(19) United States
(12) Patent Application Publication
(10) Pub. No.: US 2025/0311078 A1
(43) Pub. Date: Oct. 2, 2025

(54) CONTROL DEVICE FOR ILLUMINATION DEVICE, AND ILLUMINATION SYSTEM

(71) Applicant: Japan Display Inc., Tokyo (JP)

(72) Inventor: Chiehan CHIEN, Tokyo (JP)

(21) Appl. No.: 19/236,100

(22) Filed: Jun. 12, 2025

Related U.S. Application Data
(63) Continuation of application No. PCT/JP2023/041495, filed on Nov. 17, 2023.

(30) Foreign Application Priority Data
Dec. 16, 2022 (JP) 2022-201343

(51) Int. Cl. H05B 47/175; H05B 47/155; H05B 47/17; H05B 47/18; H05B 47/19

(52) U.S. Cl. CPC H05B 47/1985; H05B 47/155; H05B 47/17; H05B 47/184; H05B 47/19; H05B 47/1965; H05B 47/1975

(57) ABSTRACT

According to an aspect, a control device for an illumination device is configured to control a plurality of illumination devices each capable of setting a light distribution shape of light emitted from a light source in two directions of a first direction and a second direction intersecting the first direction. The control device includes: a touch sensor including a detection region in which a plurality of detection elements are provided; a display panel provided with a display region overlapping the detection region of the touch sensor in plan view; and a storage circuit configured to store setting information at least including setting values of the light distribution shape. The setting information of the illumination devices is set as scene information in the storage circuit. The setting information set as the scene information for each of the illumination devices is transmitted to an illumination device associated with the setting information.

### CROSS-REFERENCE TO RELATED APPLICATION

This application claims the benefit of priority from Japanese Patent Application No. 2022-201343 filed on Dec. 16, 2022 and International Patent Application No. PCT/JP2023/041495 filed on Nov. 17, 2023, the entire contents of which are incorporated herein by reference.

### BACKGROUND

### 1. Technical Field

What is disclosed herein relates to a control device for an illumination device, and an illumination system.

### 2. Description of the Related Art

In a conventional illumination instrument, a light source such as an LED is combined with a thin lens provided with a prism pattern, and the distance between the light source and the thin lens is changed to change a light distribution angle. For example, an illumination instrument is disclosed (refer to Japanese Patent Application Laid-open Publication No. H02-65001, for example) in which the front of a transparent light bulb is covered by a liquid crystal light adjustment element, and the transmittance of a liquid crystal layer is changed to switch between directly-reaching light and scattering light.

For example, in an illumination device including a liquid crystal cell for p wave polarization and a liquid crystal cell for s wave polarization, the diffusion degree of light in two directions can be controlled by driving the respective liquid crystal cells. It is desired to dispose, in the same space, a plurality of such highly functional illumination devices, capable of setting the diffusion degree, light quantity, color temperature, and the like of light and change various setting values of the illumination devices at once.

For the foregoing reasons, there is a need for a control device for an illumination device, and an illumination system that are capable of changing various setting values of a plurality of illumination devices at once.

### SUMMARY

According to an aspect, a control device for an illumination device is configured to control a plurality of illumination devices each capable of setting a light distribution shape of light emitted from a light source in two directions of a first direction and a second direction intersecting the first direction. The control device includes: a touch sensor including a detection region in which a plurality of detection elements are provided; a display panel provided with a display region overlapping the detection region of the touch sensor in plan view; and a storage circuit configured to store setting information at least including setting values of the light distribution shape. The setting information of the illumination devices is set as scene information in the storage circuit. The setting information set as the scene information for each of the illumination devices is transmitted to an illumination device associated with the setting information.

According to an aspect, an illumination system includes: a plurality of illumination devices each including a light source and an optical element, the optical element being provided on an optical axis of the light source and capable of setting a light distribution state of light emitted from the light source in two directions of a first direction and a second direction intersecting the first direction; and a control device configured to control the illumination devices to change the light distribution states. The control device includes a touch sensor including a detection region in which a plurality of detection elements are provided, a display panel provided with a display region overlapping the detection region of the touch sensor in plan view, and a first storage circuit configured to store setting information at least including setting values of the light distribution states. The setting information of the illumination devices is set as scene information in the first storage circuit. The control device is configured to transmit the setting information set as the scene information for each of the illumination devices to an illumination device associated with the setting information. The illumination device includes a second storage circuit configured to store the setting information transmitted from the control device.

### BRIEF DESCRIPTION OF THE DRAWINGS

FIG. 1A is a side view illustrating an example of an illumination device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a sectional view along line A-A′ illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of change in shape of light by the optical element according to the embodiment;

FIG. 8B is a conceptual diagram for description of change in shape of light by the optical element according to the embodiment;

FIG. 8C is a conceptual diagram for description of change in shape of light by the optical element according to the embodiment;

FIG. 8D is a conceptual diagram for description of change in shape of light by the optical element according to the embodiment;

FIG. 9 is a conceptual diagram for conceptually describing control of the light diffusion degree of the illumination device according to the embodiment;

FIG. 10 is a schematic view illustrating an example of the configuration of an illumination system according to the first embodiment;

FIG. 11 is an exterior diagram illustrating an example of a control device according to the first embodiment;

FIG. 12 is a conceptual diagram illustrating an example of a touch detection region on a touch sensor;

FIG. 13 is a diagram illustrating an example of the control block configuration of a control device according to the first embodiment;

FIG. 14 is a diagram illustrating an example of the control block configuration of an illumination device according to the first embodiment;

FIG. 15 is a conceptual diagram illustrating an example of the display aspect of an initial screen on a control device 200 according to the first embodiment;

FIG. 16A is a conceptual diagram illustrating an example of the display aspect of a setting change screen on the control device according to the first embodiment;

FIG. 16B is a conceptual diagram illustrating an example of the display aspect of the setting change screen on the control device according to the first embodiment;

FIG. 16C is a conceptual diagram illustrating an example of the display aspect of the setting change screen on the control device according to the first embodiment;

FIG. 16D is a conceptual diagram illustrating an example of the display aspect of the setting change screen on the control device according to the first embodiment;

FIG. 16E is a conceptual diagram illustrating an example of the display aspect of the setting change screen on the control device according to the first embodiment;

FIG. 17 is a diagram for description of the relation between the position on the setting change screen on the control device according to the first embodiment and the light diffusion degree;

FIG. 18A is a conceptual diagram illustrating an example of the display aspect of a scene setting change screen on the control device according to the first embodiment;

FIG. 18B is a conceptual diagram illustrating an example of the display aspect of the scene setting change screen on the control device according to the first embodiment;

FIG. 18C is a conceptual diagram illustrating an example of the display aspect of the scene setting change screen on the control device according to the first embodiment;

FIG. 18D is a conceptual diagram illustrating an example of the display aspect of the scene setting change screen on the control device according to the first embodiment;

FIG. 18E is a conceptual diagram illustrating an example of the display aspect of the scene setting change screen on the control device according to the first embodiment;

FIG. 19 is a conceptual diagram illustrating an example of the display aspect when a first slider is operated on the scene setting change screen illustrated in FIG. 18A after device selection;

FIG. 20 is a conceptual diagram illustrating an example of the display aspect of a first registration screen on the control device according to the first embodiment;

FIG. 21 is a conceptual diagram illustrating an example of the display aspect of a second registration screen on the control device according to the first embodiment;

FIG. 22 is a conceptual diagram illustrating an example of a storage region in the control device for the illumination device according to the first embodiment;

FIG. 23 is a flowchart illustrating an example of initial setting processing by the control device for the illumination device according to the first embodiment;

FIG. 24 is a flowchart illustrating an example of the overall flow of illumination control processing by the control device for the illumination device according to the first embodiment;

FIG. 25 is a flowchart illustrating an example of setting change processing by the control device for the illumination device according to the first embodiment;

FIG. 26 is a flowchart illustrating an example of new scene registration processing by the control device for the illumination device according to the first embodiment;

FIG. 27 is a flowchart illustrating an example of scene change processing by the control device for the illumination device according to the first embodiment;

FIG. 28 is a flowchart illustrating an example of scene setting change processing by the control device for the illumination device according to the first embodiment;

FIG. 29 is a flowchart illustrating an example of additional scene registration processing by the control device for the illumination device according to the first embodiment;

FIG. 30 is a diagram illustrating an example of the control block configuration of a control device for an illumination device according to a second embodiment;

FIG. 31 is a diagram illustrating an example of the control block configuration of the illumination device according to the second embodiment;

FIG. 32A is a conceptual diagram illustrating an example of a storage region in the control device for the illumination device according to the second embodiment;

FIG. 32B is a conceptual diagram illustrating an example of the storage region in the control device for the illumination device according to the second embodiment;

FIG. 32C is a conceptual diagram illustrating an example of a storage region in the illumination device according to the second embodiment;

FIG. 33 is a flowchart illustrating an example of initial setting processing by the control device for the illumination device according to the second embodiment;

FIG. 34A is a sequence diagram illustrating an example of first synchronization processing by the illumination system according to the second embodiment;

FIG. 34B is a sequence diagram illustrating an example of second synchronization processing by the illumination system according to the second embodiment;

FIG. 35 is a flowchart illustrating an example of setting change processing by the control device for the illumination device according to the second embodiment;

FIG. 36 is a flowchart illustrating an example of new scene registration processing by the control device for the illumination device according to the second embodiment;

FIG. 37A is a diagram illustrating an example of a state transition in a storage region of a storage circuit of the illumination device according to the second embodiment;

FIG. 37B is a diagram illustrating an example of the state transition in the storage region of the storage circuit of the illumination device according to the second embodiment;

FIG. 37C is a diagram illustrating an example of the state transition in the storage region of the storage circuit of the illumination device according to the second embodiment;

FIG. 37D is a diagram illustrating an example of the state transition in the storage region of the storage circuit of the illumination device according to the second embodiment;

FIG. 37E is a diagram illustrating an example of the state transition in the storage region of the storage circuit of the illumination device according to the second embodiment;

FIG. 38 is a flowchart illustrating an example of scene setting change processing by the control device for the illumination device according to the second embodiment;

FIG. 39 is a flowchart illustrating an example of additional scene registration processing by the control device for the illumination device according to the second embodiment;

FIG. 40A is a schematic view illustrating an example of the configuration of an illumination system according to a third embodiment; and

FIG. 40B is a schematic view illustrating a specific coupling example in a case where an illumination control device is a DMX controller in the configuration of the illumination system according to the third embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those that are identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

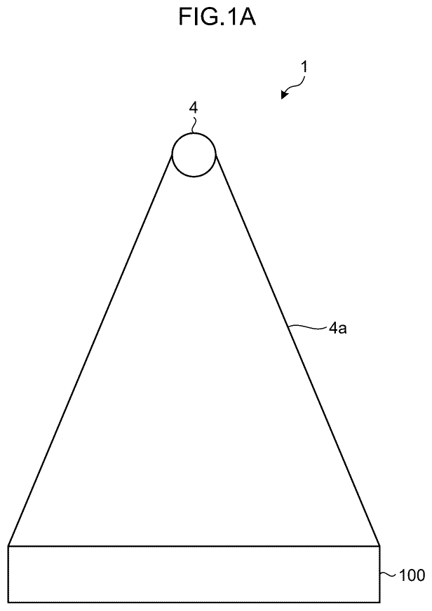

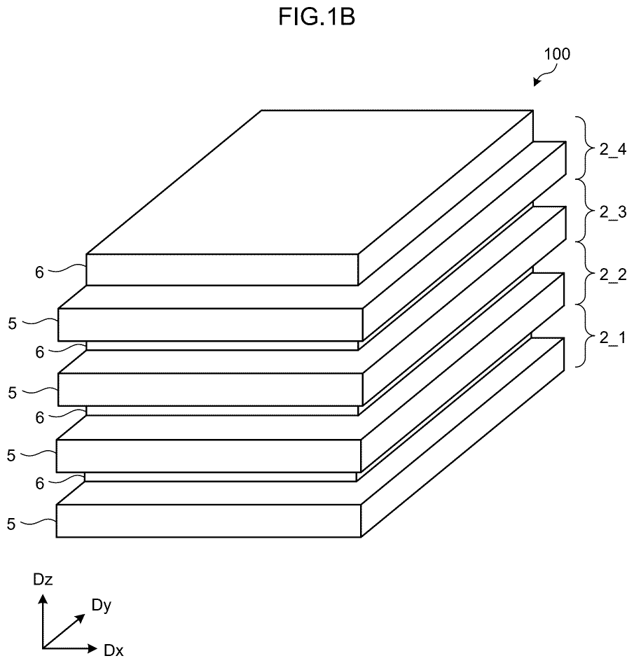

FIG. 1A is a side view illustrating an example of an illumination device 1 according to an embodiment. FIG. 1B is a perspective view illustrating an example of an optical element 100 according to the embodiment. As illustrated in FIG. 1A, the illumination device 1 includes a light source 4, a reflector 4a, and an optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as “liquid crystal cells 2”.

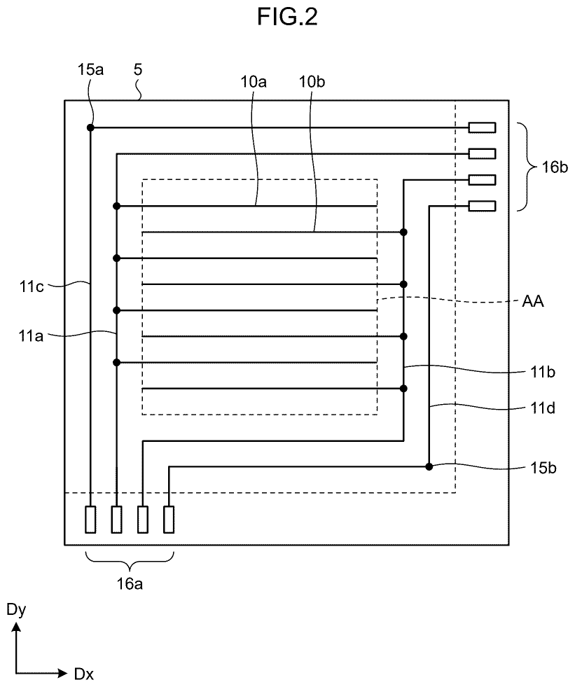

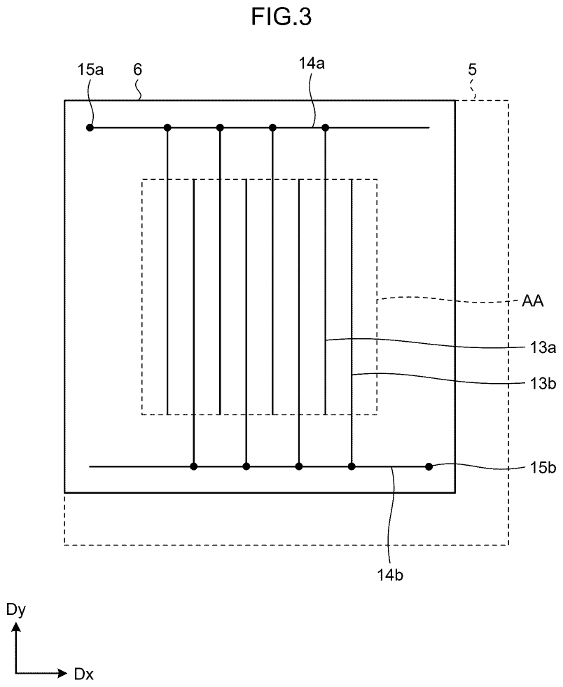

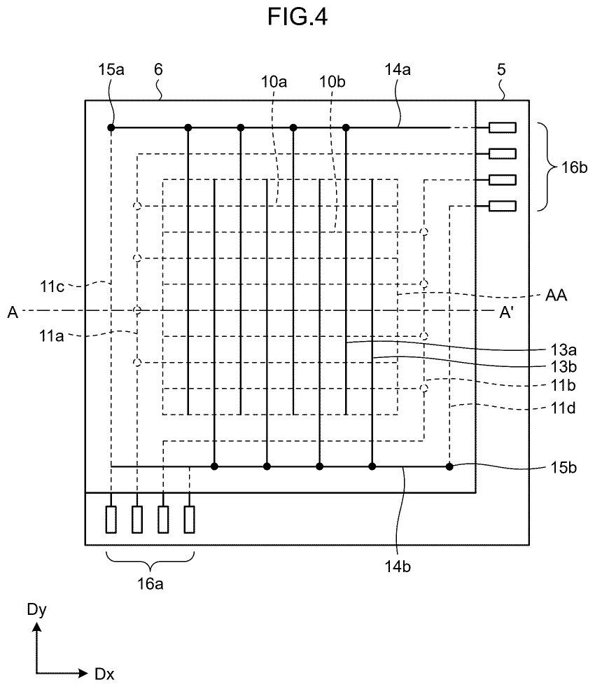

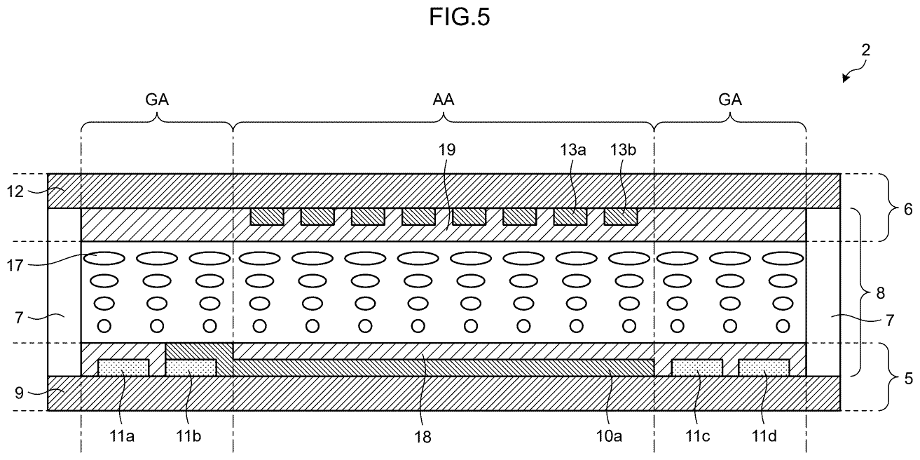

Each liquid crystal cell 2 includes a first substrate 5 and a second substrate 6. FIG. 2 is a schematic plan view of the first substrate 5 when viewed in the Dz direction. FIG. 3 is a schematic plan view of the second substrate 6 when viewed in the Dz direction. In FIG. 3, drive electrodes are visible through the substrates, but for clarity, the drive electrodes and wiring lines are illustrated with solid lines. FIG. 4 is a see-through view of a liquid crystal cell in which the first substrate 5 and the second substrate 6 are stacked in the Dz direction. In FIG. 4 as well, for clarity, the drive electrodes and wiring lines on the second substrate side are illustrated with solid lines, and the drive electrodes and wiring lines on the first substrate side are illustrated with dotted lines. FIG. 5 is a sectional view along line A-A′ illustrated in FIG. 4. FIGS. 2, 3, 4, and 5 exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

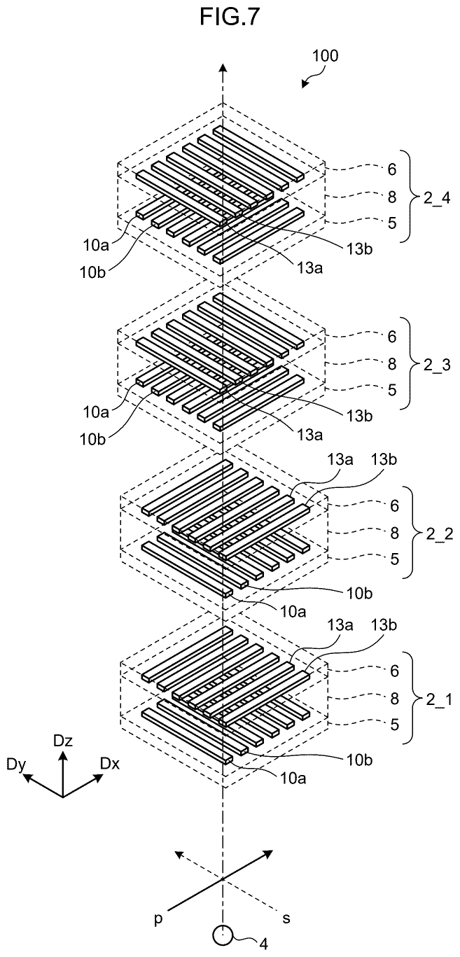

As illustrated in FIG. 2, the drive electrodes 10a and 10b, metal lines 11a and 11b, and metal lines 11c and 11d are provided on the liquid crystal layer 8 side of a base member 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later. The metal lines 11a, 11b, 11c, and 11d are provided in a wiring layer of the first substrate 5. The metal lines 11a, 11b, 11c, and 11d are provided at intervals in the wiring layer on the first substrate 5. Hereinafter, the drive electrodes 10a and 10b are simply referred to as “drive electrodes 10” in some cases. The metal lines 11a, 11b, 11c, and 11d are referred to as “first metal lines 11” in some cases. As illustrated in FIGS. 2 and 7, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b and a plurality of metal lines 14a and 14b that supply drive voltage applied to these drive electrodes 13 are provided on the liquid crystal layer 8 side of a base member 12 of the second substrate 6 illustrated in FIG. 5. The metal lines 14a and 14b are provided in a wiring layer of the second substrate 6. The metal lines 14a and 14b are provided at intervals in the wiring layer on the second substrate 6. Hereinafter, the drive electrodes 13a and 13b are simply referred to as “drive electrodes 13” in some cases. The metal lines 14a and 14b are referred to as “second metal lines 14” in some cases. As illustrated in FIGS. 3 and 7, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and 13 are translucent electrodes formed of a translucent conductive material (light-transmitting conductive oxide) such as indium tin oxide (ITO). The first substrate 5 and the second substrate 6 are light-transmitting substrates of glass, resin, or the like. The first metal lines 11 and the second metal lines 14 are formed of at least one metallic material among aluminum (Al), copper (Cu), silver (Ag), molybdenum (Mo), and alloy thereof. The first metal lines 11 and the second metal lines 14 may be each formed of one or more of these metallic materials as a multilayered body of a plurality of layers. The at least one metallic material among aluminum (Al), copper (Cu), silver (Ag), molybdenum (Mo), and alloy thereof has a resistance lower than that of light-transmitting conductive oxide such as ITO.

The metal line 11c of the first substrate 5 and the metal line 14a of the second substrate 6 are coupled by a conduction part 15a made of, for example, conductive paste. The metal line 11d of the first substrate 5 and the metal line 14b of the second substrate 6 are coupled by a conduction part 15b made of, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and to the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as “coupling terminal parts 16” in some cases.

As illustrated in FIG. 4, in the liquid crystal cell 2, the first substrate 5 and the second substrate 6 are stacked in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an “effective region AA”. The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7 is referred to as a “peripheral region GA” (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

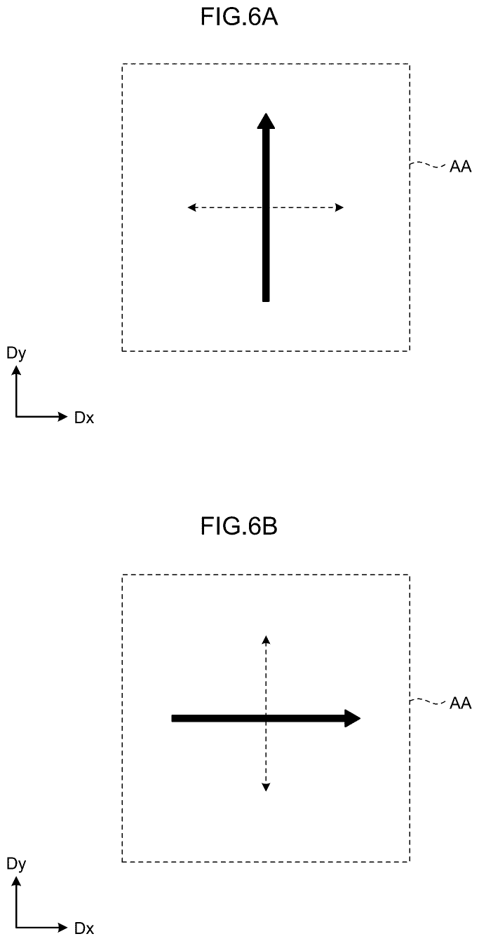

FIG. 6A is a diagram illustrating the alignment direction of the alignment film of the first substrate 5. FIG. 6B is a diagram illustrating the alignment direction of the alignment film of the second substrate 6.

As illustrated in FIGS. 6A and 6B, the alignment direction of the alignment film 18 of the first substrate 5 and the alignment direction of the alignment film 19 of the second substrate 6 are directions intersecting each other in plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

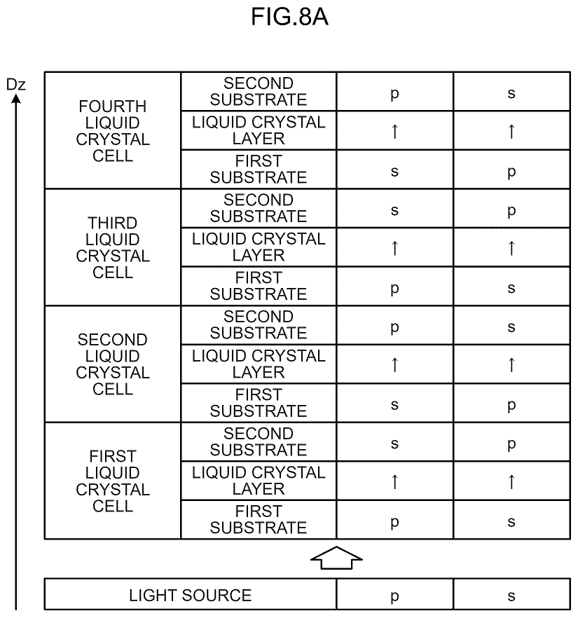

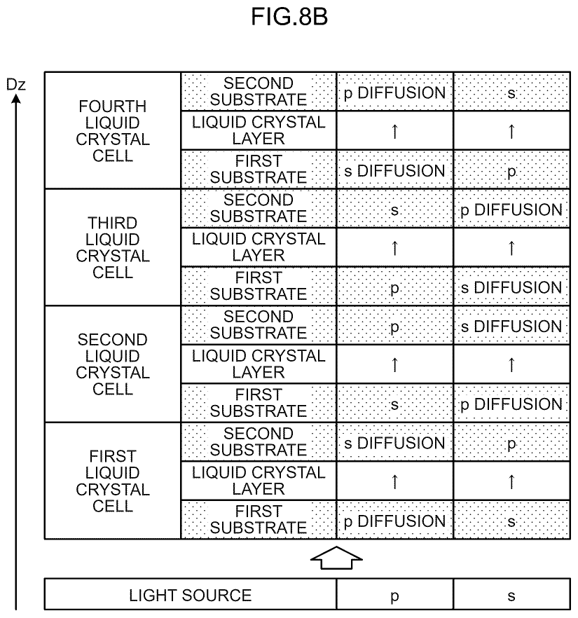

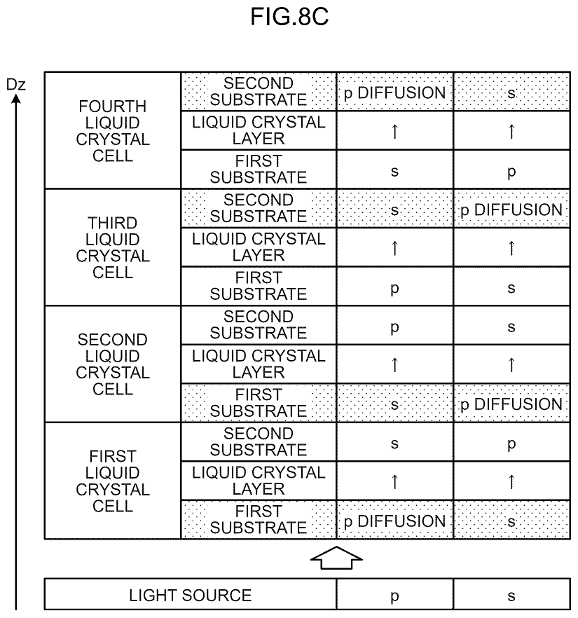

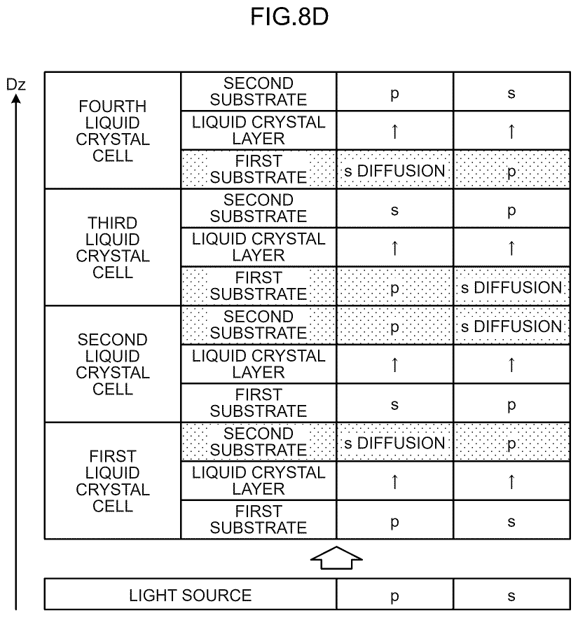

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element 100 according to the embodiment. FIGS. 8A, 8B, 8C, and 8D are conceptual diagrams for describing change in shape of light by the optical element 100 according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the alignment direction of the alignment film on the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized light component of transmitted light rotates along with the change. Specifically, in the liquid crystal cell 2, the polarized light component, which is a p-polarized component on the first substrate 5 side, changes to an s-polarized light component as distance from the second substrate 6 decreases; and the polarized light component, which is an s-polarized light component on the first substrate 5 side, changes to a p-polarized component as distance from the second substrate 6 decreases. This rotation of the polarized light component may be referred to as optical rotation.

FIG. 8A illustrates a state in which no potential is generated between adjacent electrodes in each liquid crystal cell 2. In this case, only optical rotation occurs in each liquid crystal cell 2 and no polarized light component is diffused.

As illustrated in FIG. 8B, for example, when potential difference is generated between the drive electrodes 10a and 10b on the first substrate 5 in the first liquid crystal cell 2_1 to induce a horizontal electric field, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized light component (in FIG. 8B, p-polarized component) parallel to the Dx direction, and therefore, the p-polarized component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized light component diffuses in the Dy direction on the second substrate 6 side. Specifically, the polarized light component having changed from a p-polarized component to an s-polarized light component during passing through the liquid crystal layer 8 in the first liquid crystal cell 2_1 diffuses in the Dy direction as well. However, the s-polarized light component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized light component at incidence on the first liquid crystal cell 2_1 changes to a p-polarized component after passing through the first liquid crystal cell 2_1, and the second liquid crystal cell 2_2 acts on this p-polarized component. Specifically, as illustrated in FIGS. 8A and 8B, the first liquid crystal cell 2_1 acts on the p-polarized component of light incident on the optical element 100, and the second liquid crystal cell 2_2 acts on the s-polarized light component thereof. Since the third liquid crystal cell 2_3 and the fourth liquid crystal cell 2_4 are provided with rotation by 90° relative to the first liquid crystal cell 2_1 and the second liquid crystal cell 2_2, polarized light components on which they act are switched by 90°. Specifically, the third liquid crystal cell 2_3 acts on the s-polarized light component at incidence on the optical element 100, and the fourth liquid crystal cell 2_4 acts on the p-polarized component at incidence on the optical element 100.

As illustrated in FIG. 8C, in the optical element, it is possible to act on the p-polarized component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized light component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100%) in a case where the potential difference between the drive electrodes 10a and 10b (or between the drive electrodes 13a and 13b) is maximum potential difference (for example, 30 V) defined in advance, and no spread of light (0%) occurs in the direction in a case where no potential difference is generated. Alternatively, the spread of light in the direction is 50% in a case where the potential difference between the drive electrodes 10a and 10b (or between the drive electrodes 13a and 13b) is 50% (for example, 15 V) of the above-described maximum potential difference. In a case where the relation between voltage difference and light spread is not linear, it is possible to set another potential difference instead of 15 V.

In each liquid crystal cell 2, the interval (also referred to as a cell gap) between its substrates (between the first substrate 5 and the second substrate 6) is large and is 10 μm to 50 μm approximately, more preferably 15 μm to 35 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

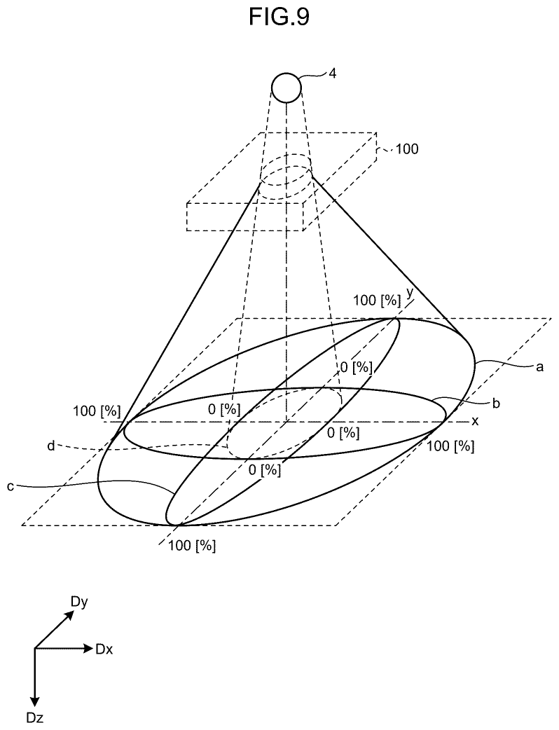

In the present disclosure, in the illumination device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. The following describes control of the light diffusion degree in the present disclosure with reference to FIG. 9.

FIG. 9 is a conceptual diagram for conceptually describing control of the light diffusion degree of the illumination device 1 according to the embodiment. FIG. 9 illustrates an irradiation area of light on an imaginary plane xy orthogonal to the Dz direction. The outline of the actual irradiation area is slightly unclear depending on the distance from the light source 4, a light diffraction phenomenon, and the like.

As described above, the drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. With this control, the light distribution shape of light emitted from the optical element 100 is controlled.

Specifically, for example, the light distribution shape in the Dx direction changes in accordance with the drive voltage applied to the drive electrodes 10 or drive electrodes 13 extending in the Dy direction in each liquid crystal cell 2 as described above (horizontal diffusion). The light distribution shape in the Dy direction changes in accordance with the drive voltage applied to the drive electrodes 10 or drive electrodes 13 extending in the Dx direction in the first to fourth liquid crystal cells (vertical diffusion).

In the present disclosure, the minimum diffusion degrees of the horizontal diffusion and the vertical diffusion are 0% and the maximum diffusion degrees thereof are 100%. More specifically, in a case where the horizontal diffusion degree is 0%, drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100%, drive electrodes (for example, the drive electrodes 10 extending in the Dy direction on the first substrate 5 in the first liquid crystal cell 2_1) functioning to expand the light distribution state in the Dx direction maximumly act on the refractive index distribution of the liquid crystal layer 8. In this case, the potential difference between the adjacent drive electrodes 10a and 10b is set to the maximum potential difference (for example, 30 V) in the optical element 100. In a case where the horizontal diffusion degree is larger than 0% and smaller than 100%, potential adjusted such that the potential difference between the adjacent drive electrodes 10a and 10b is larger than 0 V and smaller than the maximum potential difference (for example, 30 V) is applied to the electrodes. The same applies to the vertical diffusion.

Outline “a” illustrated in FIG. 9 exemplarily indicates the irradiation area in a case where the horizontal diffusion degree and the vertical diffusion degree are both 100%. Outline “b” illustrated in FIG. 9 exemplarily indicates the irradiation area in a case where the horizontal diffusion degree is 100% and the vertical diffusion degree is 0%. Outline “c” illustrated in FIG. 9 exemplarily indicates the irradiation area in a case where the horizontal diffusion degree is 0% and the vertical diffusion degree is 100%. Outline “d” illustrated in FIG. 9 exemplarily indicates the irradiation area in a case where the horizontal diffusion degree and the vertical diffusion degree are both 0%. In other words, outline “d” indicates the light distribution state when light from the light source 4 is emitted without being controlled by the optical element 100 (or simply transmitted through the optical element 100).

In this manner, in the illumination device 1 with the above-described configuration, it is possible to control the horizontal and vertical diffusion degrees of emission light from the optical element 100 by performing drive voltage control of each liquid crystal cell 2. Thus, it is possible to change the light distribution shape of emission light from the illumination device 1. Hereinafter, control that changes the light distribution shape of emission light from the illumination device 1 is also referred to as “light distribution control”.

In the present disclosure, the illumination device 1 capable of light distribution control in the two directions of the Dx and Dy directions is exemplarily described, but the controllable parameter of the illumination device 1 is not limited to light distribution (light spread). For example, the illumination device 1 may be capable of light adjustment control. In this case, the controllable parameters of the illumination device 1 may include light adjustment (brightness).

### First Embodiment

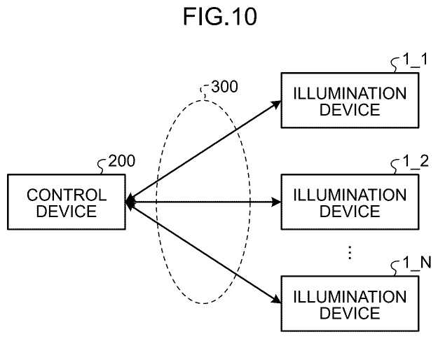

FIG. 10 is a schematic view illustrating an example of the configuration of an illumination system according to a first embodiment. The illumination system according to the first embodiment includes a plurality of illumination devices 1_1, 1_2, . . . , and 1_N and a control device 200. The control device 200 is, for example, a portable communication terminal device such as a smartphone or a tablet. The illumination devices 1_1, 1_2, . . . , and 1_N are each registered in the control device 200 in advance as a control target device having a light diffusion degree controllable by the control device 200.

Data and various command signals are transmitted bidirectionally between the control device 200 and each of the illumination devices 1_1, 1_2, . . . , and 1_N through a communication means 300. In the present disclosure, the communication means 300 is a wireless communication means of, for example, Bluetooth (registered trademark) or WiFi (registered trademark). Wireless communication may be performed between the control device 200 and each of the illumination devices 1_1, 1_2, . . . , and 1_N through, for example, a predetermined network such as a mobile communication network. Alternatively, each of the illumination devices 1_1, 1_2, . . . , and 1_N and the control device 200 may be coupled in a wired manner to perform wired communication therebetween.

As illustrated in FIG. 10, N (N is a natural number equal to or larger than one) illumination devices 1_n (n is a natural number of 1 to N) are control target devices of the control device 200 in the present disclosure, but the present disclosure is not limited by the number of control target devices (illumination devices 1_n) of the control device 200. Furthermore, in the present disclosure, an aspect in which the light diffusion degree of each illumination device 1_n is controlled as a setting parameter of a control target device (illumination device 1_n) will be described below, but the setting parameter is not limited to the light diffusion degree. Examples of setting parameters of a control target device (illumination device 1_n) may include the light quantity and color temperature of the illumination device 1_n.

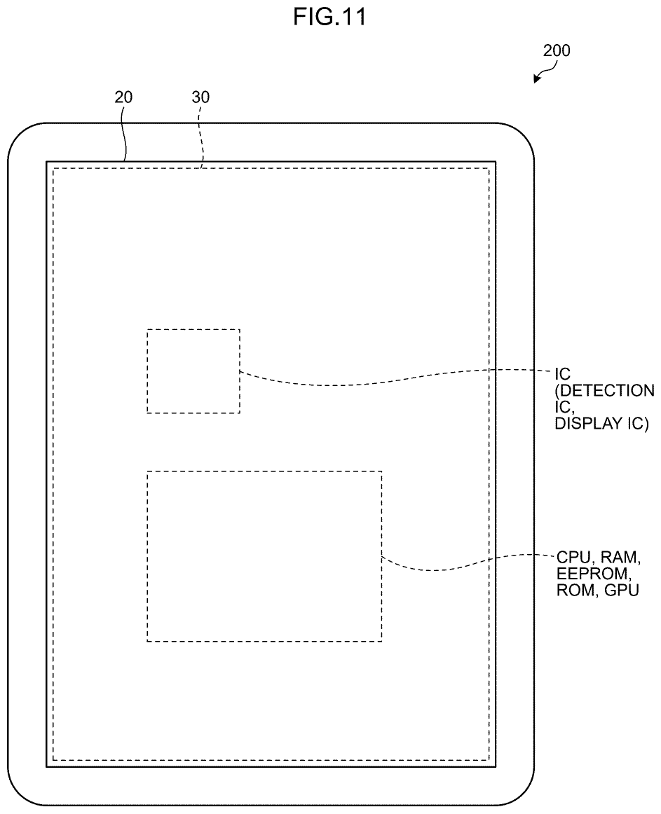

FIG. 11 is an exterior diagram illustrating an example of the control device 200 according to the first embodiment. The control device 200 is a display device (touch screen) with a touch detection function in which a display panel 20 and a touch sensor 30 are integrated. The control device 200 includes, as internal constituent components, for example, various ICs such as a detection IC and a display IC, and a central processing unit (CPU), a random access memory (RAM), an electrically erasable programmable read only memory (EEPROM), a read only memory (ROM), and a graphics processing unit (GPU) of a smartphone, a tablet, or the like constituting the control device 200.

The display panel 20 is what is called an in-cell or hybrid device in which the touch sensor 30 is built and integrated. Building and integrating the touch sensor 30 in the display panel 20 includes, for example, sharing some members such as substrates and electrodes used as the display panel 20 and some members such as substrates and electrodes used as the touch sensor 30. The display panel 20 may be what is called an on-cell device in which the touch sensor 30 is mounted on a display device.

The display panel 20 is, for example, a liquid crystal display panel including a liquid crystal display element. The display panel 20 is not limited thereto but may be, for example, an organic EL display panel (organic light emitting diode (OLED)) or an inorganic EL display panel (micro LED or mini LED).

The touch sensor 30 is, for example, a capacitive touch sensor. The touch sensor 30 is not limited thereto but may be, for example, a touch sensor of a resistance film scheme or a touch sensor of an ultrasonic wave scheme or an optical scheme.

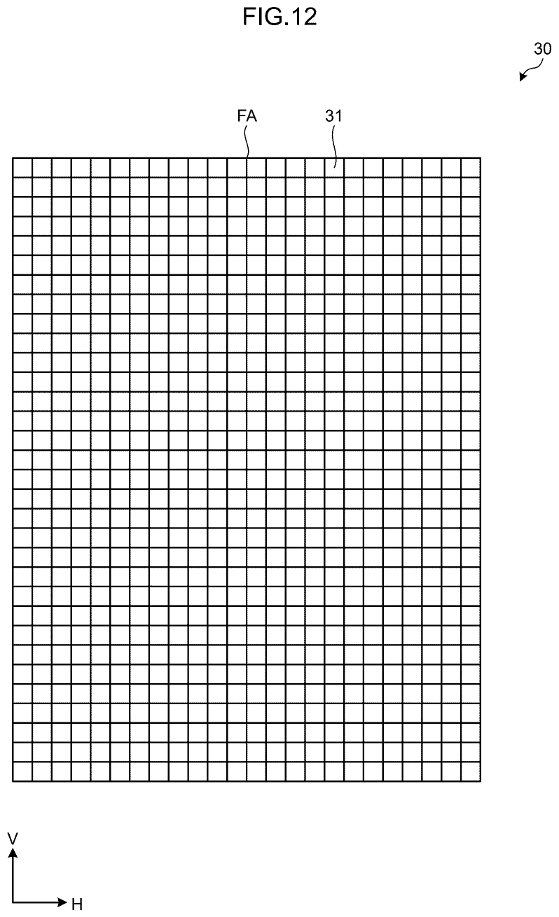

FIG. 12 is a conceptual diagram illustrating an example of a touch detection region of the touch sensor 30. A plurality of detection elements 31 are provided in a detection region FA of the touch sensor 30. The detection elements 31 in the detection region FA of the touch sensor 30 are arranged in an X direction and a Y direction orthogonal to the X direction and provided in a matrix of a row-column configuration. In other words, the touch sensor 30 has the detection region FA overlapping the detection elements 31 arranged in the X direction and the Y direction.

Specific configurations and operation for controlling the light diffusion degree of the illumination device 1 in the above-described configuration of the illumination system according to the first embodiment will be described below.

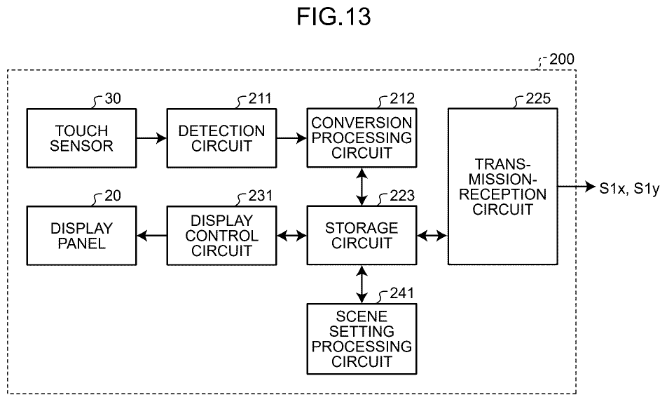

FIG. 13 is a diagram illustrating an example of a control block configuration of the control device 200 according to the first embodiment. The following describes a control block configuration for executing setting change processing to be described later.

As illustrated in FIG. 13, the control device 200 according to the first embodiment includes the display panel 20, the touch sensor 30, a detection circuit 211, a conversion processing circuit 212, a storage circuit (first storage circuit) 223, a transmission-reception circuit 225, a display control circuit 231, and a scene setting processing circuit 241. The detection circuit 211 is configured with, for example, a detection IC. Alternatively, the detection circuit 211 and the display control circuit 231 may be mounted as one display IC on the display panel 20 or on an FPC coupled to the display panel 20. The conversion processing circuit 212 and the storage circuit 223 are each configured with, for example, the CPU, RAM, EEPROM, and ROM of a smartphone, a tablet, or the like constituting the control device 200. The display control circuit 231 may be a display IC mounted on the display panel 20 as described above, and moreover, may include, for example, the GPU of a smartphone, a tablet, or the like constituting the control device 200. The transmission-reception circuit 225 is configured with, for example, a wireless communication module of a smartphone, a tablet, or the like constituting the control device 200.

The detection circuit 211 is a circuit that detects existence of a touch on the touch sensor 30 based on a detection signal output from each detection element 31 of the touch sensor 30.

The conversion processing circuit 212 is a circuit that executes conversion processing of the position of touch detection by the detection circuit 211 into various setting values (in the present disclosure, light diffusion degrees) of the illumination device 1. In the present disclosure, the conversion processing circuit 212 has a function to execute conversion processing of the position of touch detection by the detection circuit 211, that is, a touched object (pictorial image) into operation states on various screens. The conversion processing circuit 212 is a component achieved by, for example, the CPU of a smartphone, a tablet, or the like constituting the control device 200.

In illumination control processing to be described later, the scene setting processing circuit 241 sets, as one piece of scene information (to be described later), the setting values of various setting parameters (in the present disclosure, light diffusion degrees) of the illumination devices 1_n registered as control target devices in advance. The scene setting processing circuit 241 is a component achieved by, for example, the CPU of a smartphone, a tablet, or the like constituting the control device 200.

The storage circuit 223 is configured with, for example, the RAM, EEPROM, and ROM of a smartphone, a tablet, or the like constituting the control device 200. In the present disclosure, the storage circuit 223 stores setting information including various setting values (in the present disclosure, light diffusion degrees) of the illumination device 1. The storage circuit 223 temporarily stores, for example, intermediate data in the setting change processing to be described later.

The scene information set by the scene setting processing circuit 241 is stored in the storage circuit 223. The number of pieces of the scene information stored in the storage circuit 223 in the present disclosure may be one or more.

In the scene information, the setting values of various setting parameters (in the present disclosure, light diffusion degrees (more specifically, vertical diffusion degrees and horizontal diffusion degrees)) of each illumination device 1_n registered as a control target device in advance are associated with the illumination device 1_n and stored in a storage region of the storage circuit 223. The following description will be made on an examples of an aspect in which a plurality of pieces of the scene information are stored in the storage circuit 223.

The setting information is transmitted bidirectionally between the transmission-reception circuit 225 and the illumination device 1. Specifically, the transmission-reception circuit 225 transmits a Dx-directional light diffusion degree S1x and a Dy-directional light diffusion degree S1y to the illumination device 1 as first setting information in the illumination control processing to be described later.

The display control circuit 231 executes display control processing for displaying a setting change screen to be described later on the display panel 20. The display control circuit 231 in the present disclosure performs display control of the display panel 20 based on various kinds of setting information stored in a storage region of the storage circuit 223 and position information of pictorial images.

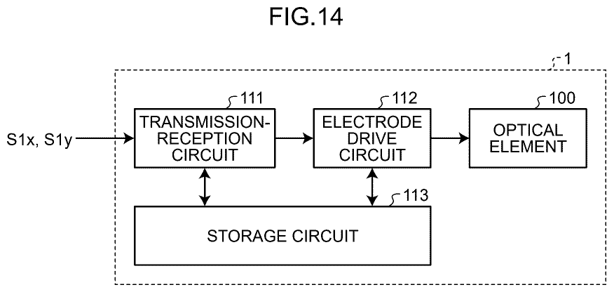

FIG. 14 is a diagram illustrating an example of the control block configuration of the illumination device 1 according to the first embodiment. As illustrated in FIG. 14, the illumination device 1 according to the first embodiment includes a transmission-reception circuit 111, an electrode drive circuit 112, and a storage circuit (second storage circuit) 113 as control blocks for controlling the optical element 100 described above.

Various kinds of setting information are transmitted bidirectionally between the transmission-reception circuit 111 and the control device 200. Specifically, the transmission-reception circuit 111 receives the first setting information (the Dx-directional light diffusion degree S1x and the Dy-directional light diffusion degree S1y) transmitted from the control device 200.

In the present embodiment, upon activation of the illumination device 1, the transmission-reception circuit 111 stores, in the storage circuit 113, the Dx-directional light diffusion degree S1x and the Dy-directional light diffusion degree S1y of the first setting information transmitted from the control device 200, as a Dx-directional light diffusion degree S2x and a Dy-directional light diffusion degree S2y.

The electrode drive circuit 112 supplies drive voltage in accordance with the Dx-directional light diffusion degree S2x and the Dy-directional light diffusion degree S2y stored in the storage circuit 113 to the drive electrodes 10 and 13 of each liquid crystal cell 2 of the optical element 100.

Specifically, upon activation of the illumination device 1, the electrode drive circuit 112 supplies drive voltage corresponding to the second setting information stored in the storage circuit 113 to the drive electrodes 10 and 13 of each liquid crystal cell 2 of the optical element 100.

The electrode drive circuit 112 also supplies, to the drive electrodes 10 and 13 of each liquid crystal cell 2 of the optical element 100, drive voltage corresponding to the second setting information updated based on the first setting information transmitted from the control device 200.

The storage circuit 113 is composed of, for example, a RAM, an EEPROM, or a ROM. In the present disclosure, the storage circuit 113 stores the final value of the second setting information in a previous operation of the illumination device 1.

Processing of the illumination system in the present disclosure is executed by application software operating on the control device 200 in cooperation with the illumination device 1. The following describes specific examples of processing according to the present embodiment achieved by the application software operating on the control device 200, the display aspect of each screen on the application software (hereinafter also referred to as “illumination control application”), and cooperative operation of the illumination device 1.

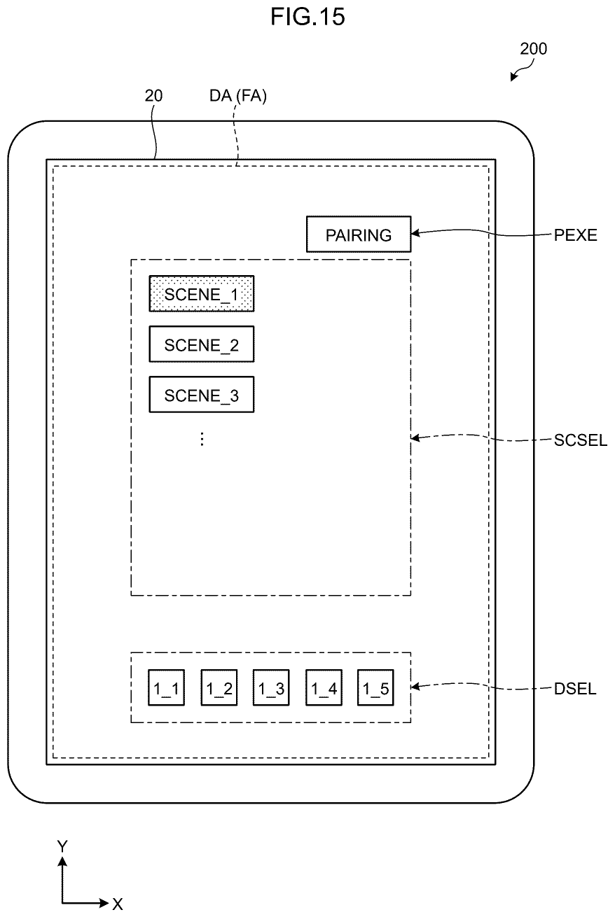

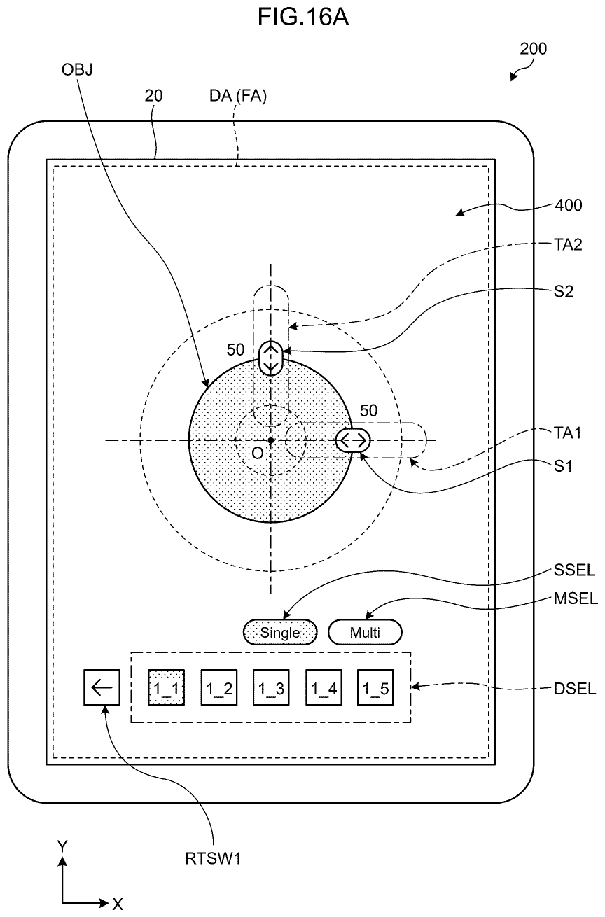

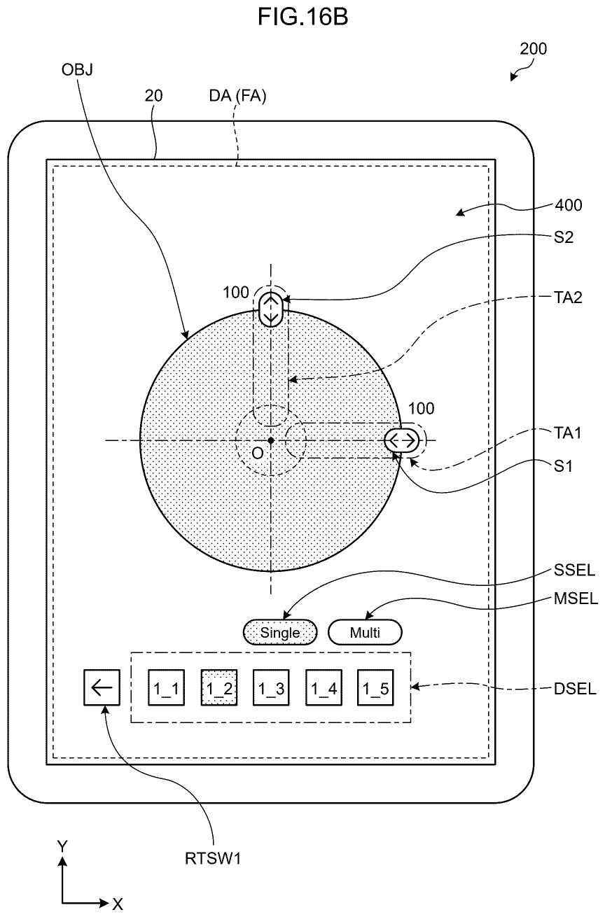

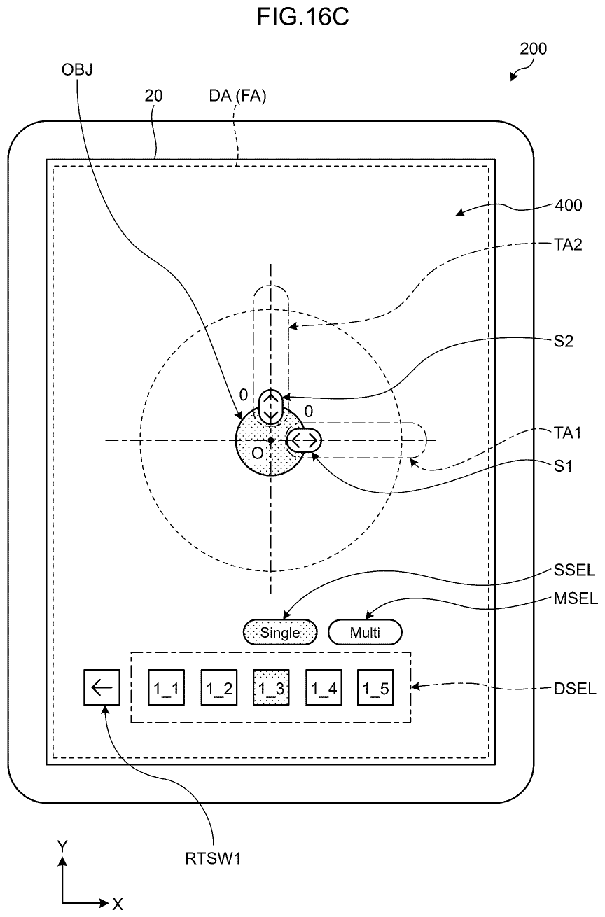

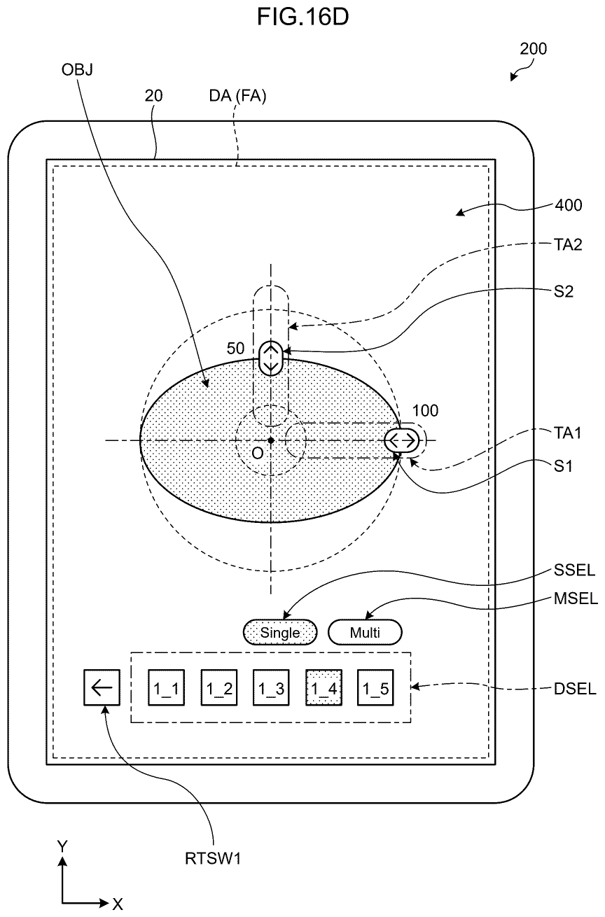

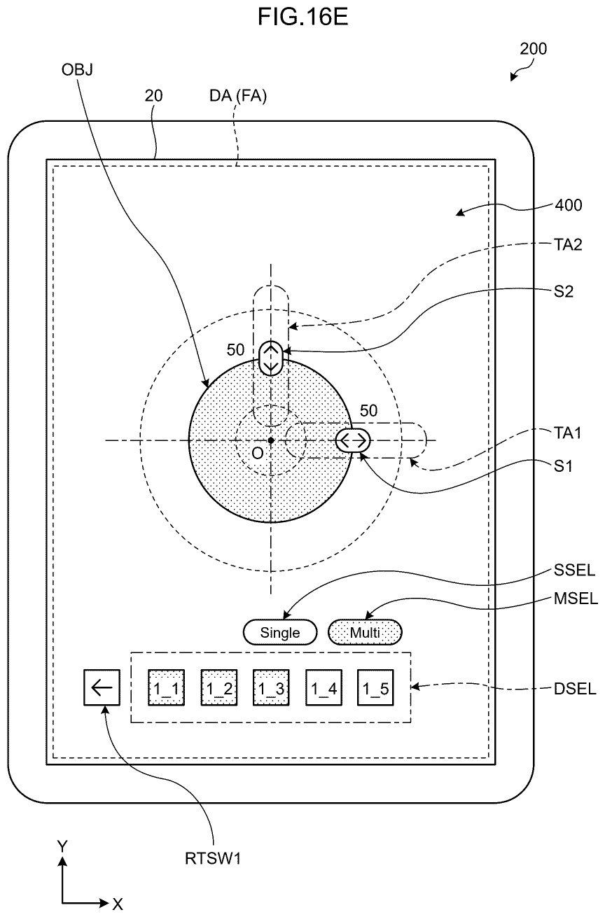

FIG. 15 is a conceptual diagram illustrating an example of the display aspect of an initial screen on the control device 200 according to the first embodiment. FIGS. 16A, 16B, 16C, 16D, and 16E are conceptual diagrams illustrating an example of the display aspect of the setting change screen on the control device according to the first embodiment.

In description of the present disclosure, it is assumed that the illumination control application is installed on the control device 200 in advance.

As illustrated in FIG. 15, a pairing button PEXE for executing pairing with each illumination device 1_n after activation of the illumination control application is provided in the display aspect of the initial screen on the control device 200 according to the first embodiment. The pairing button PEXE is, for example, a button (pictorial image) displayed as an icon with which it is possible, by touching the pairing button PEXE displayed on the initial screen illustrated in FIG. 15, to execute pairing with the illumination devices 1_1, 1_2, 1_3, 1_4, and 1_5 registered as control target devices in advance.

After the illumination control application is activated, a plurality of device selection switches DSEL and a plurality of scene selection switches SCSEL are displayed on the initial screen. The selection switches DSEL correspond to the illumination devices 1_1, 1_2, 1_3, 1_4, and 1_5 registered as control target devices in advance, and the scene selection switches SCSEL correspond to a plurality of pieces of scene information SCENE_p (p is a natural number equal to or larger than one) set by the scene setting processing circuit 241 in advance.

At initial activation of the illumination control application, for example, the illumination devices 1_n activated in a space where pairing is possible may be registered as control target devices, and the device selection switches DSEL corresponding to the illumination devices 1_n may be displayed on the initial screen. No valid scene is set at initial activation of the illumination control application. In this case, no scene selection switches SCSEL may be displayed on the initial screen, or only scene information SCENE_1 (default) to which the initial value (for example, 50%) of a Dx-directional light diffusion degree Sx (hereinafter also referred to as a “horizontal diffusion degree Sx”) and the initial value (for example, 50%) of a Dy-directional light diffusion degree Sy (hereinafter also referred to as a “vertical diffusion degree Sy”) have been set may be displayed on the initial screen for each registered illumination device 1_n.

Each device selection switch DSEL is, for example, a button (pictorial image) displayed as an icon with which it is possible to select an illumination device corresponding to the device selection switch DSEL by touching the device selection switch DSEL displayed on the initial screen illustrated in FIG. 15.

Each scene selection switch SCSEL is, for example, a button (pictorial image) displayed as an icon with which it is possible to select the scene information SCENE_p corresponding to the selected scene selection switch SCSEL by touching the scene selection switch SCSEL displayed on the initial screen illustrated in FIG. 15.

If any one of the device selection switches DSEL is touched in the initial screen illustrated in FIG. 15, a transition is made to each setting change screen (refer to FIGS. 16A, 16B, 16C, 16D, and 16E) of the illumination device 1_n corresponding to the touched device selection switch DSEL.

FIGS. 16A, 16B, 16C, 16D, and 16E are conceptual diagrams illustrating an example of the display aspect of the setting change screen on the control device 200 according to the first embodiment. On a setting change screen 400 illustrated in FIGS. 16A, 16B, 16C, 16D, and 16E, the X direction is defined as the Dx direction (first direction) in light diffusion degree control of the illumination device 1, and the Y direction is defined as the Dy direction (second direction) in light diffusion degree control of the illumination device 1. An XY plane with an origin O(0, 0) at a predetermined position on a display region DA is defined on the setting change screen 400.

The display panel 20 is provided with the display region DA overlapping the detection region FA of the touch sensor 30 in plan view. In the example illustrated in FIGS. 16A, 16B, 16C, 16D, and 16E, a light distribution shape object OBJ with a central point at the origin O(0, 0) of the XY plane on the setting change screen 400 is displayed, and a first slider S1 and a second slider S2 for setting the light diffusion degree of the illumination device 1 are disposed on the outline of the light distribution shape object OBJ.

The light distribution shape object OBJ is a pictorial image on the setting change screen 400, corresponding to the light distribution state of light emitted from the illumination device 1.

The first slider S1 and the second slider S2 are, for example, pictorial images displayed on the setting change screen 400, which a user can touch and move (drag operation) with a finger.

The shape of the light distribution shape object OBJ can be changed by moving the first slider S1 in the X direction. Simultaneously, the light diffusion degree (horizontal diffusion degree) of the illumination device 1 in the Dx direction is controlled. The shape of the light distribution shape object OBJ can be changed by moving the second slider S2 in the Y direction. Simultaneously, the light diffusion degree (vertical diffusion degree) of the illumination device 1 in the Dy direction is controlled.

In the present disclosure, a selection switch SSEL for a single-device operation mode (first mode) and a selection switch MSEL for a multi-device operation mode (second mode) are provided on the setting change screen 400. A plurality of device selection switches DSEL corresponding to the illumination devices 1_1, 1_2, 1_3, 1_4, and 1_5 registered as control target devices in advance are provided on the setting change screen 400.

Each device selection switch DSEL is a pictorial image displayed as a button on a setting display screen. One or some of the illumination devices 1 each serving as an operation target in device setting processing to be described later are selected by selecting one or some of the device selection switches DSEL. Each time a new illumination device 1 is registered, a device selection switch DSEL is individually provided for the illumination device 1. When the registered illumination device 1 is deregistered, the device selection switch DSEL corresponding to the illumination device 1 is deleted from the setting display screen. Hereinafter, the illumination device 1 selected as an operation target through the corresponding device selection switch DSEL is also referred to as an “operation target device”.

In the present disclosure, “select a switch” means that the user touches a pictorial image corresponding to the switch on the setting change screen 400 and display of the pictorial image changes (the shape, color, brightness, or the like of the pictorial image changes). In addition, “cancel selection of the switch” means that the user touches the pictorial image again and the pictorial image returns to the original state.

The selection switch SSEL is a pictorial image displayed as a button on the setting change screen 400. When the selection switch SSEL is selected and one pictorial image corresponding to an illumination device 1 to be an operation target is selected from among the pictorial images of the device selection switches DSEL, the selected illumination device 1 becomes controllable. Details will be described later.

The selection switch MSEL is a pictorial image displayed as a button on the setting change screen 400. When the selection switch MSEL is selected and one or more pictorial images corresponding to the illumination devices 1 to be operation targets are selected from among the pictorial images of the device selection switches DSEL, the selected illumination devices become controllable. Details will be described later.

In the present embodiment, a first back button RTSW1 is provided on the setting change screen 400 after device selection.

The first back button RTSW1 is, for example, a button (pictorial image) displayed as an icon for making a transition to screen display in accordance with various conditions described below by touching the first back button RTSW1 displayed on the setting change screen 400 after device selection.

Specifically, if the first back button RTSW1 is touched while the setting information (in the present disclosure, light diffusion degree information) of the illumination device 1_n is not changed on the setting change screen 400 after device selection, the display screen returns to the initial screen illustrated in FIG. 15.

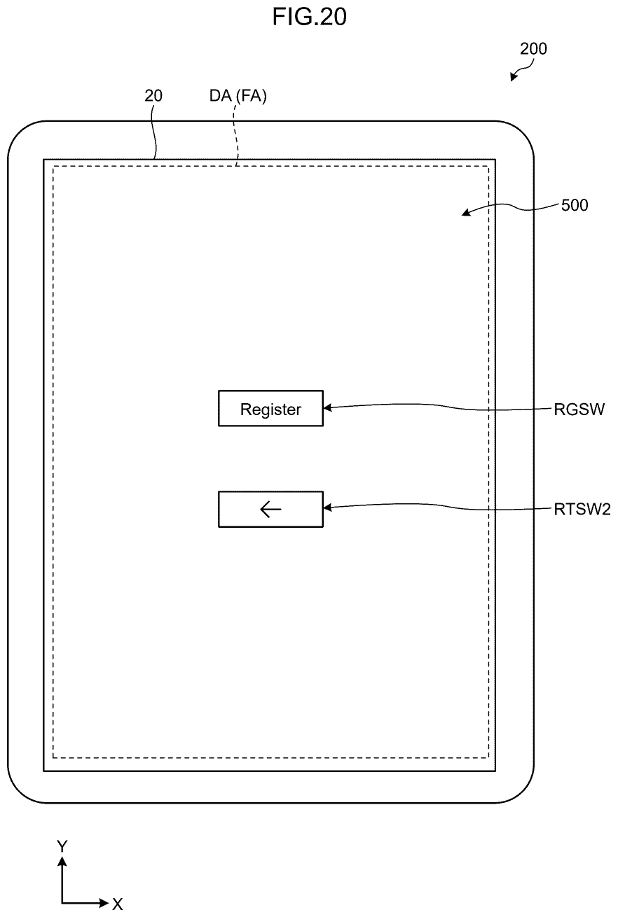

For example, if the first back button RTSW1 is touched after the first slider S1 and the second slider S2 are operated on the setting change screen 400 after device selection to execute a setting change of the setting information (in the present disclosure, light diffusion degree information) of the illumination device 1_n, a transition is made to a first registration screen illustrated in FIG. 20. The first registration screen will be described later.

Positions where the device selection switches DSEL, the selection switch SSEL, the selection switch MSEL, and the first back button RTSW1 are provided are not limited to those in the aspect illustrated in FIGS. 16A, 16B, 16C, 16D, and 16E.

The single-device operation mode and the multi-device operation mode will be described below. The single-device operation mode and the multi-device operation mode are exclusively selected operation modes.

Specifically, for example, when the selection switch MSEL is touched in the single-device operation mode, the operation mode is switched to the multi-device operation mode. For example, when the selection switch SSEL is touched in the multi-device operation mode, the operation mode is switched to the single-device operation mode.

Behavior when the device selection switches DSEL are operated is different between the single-device operation mode and the multi-device operation mode.

Specifically, in the single-device operation mode, for example, when the device selection switch DSEL corresponding to the illumination device 1_2 is selected while the illumination device 1_1 is selected, a target device to be subjected to single-device operation switches from the illumination device 1_1 to the illumination device 1_2. In other words, in the single-device operation mode, any one of the illumination devices 1_1, 1_2, 1_3, 1_4, and 1_5 registered as control target devices in advance is selected as an operation target device and allowed for single-device operation.

In the multi-device operation mode, for example, when the device selection switch DSEL corresponding to the illumination device 1_2 is selected while the illumination device 1_1 is selected, two operation target devices of the illumination device 1_1 and the illumination device 1_2 are selected. Thereafter, when selection of the device selection switch DSEL corresponding to the illumination device 1_2 is canceled, the illumination device 1_2 is excluded from among the operation target devices and only one operation target device of the illumination device 1_1 is selected. Alternatively, when selection of the device selection switch DSEL corresponding to the illumination device 1_1 is canceled while two operation target devices of the illumination device 1_1 and the illumination device 1_2 are selected, the illumination device 1_1 is excluded from among the operation target devices and only one operation target device of the illumination device 1_2 is selected. In other words, in the multi-device operation mode, when any one of the illumination devices 1_1, 1_2, 1_3, 1_4, and 1_5 registered as control target devices in advance is selected as an operation target device, the operation target device is allowed to be operated singly. When a plurality of control target devices (for example, the illumination device 1_1 and the illumination device 1_2 selected) are selected as operation target devices, the selected operation target devices (for example, the illumination device 1_1 and the illumination device 1_2) are allowed to be operated simultaneously.

In the single-device operation mode, when the same setting information (in the present disclosure, light diffusion degree information) is to be transmitted to a plurality of illumination devices, it is needed to switch between operation target devices by selecting the corresponding device selection switches DSEL one by one and make the same setting change for each of the operation target devices (for example, the illumination device 1_1 and the illumination device 1_2).

However, in the multi-device operation mode, the same setting change is applied to a plurality of selected operation target devices (for example, the illumination device 1_1 and the illumination device 1_2). This can reduce work required to transmit the same setting information to a plurality of illumination devices.

In the example illustrated in FIGS. 16A, 16B, 16C, 16D, and 16E, the five illumination devices 1_1, 1_2, 1_3, 1_4, and 1_5 are registered as control target devices of the control device 200, but the number of control target devices of the control device 200 is not limited to five. In the following description, the number of control target devices (illumination devices 1) of the control device 200 is N (N is a natural number equal to or larger than one) in some cases. The number of operation target devices (illumination devices 1) selected in the multi-device operation mode (second mode) from among the control target devices (the illumination devices 1_n (1_1, 1_2, . . . , 1_N)) of the control device 200 is M (M is a natural number of 1 to N) in some cases.

FIG. 16A illustrates the setting change screen 400 in a case where the illumination device 1_1 is selected as an operation target device in the single-device operation mode. FIG. 16A illustrates an example in which the horizontal diffusion degree Sx of the illumination device 1_1 is 50% and the vertical diffusion degree Sy of the illumination device 1_1 is 50%. As illustrated in FIG. 16A, the values of the horizontal diffusion degree Sx and the vertical diffusion degree Sy are displayed on the display screen as well.

FIG. 16B illustrates the setting change screen 400 in a case where the illumination device 1_2 is selected as an operation target device in the single-device operation mode. FIG. 16B illustrates an example in which the horizontal diffusion degree Sx and the vertical diffusion degree Sy of the illumination device 1_2 are both 100%.

FIG. 16C illustrates the setting change screen 400 in a case where the illumination device 1_3 is selected as an operation target device in the single-device operation mode. FIG. 16C illustrates an example in which the horizontal diffusion degree Sx and the vertical diffusion degree Sy of the illumination device 1_3 are both 0%.

FIG. 16D illustrates the setting change screen 400 in a case where the illumination device 1_4 is selected as an operation target device in the single-device operation mode. FIG. 16D illustrates an example in which the horizontal diffusion degree Sx of the illumination device 1_4 is 100% and the vertical diffusion degree Sy of the illumination device 1_4 is 50%.

FIG. 16E illustrates the setting change screen 400 in a case where the illumination devices 1_1, 1_2, and 1_3 are selected as operation target devices in the multi-device operation mode. FIG. 16E illustrates an example in which the horizontal diffusion degree Sx and the vertical diffusion degree Sy of each of the illumination devices 1_1, 1_2, and 1_3 are set to initial values (default values) in the setting change processing to be described later. Although the initial value of the horizontal diffusion degree Sx and the initial value of the vertical diffusion degree Sy are both 50% in the example illustrated in FIG. 16E, the initial value of the horizontal diffusion degree Sx and the initial value of the vertical diffusion degree Sy are not limited to 50% but may be set to arbitrary values such as 0%, 30%, or 100%. The initial value of the horizontal diffusion degree Sx and the initial value of the vertical diffusion degree Sy may be different from each other. A setting change procedure in the multi-device operation mode will be described in detail in the setting change processing to be described later.

In the present disclosure, the shape of the light distribution shape object OBJ on the setting change screen 400 changes in a circular or elliptical shape along with movement of the first slider S1 and the second slider S2 as illustrated in FIGS. 16A, 16B, 16C, 16D, and 16E.

As illustrated in FIG. 9, in the illumination device 1 as a control target in the present disclosure, a predetermined substantially circular area (outline “d”) is irradiated with light even in a case where the horizontal diffusion degree Sx and vertical diffusion degree Sy of the illumination device 1 are both 0%. In the present disclosure, as illustrated in FIG. 16C, the light distribution shape object OBJ in a small circular shape is displayed in a case where the horizontal diffusion degree Sx and the vertical diffusion degree Sy are both 0%.

In the present disclosure, as illustrated in FIGS. 16A, 16B, 16C, 16D, and 16E, a first region TAL is provided as a region in which the first slider S1 can be operated.

The first slider S1 can be moved in the X direction in the first region TA1 between the position on the outline of the light distribution shape object OBJ in a case where the horizontal diffusion degree Sx is 0% and the position on the outline of the light distribution shape object OBJ in a case where the horizontal diffusion degree Sx is 100%. Thus, the first slider S1 does not move when the user's finger moves away from the screen or even when it remains on the screen but moves out of the first region TA1.

In the present disclosure, as illustrated in FIGS. 16A, 16B, 16C, 16D, and 16E, a second region TA2 is provided as a region in which the second slider S2 can be operated.

The second slider S2 can be moved in the Y direction in the second region TA2 between the position on the outline of the light distribution shape object OBJ in a case where the vertical diffusion degree Sy is 0% and the position on the outline of the light distribution shape object OBJ in a case where the vertical diffusion degree Sy is 100%. Thus, the second slider S2 does not move when the user's finger moves away from the screen or even when it remains on the screen but moves out of the second region TA2.

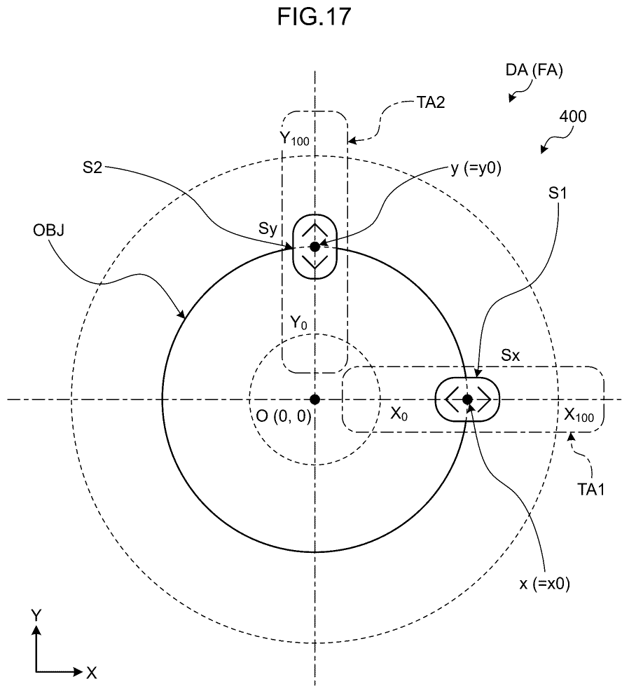

FIG. 17 is a diagram for description of the relation between the position on the setting change screen 400 on the control device 200 according to the first embodiment and the light diffusion degree. In the present disclosure, to facilitate description, the position (coordinate) on the display region DA of the display panel 20 and the position (coordinate) on the detection region FA of the touch sensor 30 are assumed to be equivalent.

On the setting change screen 400 of the control device 200 according to the first embodiment, the horizontal diffusion degree Sx of the illumination device 1 can set based on the movement amount of a position x of an intersection point of the X axis of the XY plane and the outline of the light distribution shape object OBJ.

In the present disclosure, the position x of the intersection point of the X axis and the outline of the light distribution shape object OBJ is the central point of the first slider S1. In other words, a position x0 of the first slider S1 on the display region DA coincides with the position x of the intersection point of the X axis and the outline of the light distribution shape object OBJ. Thus, the horizontal diffusion degree Sx of the illumination device 1 can be set by touching the first slider S1 and moving the first slider S1 in the X-axis direction. In FIG. 17, “Sx” indicates the horizontal diffusion degree (for example, “50” %) of the illumination device 1.

The reference movement amount Px in the X direction on the XY plane in a case where a horizontal diffusion degree change amount ΔSx of the illumination device 1 is 1% is expressed by Expression (1) below, where X₁₀₀ represents the intersection point of the X axis and the outline of the light distribution shape object OBJ in a case where the horizontal diffusion degree Sx is 100%, and X₀ represents the intersection point of the X axis and the outline of the light distribution shape object OBJ in a case where the horizontal diffusion degree Sx is 0%.

$$Px = ( {X}_{100} - {X}_{0} ) / 100 \qquad ( 1 )$$

The relation between the horizontal diffusion degree Sx and the position x0 of the first slider S1 on the display region DA on the XY plane is expressed by Expressions (2) and (3) below by using Expression (1) above.

$$Sx = ( x 0 - {X}_{0} ) / Px \qquad ( 2 )$$

$$x 0 = Sx \times Px + {X}_{0} \qquad ( 3 )$$

The vertical diffusion degree Sy of the illumination device 1 can be set based on the movement amount of a position y of an intersection point of the Y axis of the XY plane and the outline of the light distribution shape object OBJ, on the setting change screen 400 of the control device 200 according to the first embodiment.

In the present disclosure, the position y of the intersection point of the Y axis and the outline of the light distribution shape object OBJ is the central point of the second slider S2. In other words, a position y0 of the second slider S2 on the display region DA coincides with the position y of the intersection point of the Y axis and the outline of the light distribution shape object OBJ. Thus, the vertical diffusion degree Sy of the illumination device 1 can be set by touching the second slider S2 and moving the second slider S2 in the Y-axis direction. In FIG. 17, “Sy” indicates the vertical diffusion degree (for example, “50” %) of the illumination device 1.

The reference movement amount Py in the Y direction on the XY plane in a case where a vertical diffusion degree change amount ΔSy of the illumination device 1 is 1% is expressed by Expression (4) below, where Y₁₀₀ represents the intersection point of the Y axis and the outline of the light distribution shape object OBJ in a case where the vertical diffusion degree Sy is 100%, and Y₀ represents the intersection point of the Y axis and the outline of the light distribution shape object OBJ in a case where the vertical diffusion degree Sy is 0%.

$$P y = ( {Y}_{100} - {Y}_{0} ) / 100 \qquad ( 4 )$$

The relation between the vertical diffusion degree Sy and the position y0 of the second slider S2 on the display region DA on the XY plane is expressed by Expressions (5) and (6) below by using Expression (4) above.

$$S y = ( y 0 - {Y}_{0} ) / Py \qquad ( 5 )$$

$$y 0 = S y \times P y + {Y}_{0} \qquad ( 6 )$$

The above description is made on the aspect in which the light distribution shape object OBJ in a circular shape is displayed in a case where the horizontal diffusion degree Sx and the vertical diffusion degree Sy are both 0%, but the present disclosure is not limited thereto. For example, the origin O(0, 0) of the XY plane on the setting change screen 400 may be a position in a case where the horizontal diffusion degree Sx and the vertical diffusion degree Sy are both 0%.

Referring back to FIG. 15, if any one of the scene selection switches SCSEL is touched on the initial screen, the setting values (in the present disclosure, light diffusion degrees) of various setting parameters for each illumination device 1_n stored in the scene information SCENE_p of “SCENE_1”, “SCENE_2”, “SCENE_3”, . . . corresponding to the touched scene selection switch SCSEL are read from the storage region of the storage circuit 223, and changed setting values of various setting parameters of each illumination device 1_n are transmitted to the illumination device 1_n as the second setting information.

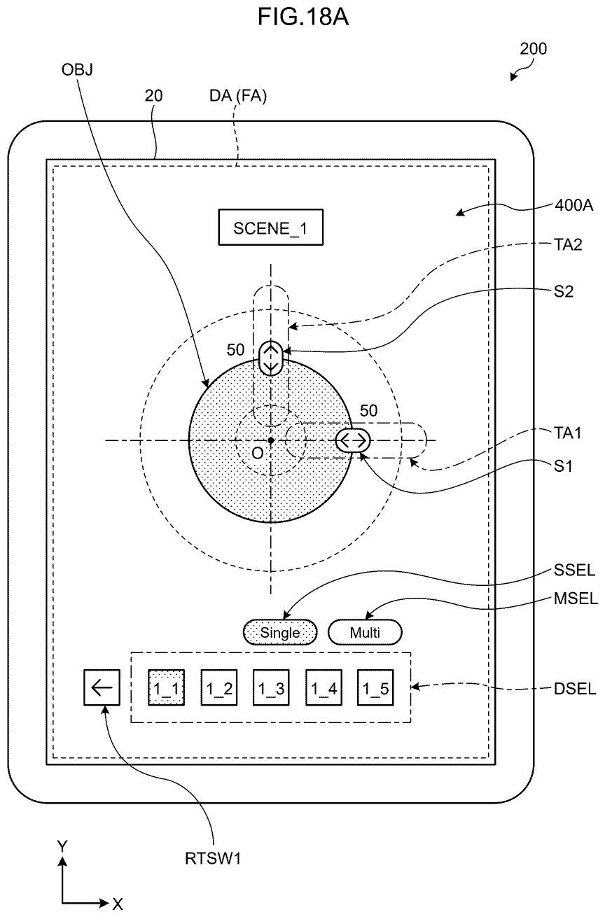

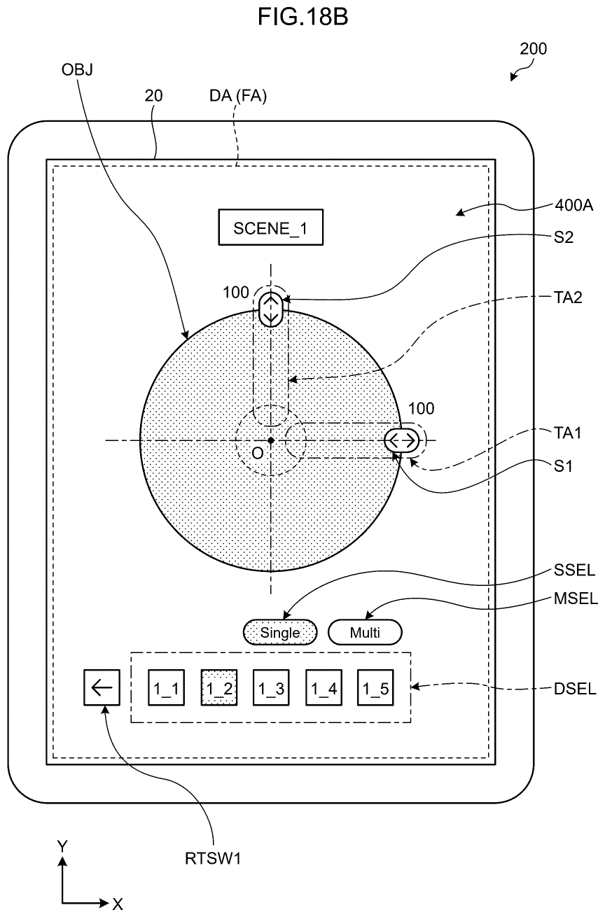

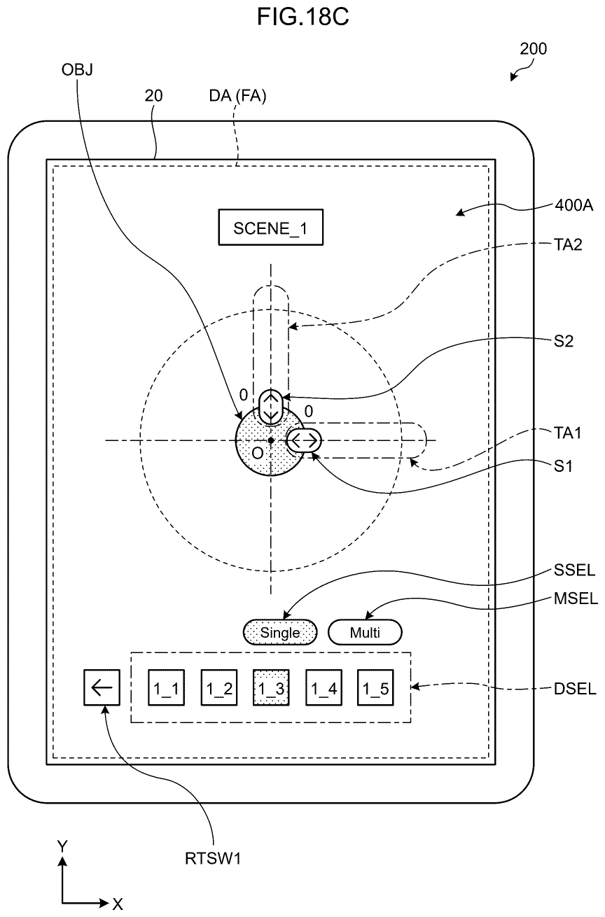

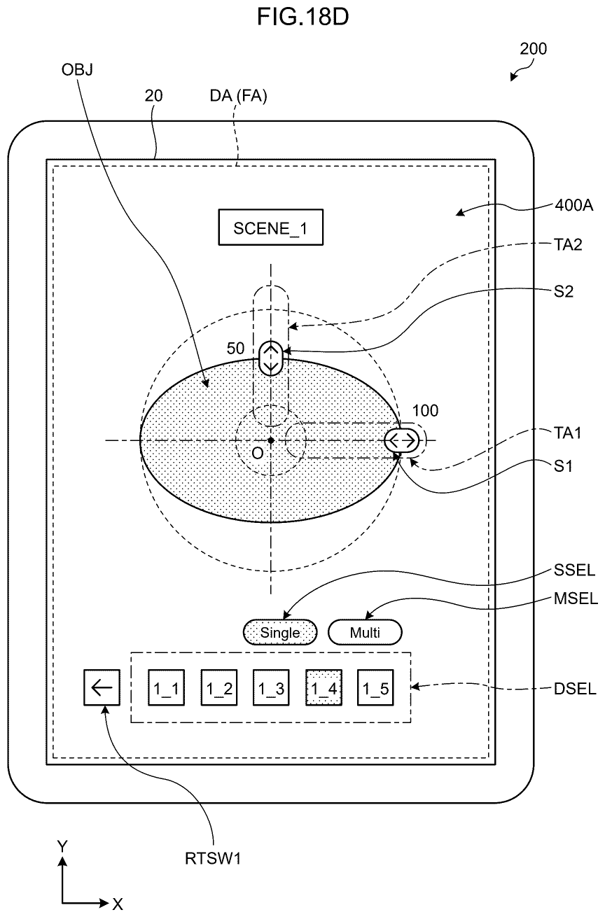

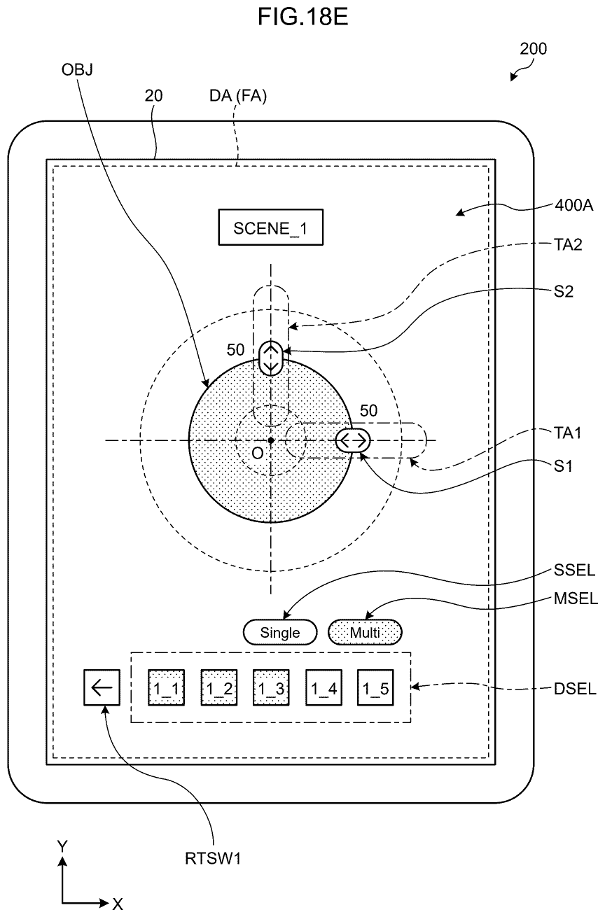

Then, if any one of the scene selection switches SCSEL is touched on the initial screen illustrated in FIG. 15, and in addition, any one of the device selection switches DSEL is touched, a transition is made to a scene setting change screen 400A of the illumination device 1_n corresponding to the touched device selection switch DSEL. FIGS. 18A, 18B, 18C, 18D, and 18E are conceptual diagrams illustrating an example of the display aspect of the scene setting change screen 400A on the control device 200 according to the first embodiment. FIGS. 18A, 18B, 18C, 18D, and 18E illustrate an example in which the scene selection switch SCSEL corresponding to “SCENE_1” is touched (selected).

In the display aspect of the scene setting change screen 400A on the control device 200 according to the first embodiment as illustrated in FIGS. 18A, 18B, 18C, 18D, and 18E, as in FIGS. 16A, 16B, 16C, 16D, and 16E, a light distribution shape object OBJ with a central point at the origin O(0, 0) of the XY plane on the scene setting change screen 400A is displayed, and the first slider S1 and the second slider S2 for setting the light diffusion degree of the illumination device 1 are disposed on the outline of the light distribution shape object OBJ.

FIG. 18A illustrates the scene setting change screen 400A in a case where the illumination device 1_1 is selected in “SCENE_1”. FIG. 18A illustrates an example in which the horizontal diffusion degree Sx and the vertical diffusion degree Sy of the illumination device 1_1 are both 50%.

FIG. 18B illustrates the scene setting change screen 400A in a case where the illumination device 1_2 is selected in “SCENE_1”. FIG. 18B illustrates an example in which the horizontal diffusion degree Sx and the vertical diffusion degree Sy of the illumination device 1_2 are both 100%.

FIG. 18C illustrates the scene setting change screen 400A in a case where the illumination device 1_3 is selected in “SCENE_1”. FIG. 18C illustrates an example in which the horizontal diffusion degree Sx and the vertical diffusion degree Sy of the illumination device 1_3 are both 0%.

FIG. 18D illustrates the scene setting change screen 400A in a case where the illumination device 1_4 is selected in “SCENE_1”. FIG. 18D illustrates an example in which the horizontal diffusion degree Sx of the illumination device 1_4 is 100% and the vertical diffusion degree Sy of the illumination device 1_4 is 50%.

FIG. 18E illustrates the scene setting change screen 400A in a case where the illumination device 1_5 is selected in “SCENE_1”. FIG. 18E illustrates an example in which the horizontal diffusion degree Sx and the vertical diffusion degree Sy of the illumination device 1_5 are both 50%.

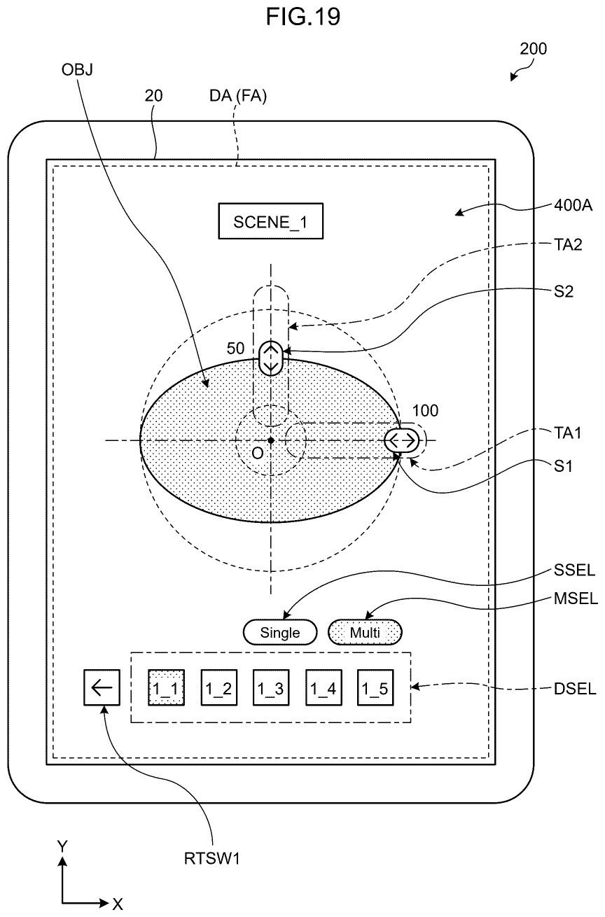

FIG. 19 is a conceptual diagram illustrating an example of the display aspect in a case where the first slider S1 is operated on the scene setting change screen 400A illustrated in FIG. 18A after device selection. In the example illustrated in FIG. 19, the first slider S1 for the illumination device 1_1 is operated to change setting of the horizontal diffusion degree Sx_1 from 50% to 100%.

As described above, a transition is made to the first registration screen illustrated in FIG. 20 if the first back button RTSW1 is touched after a setting change of the setting information (in the present disclosure, light diffusion degree information) of the illumination device 1_n is executed. FIG. 20 is a conceptual diagram illustrating an example of the display aspect of the first registration screen on the control device according to the first embodiment.

As illustrated in FIG. 20, a registration button RGSW and a second back button RTSW2 are provided in the display aspect of the first registration screen on the control device 200 according to the first embodiment.

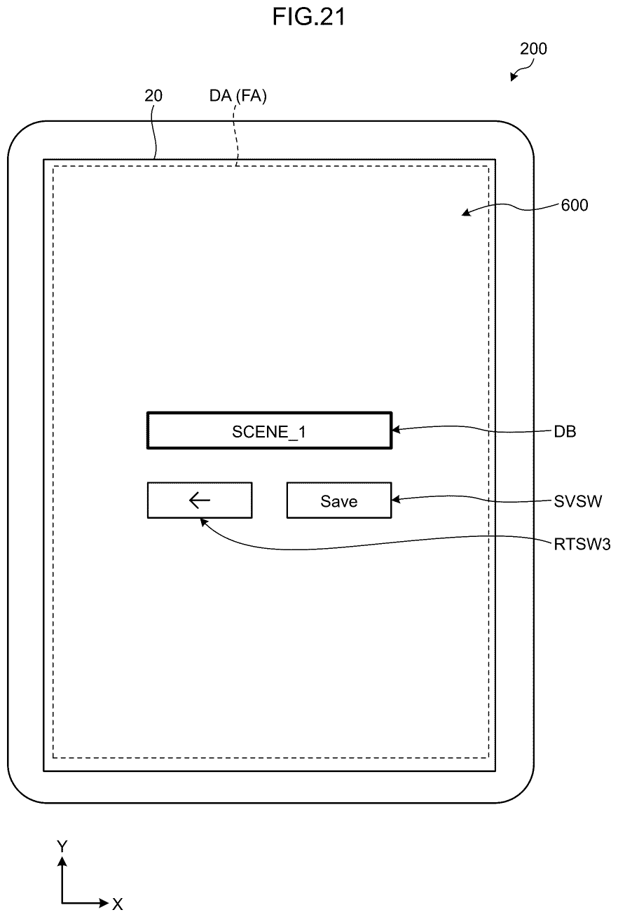

The registration button RGSW is, for example, a button (pictorial image) displayed as an icon for making a transition to a second registration screen illustrated in FIG. 21 by touching the registration button RGSW displayed on the first registration screen illustrated in FIG. 20. FIG. 21 is a conceptual diagram illustrating an example of the display aspect of the second registration screen on the control device according to the first embodiment.

As illustrated in FIG. 21, a dialog box DB, a save button SVSW, and a third back button RTSW3 are provided in the display aspect of the second registration screen on the control device 200 according to the first embodiment. The dialog box DB is a dialog box for inputting or changing the registration name of the scene information to which the setting change on the scene setting change screen 400A illustrated in FIGS. 18A, 18B, 18C, 18D, and 18E after device selection is applied.

The save button SVSW is, for example, a button (pictorial image) displayed as an icon for registering the setting-changed scene information with a registration name registered in the dialog box DB, by touching the save button SVSW displayed on the second registration screen illustrated in FIG. 21.

The third back button RTSW3 is, for example, a button (pictorial image) displayed as an icon for causing a return to the initial screen illustrated in FIG. 15 without registering the scene information having the setting change applied thereto, by touching the third back button RTSW3 displayed on the second registration screen illustrated in FIG. 21.

FIG. 21 illustrates an example in which “SCENE_1” is displayed as the registration name of the scene information in the dialog box DB. The dialog box DB is activated to be writable by, for example, a character input object (not illustrated) such as a keyboard after a transition to the second registration screen. Examples of scene registration names include names based on locations such as “living room”, “kitchen”, or “office”, and names based on time or events such as “morning”, “evening”, and “Christmas”.

If the save button SVSW is touched after the registration name of the scene information is changed or input, the scene information is stored with the input or changed registration name. If the third back button RTSW3 is touched on the second registration screen, a return is made to the initial screen illustrated in FIG. 15 without registering the scene information having the setting change applied thereto.

The following describes specific examples of processing by the control device 200 for the illumination device 1 and the illumination system according to the first embodiment described above.

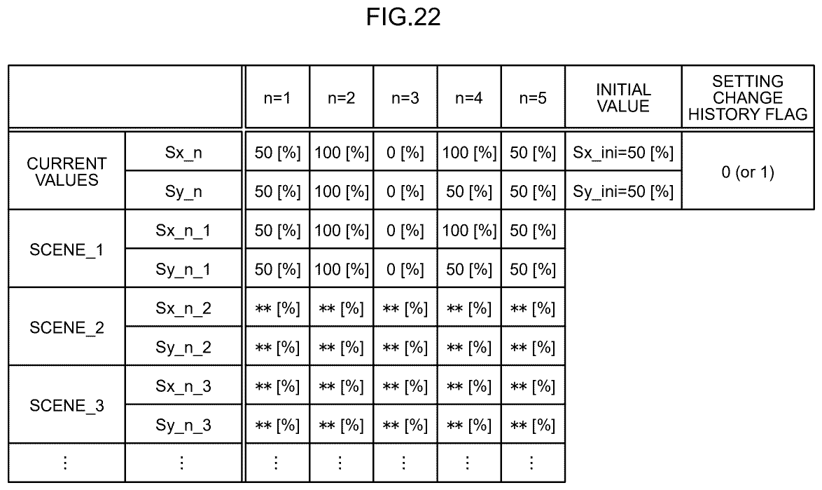

FIG. 22 is a conceptual diagram illustrating an example of a storage region in the control device 200 for the illumination device 1 according to the first embodiment.

In the first embodiment, the horizontal diffusion degree Sx_n and the vertical diffusion degree Sy_n of each control target device (illumination device 1_n or illumination device 1_1, 1_2, 1_3, 1_4, or 1_5 in this example) are stored in the storage circuit 223 of the control device 200 and transmitted as the first setting information (S1x_n and S1y_n) to the control target device (illumination device 1_n) as appropriate in each processing by the control device 200 for the illumination device 1 and the illumination system according to the first embodiment. The control target device (illumination device 1_n) stores the received first setting information (S1x_n and S1y_n) as the second setting information (S2x_n and S2y_n) in the storage circuit 113 of each illumination device 1 and is driven and controlled in accordance with the second setting information stored in the storage circuit 113. As illustrated in FIG. 22, a horizontal diffusion degree Sx_ini (in FIG. 22, 50%) and a vertical diffusion degree Sy_ini (in FIG. 22, 50%) that are initial values (default values) of the horizontal diffusion degree Sx_n and the vertical diffusion degree Sy_n are stored in the storage circuit 223 of the control device 200.

A setting change history flag is reset (“0”) upon activation of the illumination control application. The setting change history flag is stored in the storage circuit 223 of the control device 200. The setting change history flag is set to “1” if the setting information is changed in each processing by the control device 200 for the illumination device 1 and the illumination system according to the first embodiment.

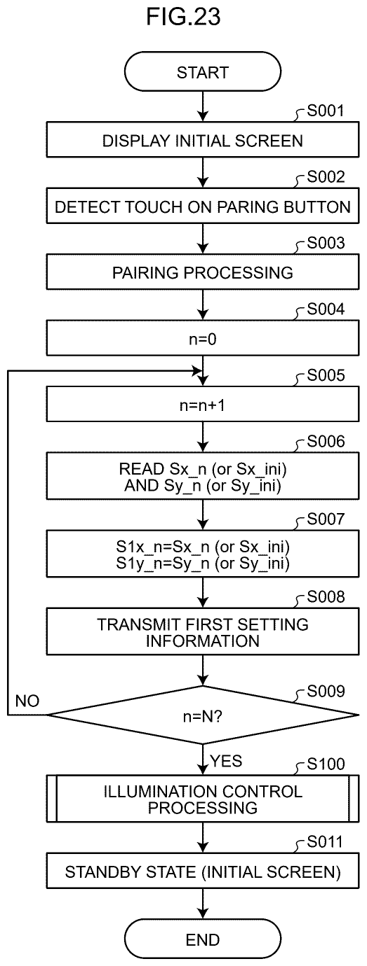

In the present disclosure, as illustrated in FIG. 22, each scene information SCENE_p (p=1, 2, 3, . . . ) in which the setting values of various setting parameters (in the present disclosure, light diffusion degrees) are set for each control target device (illumination device 1_n or illumination device 1_1, 1_2, 1_3, 1_4, or 1_5 in this example) is stored in the storage circuit 223 of the control device 200. Each scene information SCENE_p (p=1, 2, 3, . . . ) is set as appropriate in processing (refer to FIGS. 23 to 29) to be described later.

Processing during execution of the above-described illumination control application is achieved by application software executed by, for example, the CPU of a smartphone, a tablet, or the like constituting the control device 200. After the illumination control application is activated on the control device 200, the initial screen illustrated in FIG. 15 is displayed on the display region DA.

FIG. 23 is a flowchart illustrating an example of initial setting processing by the control device 200 for the illumination device 1 according to the first embodiment. After the illumination control application is activated on the control device 200, the initial screen of the illumination control application illustrated in FIG. 15 is displayed on the display region DA (step S001).

Before activation of the illumination control application, the illumination devices 1_n registered in advance in a space where pairing with the control device 200 is possible are activated.

If the pairing button PEXE is touched on the initial screen of the illumination control application illustrated in FIG. 15 (step S002), the transmission-reception circuit 225 of the control device 200 executes pairing processing with any illumination device 1_n registered as a control target device in advance and activated in a space where pairing with the control device 200 is possible (step S003), and the horizontal diffusion degree Sx_n (current value Sx_n illustrated in FIG. 22) and the vertical diffusion degree Sy_n (current value Sy_n illustrated in FIG. 22) at the previous end of the illumination control application are transmitted as the first setting information (S1x_n and S1y_n) by the transmission-reception circuit 225. The current values (horizontal diffusion degree Sx_n and vertical diffusion degree Sy_n) illustrated in FIG. 22 refers to displayed values on the setting change screen 400 (or the scene setting change screen 400A).

In initial activation of the illumination control application, the transmission-reception circuit 225 of the control device 200 registers, as a control target device, for example, any illumination device 1_n activated in a space where pairing is possible, and transmits, to the registered control target device (illumination device 1_n), the first setting information (S1x_n and S1y_n) including the initial value (for example, Sx_ini=50% illustrated in FIG. 22) of the horizontal diffusion degree Sx as the horizontal diffusion degree Sx_n and the initial value (for example, Sy_ini=50% illustrated in FIG. 22) of the vertical diffusion degree Sy as the vertical diffusion degree Sy_n.

Specifically, the transmission-reception circuit 225 resets a device counter value n (n=0; step S004), adds one to the device counter value n (n=n+1; step S005), reads the horizontal diffusion degree Sx_n (or Sx_ini) and the vertical diffusion degree Sy_n (or Sy_ini) stored in the storage circuit 223 (step S006), sets the read horizontal diffusion degree Sx_n (or Sx_ini) and vertical diffusion degree Sy_n (or Sy_ini) as the first setting information (S1x_n=Sx_n (or Sx_ini) and S1y_n=Sy_n (or Sy_ini); step S007), and transmits the first setting information to the illumination device 1_n (step S008).

The transmission-reception circuit 111 of the illumination device 1_1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

The transmission-reception circuit 225 determines whether the first setting information is transmitted to all control target devices (illumination devices 1_n or illumination devices 1_1, 1_2, 1_3, 1_4, and 1_5 in this example). Specifically, the control device 200 determines whether the device counter value n is equal to N (step S009).

In the case of n<N (No at step S009), the processing from step S005 to step S009 is repeatedly executed. Specifically, the transmission-reception circuit 225 adds one to the device counter value n (n=n+1; step S005) and transmits the first setting information to the illumination device 1_n corresponding to the device counter value n (step S008).

The transmission-reception circuit 111 of the illumination device 1_n stores the received first setting information (S1x_n and S1y_n) as the second setting information (S2x_n and S2y_n) in the storage circuit 113, reads the second setting information stored in the storage circuit 113, and supplies drive voltage corresponding to the second setting information to the drive electrodes 10 and 13 of each liquid crystal cell 2 of the optical element 100.

If the first setting information is transmitted to all control target devices (illumination devices 1_n or illumination devices 1_1, 1_2, 1_3, 1_4, and 1_5 in this example) (Yes at step S009), the liquid crystal cells 2 of the optical element 100 are driven in each control target device (illumination device 1_n or illumination device 1_1, 1_2, 1_3, 1_4, or 1_5 in this example).

If the first setting information is transmitted to all control target devices (illumination devices 1_n or illumination devices 1_1, 1_2, 1_3, 1_4, and 1_5 in this example) (Yes at step S009 in FIG. 23), the control device 200 for the illumination device 1 according to the first embodiment executes the illumination control processing (step S100).

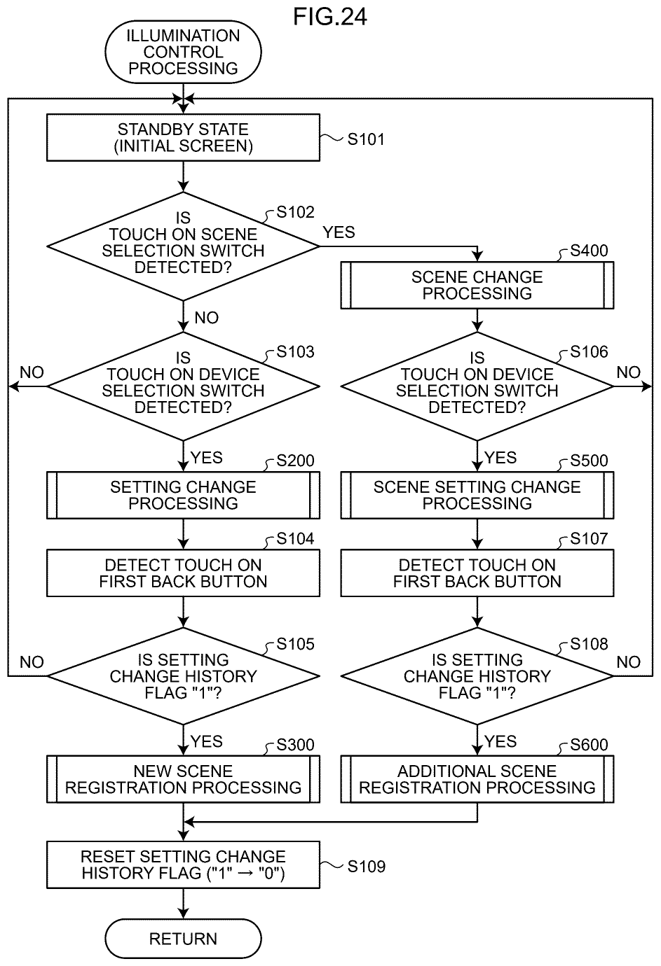

After the illumination control processing at step S100 is executed, a transition is made to a standby state of the initial screen of the illumination control application illustrated in FIG. 15 (step S011). If the illumination control application is ended in the standby state of the initial screen of the illumination control application, control of the illumination devices 1_n by the control device 200 ends. FIG. 24 is a flowchart illustrating an example of the overall flow of the illumination control processing by the control device 200 for the illumination device 1 according to the first embodiment.

In the illumination control processing illustrated in FIG. 24 by the control device 200 for the illumination device 1 according to the first embodiment, the control device 200 determines whether any of the scene selection switches SCSEL is touched in the standby state (step S101) of the initial screen of the illumination control application illustrated in FIG. 15 (step S102). If none of the scene selection switches SCSEL is touched (No at step S102), the control device 200 subsequently determines whether any of the device selection switches DSEL is touched (step S103). If none of the device selection switches DSEL is touched (No at step S103), a return is made to the standby state of the initial screen of the illumination control application illustrated in FIG. 15 (step S101).

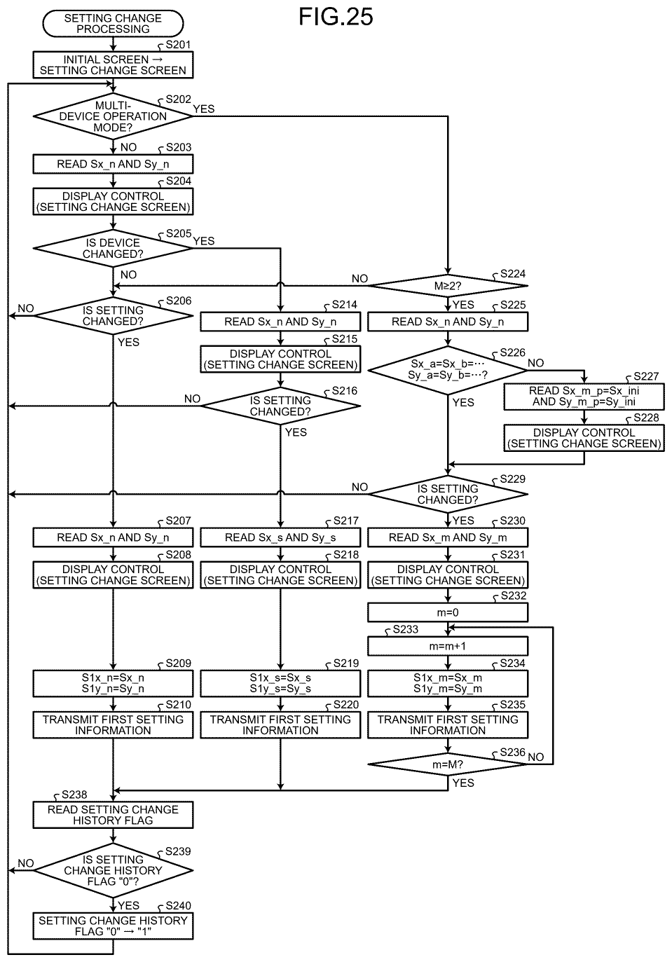

If any of the device selection switches DSEL is touched (Yes at step S103), the setting change processing is executed (step S200). FIG. 25 is a flowchart illustrating an example of the setting change processing by the control device 200 for the illumination device 1 according to the first embodiment.

In the setting change processing illustrated in FIG. 25 by the control device 200 for the illumination device 1 according to the first embodiment, the control device 200 transitions from the initial screen of the illumination control application illustrated in FIG. 15 to the setting change screen 400 illustrated in any of FIGS. 16A, 16B, 16C, 16D, and 16E (step S201) and determines whether the multi-device operation mode is selected (step S202).

If the single-device operation mode is selected and an illumination device 1_n is selected (No at step S202), the display control circuit 231 of the control device 200 reads the horizontal diffusion degree Sx_n and the vertical diffusion degree Sy_n of the illumination device 1_n (step S203) stored in the storage region of the storage circuit 223, and executes display control of the display panel 20 (step S204).

Subsequently, the control device 200 determines whether the operation target device is changed (step S205).

If the operation target device is not changed (No at step S205), the display control circuit 231 of the control device 200 determines whether a setting change of the setting information (in the present disclosure, light diffusion degree information) of the illumination device 1_n is executed (step S206). If a setting change of the setting information of the illumination device 1_n is not executed (No at step S206), the control device 200 returns to the processing at step S202.

The following describes a specific operation example of the setting change of the setting information (in the present disclosure, light diffusion degree information) according to the first embodiment. Specifically, the conversion processing circuit 212 executes, for example, touch detection processing for the first slider S1 and touch detection processing for the second slider S2 on the setting change screen 400. If the first slider S1 is touched, the conversion processing circuit 212 calculates the current horizontal diffusion degree Sx_n of the illumination device 1_n based on the X-directional position of the first slider S1 on the detection region FA and stores the current horizontal diffusion degree Sx_n in the storage region of the storage circuit 223. More specifically, by such an operation on the first slider S1, the current value of the horizontal diffusion degree Sx_n of the illumination device 1_n illustrated in FIG. 19 is updated and overwritten. If the second slider S2 is touched, the conversion processing circuit 212 calculates the current vertical diffusion degree Sy_n of the illumination device 1_n based on the Y-directional position of the second slider S2 on the detection region FA and stores the current vertical diffusion degree Sy_n in the storage region of the storage circuit 223. More specifically, by such an operation on the second slider S2, the current value of the vertical diffusion degree Sy_n of the illumination device 1_n illustrated in FIG. 19 is updated and overwritten.

If a setting change of the setting information of the illumination device 1_n is executed on the setting change screen 400 (Yes at step S206), the display control circuit 231 of the control device 200 reads the displayed current values of the horizontal diffusion degree Sx_n and the vertical diffusion degree Sy_n of the illumination device 1_n overwritten by making the setting change on the setting change screen 400 (step S207), and executes display control of the display panel 20 (step S208).

The transmission-reception circuit 225 of the control device 200 transmits the first setting information to the illumination device 1_n. Specifically, the transmission-reception circuit 225 sets the displayed current values of the horizontal diffusion degree Sx_n and the vertical diffusion degree Sy_n of the illumination device 1_n as the first setting information (S1x_n=Sx_n and S1y_n=Sy_n; step S209) and transmits the first setting information to the illumination device 1_n (step S210).

Then, the control device 200 reads the setting change history flag stored in the storage region of the storage circuit 223 (step S238) and determines whether the setting change history flag is “0” (step S239). If the setting change history flag is “0” (Yes at step S239), the control device 200 changes the setting change history flag stored in the storage circuit 223 from “0” to “1” (step S240) and returns to the processing at step S202.

In the first embodiment, the setting change history flag of “0” (Yes at step S239) indicates a state in which no setting change of the setting information is performed for all control target devices (illumination devices 1_n or illumination devices 1_1, 1_2, 1_3, 1_4, and 1_5 in this example) in the setting change processing illustrated in FIG. 25 by the control device 200 for the illumination device 1 according to the first embodiment. Alternatively, the setting change history flag of “0” indicates that the screen is operated for a setting change but finally returned to the same state as that before the setting change. On the other hand, the setting change history flag of “1” indicates a state in which a setting change of the setting information (in this example, at least one of the horizontal diffusion degree Sx_n and the vertical diffusion degree Sy_n of the illumination device 1_1, 1_2, 1_3, 1_4, or 1_5) of one of all control target devices (illumination devices 1_n or illumination devices 1_1, 1_2, 1_3, 1_4, and 1_5 in this example) is made in the setting change processing illustrated in FIG. 25 by the control device 200 for the illumination device 1 according to the first embodiment. In other words, the setting change history flag of “0” indicates that none of the horizontal diffusion degree Sx_n and the vertical diffusion degree Sy_n of the illumination device 1_n selected as the operation target device is changed, and the setting change history flag of “1” indicates that at least one of the horizontal diffusion degree Sx_n and the vertical diffusion degree Sy_n of the illumination device 1_n selected as the operation target device is changed.

The transmission-reception circuit 111 of the illumination device 1_n stores the received first setting information (S1x_n and S1y_n) as the second setting information (S2x_n and S2y_n) in the storage circuit 113. The electrode drive circuit 112 of the illumination device 1_n supplies drive voltage corresponding to the second setting information stored in the storage circuit 113 to the drive electrodes 10 and 13 of each liquid crystal cell 2 of the optical element 100.

If the operation target device is changed (Yes at step S205), the display control circuit 231 of the control device 200 reads the displayed current values of a horizontal diffusion degree Sx_s and a vertical diffusion degree Sy_s of an illumination device 1_s selected as the operation target device (step S214) and executes display control of the display panel 20 (step S215).

Subsequently, the display control circuit 231 of the control device 200 determines whether a setting change of the setting information (in the present disclosure, light diffusion degree information) of the illumination device 1_s is executed (step S216). If a setting change of the setting information is not executed (No at step S216), the control device 200 returns to the processing at step S202.

If a setting change of the setting information of the illumination device 1_s is executed on the setting change screen 400 (Yes at step S216), the display control circuit 231 of the control device 200 reads the displayed current values of the horizontal diffusion degree Sx_s and the vertical diffusion degree Sy_s of the illumination device 1_s overwritten by making the setting change on the setting change screen 400 (step S217) and executes display control of the display panel 20 (step S218).

The transmission-reception circuit 225 of the control device 200 transmits the first setting information to the illumination device 1_s. Specifically, the transmission-reception circuit 225 sets the horizontal diffusion degree Sx_s and the vertical diffusion degree Sy_s, which are the displayed current values, as the first setting information (S1x_s=Sx_s and S1y_s=Sy_s; step S219) and transmits the first setting information to the illumination device 1_s (step S220).

Then, the control device 200 reads the setting change history flag stored in the storage region of the storage circuit 223 (step S238) and determines whether the setting change history flag is “0” (step S239). If the setting change history flag is “0” (Yes at step S239), the control device 200 changes the setting change history flag stored in the storage circuit 223 from “0” to “1” (step S240) and returns to the processing at step S202.

The transmission-reception circuit 111 of the illumination device 1_s stores the received first setting information (S1x_s and S1y_s) as the second setting information (S2x_s and S2y_s) in the storage circuit 113. The electrode drive circuit 112 of the illumination device 1_s supplies drive voltage corresponding to the second setting information stored in the storage circuit 113 to the drive electrodes 10 and 13 of each liquid crystal cell 2 of the optical element 100.

If the multi-device operation mode is selected on the setting change screen 400 (Yes at step S202), the control device 200 determines whether the number M of illumination devices 1 selected as operation target devices in the multi-device operation mode is equal to or larger than two (step S224). If only one illumination device 1 is selected as an operation target device (M=1; No at step S224), the control device 200 determines whether a setting change of the setting information of the illumination device 1_n selected as the operation target device is executed (step S206). If a setting change of the setting information of the illumination device 1_n is not executed (No at step S206), the control device 200 returns to the processing at step S202.

If a setting change of the setting information of the illumination device 1_n is executed on the setting change screen 400 (Yes at step S206), the display control circuit 231 of the control device 200 reads the displayed current values of the horizontal diffusion degree Sx_n and the vertical diffusion degree Sy_n of the illumination device 1_n overwritten by making the setting change on the setting change screen 400 (step S207), and executes display control of the display panel 20 (step S208).

The transmission-reception circuit 225 of the control device 200 transmits the first setting information to the illumination device 1_n. Specifically, the transmission-reception circuit 225 sets the displayed current values of the horizontal diffusion degree Sx_n and the vertical diffusion degree Sy_n of the illumination device 1_n as the first setting information (S1x_n=Sx_n and S1y_n=Sy_n; step S209) and transmits the first setting information to the illumination device 1_n (step S210).

Then, the control device 200 reads the setting change history flag stored in the storage region of the storage circuit 223 (step S238) and determines whether the setting change history flag is “0” (step S239). If the setting change history flag is “0” (Yes at step S239), the control device 200 changes the setting change history flag stored in the storage circuit 223 from “0” to “1” (step S240) and returns to the processing at step S202.

The transmission-reception circuit 111 of the illumination device 1_n stores the received first setting information (S1x_n and S1y_n) as the second setting information (S2x_n and S2y_n) in the storage circuit 113. The electrode drive circuit 112 of the illumination device 1_n supplies drive voltage corresponding to the second setting information stored in the storage circuit 113 to the drive electrodes 10 and 13 of each liquid crystal cell 2 of the optical element 100.

If the number M illumination devices 1 selected as operation target devices in the multi-device operation mode is equal to or larger than two (M≥2; Yes at step S224), the control device 200 reads a horizontal diffusion degree Sx_m and a vertical diffusion degree Sy_m of each of M illumination devices 1_m (1_a, 1_b, . . . ) selected as operation target devices in the multi-device operation mode from the storage region of the storage circuit 223 (step S225) and determines whether the light distribution shapes of the M illumination devices 1_m (1_a, 1_b, . . . ) are identical to one another. Specifically, the control device 200 determines whether the horizontal diffusion degrees Sx_m (Sx_a, Sx_b, . . . ) of the M illumination devices 1_m (1_a, 1_b, . . . ) are identical to one another and the vertical diffusion degrees Sy_m (Sy_a, Sy_b, . . . ) of the M illumination devices 1_m (1_a, 1_b, . . . ) are identical to one another (step S226).

If the light distribution shapes of the M illumination devices 1_m (1_a, 1_b, . . . ) selected as the operation target devices in the multi-device operation mode are identical to one another (Yes at step S226), a transition is made to step S229.

If the light distribution shapes of the M illumination devices 1_m (1_a, 1_b, . . . ) selected as the operation target devices in the multi-device operation mode are different from one another (No at step S226), displaying only the light distribution shape of a particular illumination device on the screen makes it difficult for the user to determine, based on the screen display only, which illumination device has the light distribution shape or whether the light distribution shapes of all illumination devices are the same as the displayed light distribution shape. Thus, in this case, the display control circuit 231 of the control device 200 reads the horizontal diffusion degree Sx_ini (in FIG. 22, 50%) that is the initial value (default value) of the horizontal diffusion degree Sx_n stored in the storage region of the storage circuit 223, and sets the horizontal diffusion degree Sx_ini as the current values of the horizontal diffusion degrees Sx_m of the illumination devices 1_m, and in addition, reads the vertical diffusion degree Sy_ini (in the example illustrated in FIG. 22, 50%) that is the initial value of the vertical diffusion degree Sy_n, and sets the vertical diffusion degree Sy_ini as the current values of the vertical diffusion degrees Sy_m of the illumination devices 1_m (Sx_m=Sx_ini and Sy_m=Sy_ini; step S227), and then executes display control of the display panel 20 (step S228), and a transition is made to step S229.

The display control circuit 231 of the control device 200 determines whether a setting change of each of the illumination devices 1_m selected as the operation target devices in the multi-device operation mode is executed (step S229). If a setting change of the setting information is not executed (No at step S229), the control device 200 returns to the processing at step S202.

If a setting change of the setting information of each of the illumination devices 1_m is executed on the setting change screen 400 (Yes at step S229), the display control circuit 231 of the control device 200 reads the displayed current values of the horizontal diffusion degrees Sx_m and the vertical diffusion degrees Sy_m of the illumination devices 1_m overwritten by making the setting change on the setting change screen 400 (step S230), and executes display control of the display panel 20 (step S231).

The transmission-reception circuit 225 of the control device 200 transmits the horizontal diffusion degrees Sx_m and the vertical diffusion degrees Sy_m overwritten by making the setting change on the setting change screen 400, as the first setting information to the illumination devices 1_m selected as the operation target devices in the multi-device operation mode. Specifically, the transmission-reception circuit 225 resets a device counter value m (m=0; step S232), adds one to the device counter value m (m=m+1; step S233), sets the displayed current values of the horizontal diffusion degrees Sx_m and the vertical diffusion degrees Sy_m of the illumination devices 1_m as the first setting information (S1x_m=Sx_m and S1y_m=Sy_m; step S234), and transmits the first setting information to the illumination device corresponding to the device counter value m (step S235).

The transmission-reception circuit 225 determines whether the first setting information is transmitted to all operation target devices (illumination devices 1_m). Specifically, the control device 200 determines whether the device counter value m is equal to M (step S236).

In the case of m<M (No at step S236), the processing from step S233 to step S236 is repeatedly executed. Specifically, the transmission-reception circuit 225 adds one to the device counter value m (m=m+1; step S233) and transmits the first setting information to the illumination device 1_m corresponding to the device counter value m (step S235).

Then, the control device 200 reads the setting change history flag stored in the storage region of the storage circuit 223 (step S238) and determines whether the setting change history flag is “0” (step S239). If the setting change history flag is “0” (Yes at step S239), the control device 200 changes the setting change history flag stored in the storage circuit 223 from “0” to “1” (step S240) and returns to the processing at step S202.

The transmission-reception circuits 111 of the M illumination devices 1_m each store the received first setting information (S1x_m and S1y_m) as the second setting information (S2x_m and S2y_m) in the storage circuit 113. The electrode drive circuit 112 of each illumination device 1_m supplies drive voltage corresponding to the second setting information stored in the storage circuit 113 to the drive electrodes 10 and 13 of each liquid crystal cell 2 of the optical element 100.

The above-described processing from step S233 to step S236 is executed until m=M (Yes at step S236). Accordingly, the same setting change is executed for the M illumination devices 1_m selected as the operation target devices in the multi-device operation mode.

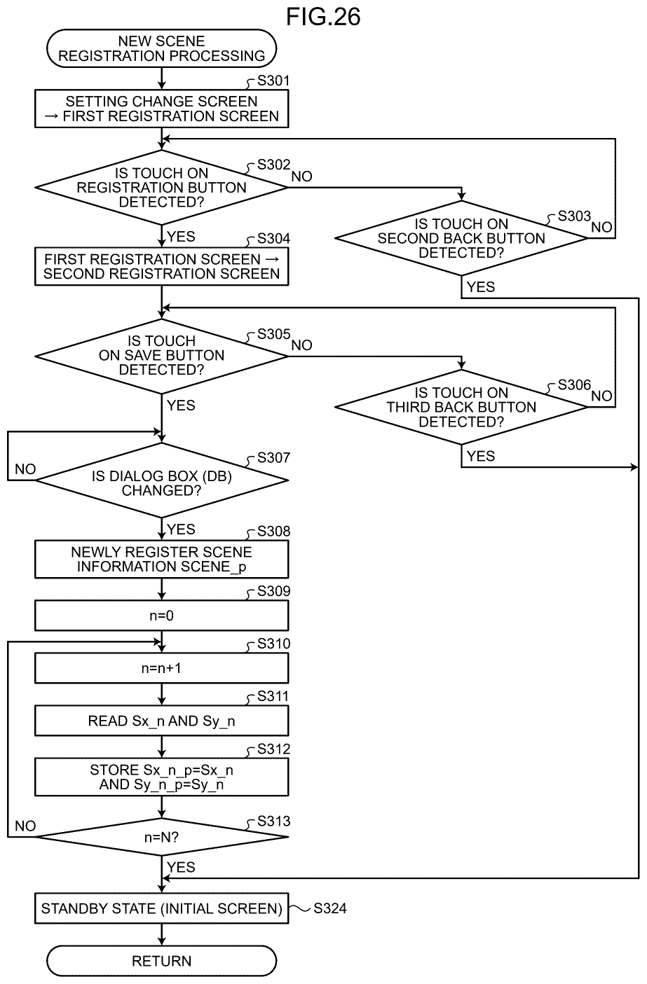

Referring back to FIG. 24, the control device 200 determines whether the setting change history flag is “1” (step S105). If the setting change history flag is “0” (No at step S105), a return is made to the standby state of the initial screen of the illumination control application illustrated in FIG. 15 (step S101). If the setting change history flag is “1” (Yes at step S105), a transition is made to a standby state of the first registration screen illustrated in FIG. 20 to execute new scene registration processing (step S300). FIG. 26 is a flowchart illustrating an example of the new scene registration processing by the control device 200 for the illumination device 1 according to the first embodiment.

In the new scene registration processing illustrated in FIG. 26 by the control device 200 for the illumination device 1 according to the first embodiment, the control device 200 transitions from any of FIGS. 16A, 16B, 16C, 16D, and 16E to a first registration screen 500 illustrated in FIG. 20 (step S301) and executes touch detection processing of the registration button RGSW (step S302), and touch detection processing of the second back button RTSW2 (step S303).

Specifically, if the registration button RGSW is touched (Yes at step S302), the control device 200 transitions from the first registration screen 500 illustrated in FIG. 20 to a second registration screen 600 illustrated in FIG. 21 (step S304).

The control device 200 transitions to step S303 if the registration button RGSW is not touched (No at step S302), and the control device 200 repeatedly executes the processing at steps S302 and S303 if the second back button RTSW2 is not touched (No at step S303). If the second back button RTSW2 is touched (Yes at step S303), the control device 200 transitions to the standby state of the initial screen of the illumination control application illustrated in FIG. 15 (step S324).

In a standby state of the second registration screen 600 (step S304), the conversion processing circuit 212 of the control device 200 executes touch detection processing of the save button SVSW (step S305) and touch detection processing of the third back button RTSW3 (step S306).

Specifically, the control device 200 transitions to step S306 if the save button SVSW is not touched (No at step S305), and the control device 200 repeatedly executes the processing at steps S305 and S306 if the third back button RTSW3 is not touched (No at step S306). If the third back button RTSW3 is touched (Yes at step S306), the control device 200 transitions to the standby state of the initial screen of the illumination control application illustrated in FIG. 15 (step S324).

If the save button SVSW is touched (Yes at step S305), the conversion processing circuit 212 of the control device 200 determines whether a registration name of the scene information is input in the dialog box DB (step S307). If no registration name of the scene information is input in the dialog box DB (No at step S307), the processing at step S307 is repeatedly executed until a registration name of the scene information is input in the dialog box DB. If a registration name of the scene information is input in the dialog box DB (Yes at step S307), the scene information is registered with the input registration name (step S308). In FIG. 26, the scene information SCENE_p is a new registration target.

If the save button SVSW is touched while the dialog box DB is blank, for example, a caution object indicating that the dialog box DB is blank may be displayed. The operation aspect in a case where the save button SVSW is touched while the dialog box DB is blank is not limited to the above description, and for example, a cursor that prompts inputting of a registration name of the scene information in the dialog box DB may be displayed in a flashing manner.

The scene setting processing circuit 241 of the control device 200 resets the device counter value n (n=0; step S309), adds one to the device counter value n (n=n+1; step S310), and reads the current values of the horizontal diffusion degree Sx_n and the vertical diffusion degree Sy_n of the illumination device 1_n corresponding to the device counter value n from the storage region of the storage circuit 223 (step S311). Then, the read current values of the horizontal diffusion degree Sx_n and the vertical diffusion degree Sy_n of the illumination device 1_n are stored in the storage region of the storage circuit 223 as a horizontal diffusion degree Sx_1_p and a vertical diffusion degree Sy_1_p of the illumination device 1_n corresponding to the device counter value n in the scene information SCENE_p as a registration target (Sx_1_p=Sx_1 and Sy_1_p=Sy_1; step S312).

The scene setting processing circuit 241 determines whether a horizontal diffusion degree Sx_n_p and a vertical diffusion degree Sy_n_p of the scene information SCENE_p are stored for all control target devices (illumination devices 1_n). Specifically, the scene setting processing circuit 241 determines whether the device counter value n is equal to N (step S313).

In the case of n<N (No at step S313), the scene setting processing circuit 241 repeatedly executes the processing from step S310 to step S313. Accordingly, the horizontal diffusion degree Sx_n_p and the vertical diffusion degree Sy_n_p of each control target device (illumination device 1_n or illumination device 1_1, 1_2, 1_3, 1_4, or 1_5 in this example) in the scene information SCENE_p are stored as newly registered setting information of the scene information SCENE_p in the storage region of the storage circuit 223. Through this processing, the setting information of the control target devices (illumination devices 1_n) and the scene information SCENE_p are associated with each other.

Then, in the case of n=N (Yes at step S313), the control device 200 transitions to the standby state of the initial screen of the illumination control application illustrated in FIG. 15 (step S324).

After transitioning to the standby state of the initial screen of the illumination control application illustrated in FIG. 15 (step S324), the control device 200 returns to the illumination control processing illustrated in FIG. 24 and resets the setting change history flag (from “1” to “0”; step S109). Then, if the illumination control application is ended in the standby state of the initial screen of the illumination control application illustrated in FIG. 15, control of the illumination devices 1_n by the control device 200 ends.

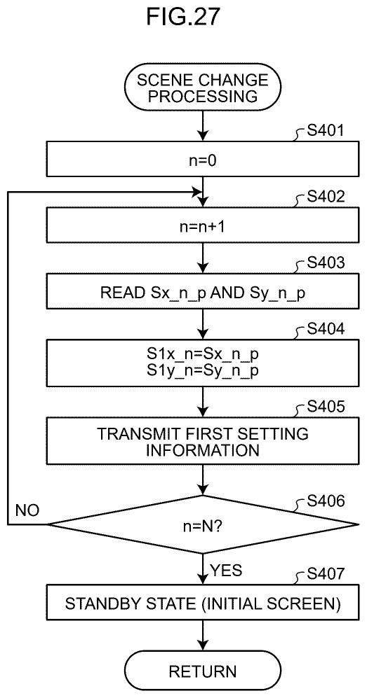

In FIG. 24, if any of the scene selection switches SCSEL is touched (Yes at step S102), the control device 200 executes scene change processing (step S400). FIG. 27 is a flowchart illustrating an example of the scene change processing by the control device 200 for the illumination device 1 according to the first embodiment.

If any of the scene selection switches SCSEL is touched on the initial screen of the illumination control application illustrated in FIG. 15, a transition is made to the scene change processing illustrated in FIG. 27.

In the scene change processing illustrated in FIG. 27 by the control device 200 for the illumination device 1 according to the first embodiment, the transmission-reception circuit 225 of the control device 200 transmits the horizontal diffusion degree Sx_n_p and the vertical diffusion degree Sy_n_p of selected scene information (in this example, the scene information SCENE_p) as the first setting information for each control target device (illumination device 1_n). Specifically, the transmission-reception circuit 225 resets the device counter value n (n=0; step S401), adds one to the device counter value n (n=n+1; step S402), reads the horizontal diffusion degree Sx_n_p and the vertical diffusion degree Sy_n_p stored in the storage circuit 223 (step S403), sets the read horizontal diffusion degree Sx_n_p and vertical diffusion degree Sy_n_p as the first setting information (S1x_n=Sx_n_p and S1y_n=Sy_n_p; step S404), and transmits the first setting information to the illumination device 1_n (step S405).

The transmission-reception circuit 111 of the illumination device 1_1 stores the received first setting information as the second setting information in the storage circuit 113, reads the second setting information stored in the storage circuit 113, and supplies drive voltage corresponding to the second setting information to the drive electrodes 10 and 13 of each liquid crystal cell 2 of the optical element 100.

The transmission-reception circuit 225 determines whether the first setting information is transmitted to all control target devices (illumination devices 1_n or illumination devices 1_1, 1_2, 1_3, 1_4, and 1_5 in this example). Specifically, the control device 200 determines whether the device counter value n is equal to N (step S406).

In the case of n<N (No at step S406), the processing from step S402 to step S406 is repeatedly executed. Specifically, the transmission-reception circuit 225 adds one to the device counter value n (n=n+1; step S402) and transmits the first setting information to the illumination device 1_n corresponding to the device counter value n (step S405). Through this processing, the setting information of each control target device (illumination device 1_n) set for the scene information SCENE_p is transmitted to an illumination device 1_n associated in the new scene registration processing illustrated in FIG. 26.

The transmission-reception circuit 111 of the illumination device 1_n stores the received first setting information (S1x_n and S1y_n) as the second setting information (S2x_n and S2y_n) in the storage circuit 113, reads the second setting information stored in the storage circuit 113, and supplies drive voltage corresponding to the second setting information to the drive electrodes 10 and 13 of each liquid crystal cell 2 of the optical element 100.

If the first setting information is transmitted to all control target devices (illumination devices 1_n or illumination devices 1_1, 1_2, 1_3, 1_4, and 1_5 in this example) (Yes at step S406), the horizontal diffusion degree Sx_n_p and the vertical diffusion degree Sy_n_p of the selected scene information (in this example, the scene information SCENE_p) are reflected onto the driving of the liquid crystal cells 2 of the optical element 100 in each control target device (illumination device 1_n or illumination device 1_1, 1_2, 1_3, 1_4, or 1_5 in this example).

If the first setting information corresponding to the selected scene information (in this example, the scene information SCENE_p) is transmitted to all control target devices (illumination devices 1_n or illumination devices 1_1, 1_2, 1_3, 1_4, and 1_5 in this example) (Yes at step S406 in FIG. 27), the control device 200 for the illumination device 1 according to the first embodiment transitions to the standby state of the initial screen of the illumination control application illustrated in FIG. 15 (step S407).

Referring back to FIG. 24, the control device 200 determines whether any of the device selection switches DSEL is touched (step S106). If none of the device selection switches DSEL is touched (No at step S106), a return is made to the standby state of the initial screen of the illumination control application illustrated in FIG. 15 (step S101).

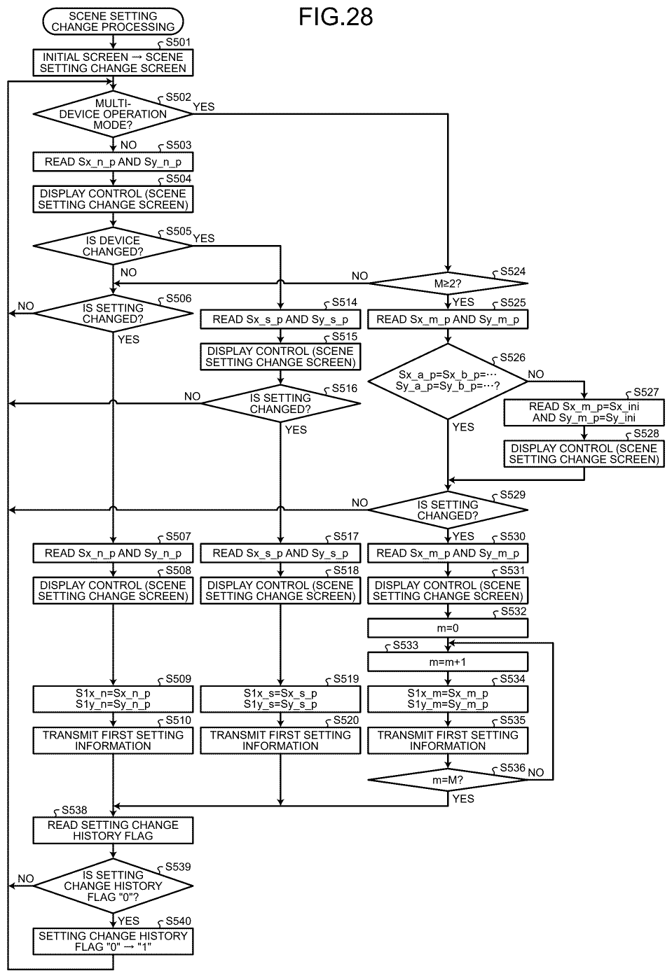

If any of the device selection switches DSEL is touched (Yes at step S106), scene setting change processing of selected scene information (in this example, the scene information SCENE_p) is executed (step S500). FIG. 28 is a flowchart illustrating an example of the scene setting change processing by the control device 200 for the illumination device 1 according to the first embodiment. Specifically, in the present embodiment, the flowchart illustrated in FIG. 25 is a flowchart for changing the light distribution state of each illumination device not through scene selection, whereas the flowchart illustrated in FIG. 28 is a flowchart for further changing, after scene selection, a preset light distribution state of each illumination device depending on the scene selection.

In the scene setting change processing illustrated in FIG. 28 by the control device 200 for the illumination device 1 according to the first embodiment, the control device 200 transitions from the initial screen of the illumination control application illustrated in FIG. 15 to the scene setting change screen 400A illustrated in any of FIGS. 18A, 18B, 18C, 18D, and 18E (step S501) and determines whether the multi-device operation mode is selected (step S502).

If the single-device operation mode is selected and an illumination device 1_n is selected (No at step S502), the display control circuit 231 of the control device 200 reads the horizontal diffusion degree Sx_n_p and the vertical diffusion degree Sy_n_p of the illumination device 1_n of the scene information SCENE_p (step S503), which are stored in the storage region of the storage circuit 223, and executes display control of the display panel 20 (step S504).

Subsequently, the control device 200 determines whether the operation target device of the scene information SCENE_p is changed (step S505).

If the operation target device is not changed (No at step S505), the display control circuit 231 of the control device 200 determines whether a setting change of the setting information (in the present disclosure, light diffusion degree information) of the illumination device 1_n of the scene information SCENE_p is executed (step S506). If a setting change of the setting information of the illumination device 1_n is not executed (No at step S506), the control device 200 returns to the processing at step S502.

If a setting change of the setting information of the illumination device 1_n of the scene information SCENE_p is executed on the scene setting change screen 400A (Yes at step S506), the display control circuit 231 of the control device 200 reads the displayed current values of the horizontal diffusion degree Sx_n_p and the vertical diffusion degree Sy_n_p of the illumination device 1_n of the scene information SCENE_p overwritten by making the setting change on the scene setting change screen 400A (step S507), and executes display control of the display panel 20 (step S508).

The transmission-reception circuit 225 of the control device 200 transmits the first setting information to the illumination device 1_n of the scene information SCENE_p. Specifically, the transmission-reception circuit 225 sets the displayed current values of the horizontal diffusion degree Sx_n_p and the vertical diffusion degree Sy_n_p of the illumination device 1_n of the scene information SCENE_p as the first setting information (S1x_n=Sx_n_p and S1y_n=Sy_n_p; step S509) and transmits the first setting information to the illumination device 1_n (step S510).

Then, the control device 200 reads the setting change history flag stored in the storage circuit 223 (step S538) and determines whether the setting change history flag is “O” (step S539). If the setting change history flag is “0” (Yes at step S539), the control device 200 changes the setting change history flag stored in the storage circuit 223 from “0” to “1” (step S540) and returns to the processing at step S502.

The transmission-reception circuit 111 of the illumination device 1_n stores the received first setting information (S1x_n and S1y_n) as the second setting information (S2x_n and S2y_n) in the storage circuit 113. The electrode drive circuit 112 of the illumination device 1_n supplies drive voltage corresponding to the second setting information stored in the storage circuit 113 to the drive electrodes 10 and 13 of each liquid crystal cell 2 of the optical element 100.

If the operation target device is changed (Yes at step S505), the display control circuit 231 of the control device 200 reads the displayed current values of a horizontal diffusion degree Sx_s_p and a vertical diffusion degree Sy_s_p of the illumination device 1_s selected as the operation target device of the scene information SCENE_p (step S514) and executes display control of the display panel 20 (step S515).

Subsequently, the display control circuit 231 of the control device 200 determines whether a setting change of the setting information (in the present disclosure, light diffusion degree information) of the illumination device 1_s of the scene information SCENE_p is executed (step S516). If a setting change of the setting information is not executed (No at step S516), the control device 200 returns to the processing at step S502.

If a setting change of the setting information of the illumination device 1_s of the scene information SCENE_p is executed on the scene setting change screen 400A (Yes at step S516), the display control circuit 231 of the control device 200 reads the displayed current values of the horizontal diffusion degree Sx_s_p and the vertical diffusion degree Sy_s_p of the illumination device 1_s of the scene information SCENE_p overwritten by making the setting change on the scene setting change screen 400A (step S517), and executes display control of the display panel 20 (step S518).

The transmission-reception circuit 225 of the control device 200 transmits the first setting information to the illumination device 1_s. Specifically, the transmission-reception circuit 225 sets the displayed current values of the horizontal diffusion degree Sx_s_p and the vertical diffusion degree Sy_s_p of the illumination device 1_s of the scene information SCENE_p as the first setting information (S1x_s=Sx_s_p and S1y_s=Sy_s_p; step S519) and transmits the first setting information to the illumination device 1_s (step S520).

Then, the control device 200 reads the setting change history flag stored in the storage circuit 223 (step S538) and determines whether the setting change history flag is “0” (step S539). If the setting change history flag is “0” (Yes at step S539), the control device 200 changes the setting change history flag stored in the storage circuit 223 from “0” to “1” (step S540) and returns to the processing at step S502.

The transmission-reception circuit 111 of the illumination device 1_s stores the received first setting information (S1x_n and S1y_n) as the second setting information (S2x_n and S2y_n) in the storage circuit 113. The electrode drive circuit 112 of the illumination device 1_s supplies drive voltage corresponding to the second setting information stored in the storage circuit 113 to the drive electrodes 10 and 13 of each liquid crystal cell 2 of the optical element 100.

If the multi-device operation mode is selected on the scene setting change screen 400A (Yes at step S502), the control device 200 determines whether the number M of illumination devices 1 of the scene information SCENE_p, which are selected as operation target devices in the multi-device operation mode, is equal to or larger than two (step S524). If only one illumination device 1 of the scene information SCENE_p is selected as an operation target device (M=1; No at step S524), the control device 200 determines whether a setting change of the setting information of the illumination device 1_n of the scene information SCENE_p, which is selected as the operation target device, is executed (step S506). If a setting change of the setting information of the illumination device 1_n is not executed (No at step S506), the control device 200 returns to the processing at step S502.

If a setting change of the setting information of the illumination device 1_n of the scene information SCENE_p is executed on the scene setting change screen 400A (Yes at step S506), the display control circuit 231 of the control device 200 reads the displayed current values of the horizontal diffusion degree Sx_n_p and the vertical diffusion degree Sy_n_p of the illumination device 1_n of the scene information SCENE_p overwritten by making the setting change on the scene setting change screen 400A (step S507), and executes display control of the display panel 20 (step S508).

The transmission-reception circuit 225 of the control device 200 transmits the first setting information to the illumination device 1_n. Specifically, the transmission-reception circuit 225 sets the displayed current values of the horizontal diffusion degree Sx_n_p and the vertical diffusion degree Sy_n_p of the illumination device 1_n of the scene information SCENE_p as the first setting information (S1x_n=Sx_n_p and S1y_n=Sy_n_p; step S509) and transmits the first setting information to the illumination device 1_n (step S510).

Then, the control device 200 determines whether the setting change history flag stored in the storage circuit 223 is “0” (step S539). If the setting change history flag is “0” (Yes at step S539), the control device 200 changes the setting change history flag stored in the storage circuit 223 from “0” to “1” (step S540) and returns to the processing at step S502.

The transmission-reception circuit 111 of the illumination device 1_n stores the received first setting information (S1x_n and S1y_n) as the second setting information (S2x_n and S2y_n) in the storage circuit 113. The electrode drive circuit 112 of the illumination device 1_n supplies drive voltage corresponding to the second setting information stored in the storage circuit 113 to the drive electrodes 10 and 13 of each liquid crystal cell 2 of the optical element 100.

If the number M of illumination devices 1 of the scene information SCENE_p, which are selected as operation target devices in the multi-device operation mode, is equal to or larger than two (M≥2; Yes at step S524), the control device 200 reads the horizontal diffusion degrees Sx_m and the vertical diffusion degrees Sy_m of the M illumination devices 1_m (1_a, 1_b, . . . ) of the scene information SCENE_p, which are selected as the operation target devices in the multi-device operation mode, from the storage region of the storage circuit 223 (step S525) and determines whether the light distribution shapes of the M illumination devices 1_m (1_a, 1_b, . . . ) are identical to one another. Specifically, the control device 200 determines whether the horizontal diffusion degrees Sx_m_p (Sx_a_p, Sx_b_p, . . . ) of the M illumination devices 1_m (1_a, 1_b, . . . ) are identical to one another and the vertical diffusion degrees Sy_m_p (Sy_a_p, Sy_b_p, . . . ) of the M illumination devices 1_m (1_a, 1_b, . . . ) are identical to one another (step S526).

If the light distribution shapes of the M illumination devices 1_m (1_a, 1_b, . . . ) of the scene information SCENE_p, which are selected as the operation target devices in the multi-device operation mode, are identical to one another (Yes at step S526), a transition is made to step S529.

If the light distribution shapes of the M illumination devices 1_m (1_a, 1_b, . . . ) of the scene information SCENE_p, which are selected as the operation target devices in the multi-device operation mode, are different from one another (No at step S526), the display control circuit 231 of the control device 200 reads the horizontal diffusion degree Sx_ini (in FIG. 22, 50%) that is the initial value (default value) of the horizontal diffusion degree Sx_n stored in the storage region of the storage circuit 223, and sets the horizontal diffusion degree Sx_ini as the current values of the horizontal diffusion degrees Sx_m_p of the illumination devices 1_m, and in addition, reads the vertical diffusion degree Sy_ini (in the example illustrated in FIG. 22, 50%) that is the initial value of the vertical diffusion degree Sy_n, and sets the vertical diffusion degree Sy_ini as the current values of the vertical diffusion degrees Sy_m_p of the illumination devices 1_m (Sx_m_p=Sx_ini and Sy_m_p=Sy_ini; step S527), and then executes display control of the display panel 20 (step S528), and a transition is made to step S529.

The display control circuit 231 of the control device 200 determines whether a setting change of each of the illumination devices 1_m of the scene information SCENE_p, which are selected as the operation target devices in the multi-device operation mode, is executed (step S529). If a setting change of the setting information is not executed (No at step S529), the control device 200 returns to the processing at step S502.

If a setting change of the setting information of each of the illumination devices 1_m of the scene information SCENE_p is executed on the scene setting change screen 400A (Yes at step S529), the display control circuit 231 of the control device 200 reads the displayed current values of the horizontal diffusion degrees Sx_m_p and the vertical diffusion degrees Sy_m_p of the illumination devices 1_m of the scene information SCENE_p overwritten by making the setting change on the scene setting change screen 400A (step S530) and executes display control of the display panel 20 (step S531).

The transmission-reception circuit 225 of the control device 200 transmits the horizontal diffusion degrees Sx_m_p and the vertical diffusion degrees Sy_m_p overwritten by making the setting change on the scene setting change screen 400A, as the first setting information to the illumination devices 1_m of the scene information SCENE_p that are selected as the operation target devices in the multi-device operation mode. Specifically, the transmission-reception circuit 225 resets the device counter value m (m=0; step S532), adds one to the device counter value m (m=m+1; step S533), sets the displayed current values of the horizontal diffusion degrees Sx_m_p and the vertical diffusion degrees Sy_m_p of the illumination devices 1_m of the scene information SCENE_p as the first setting information (S1x_m=Sx_m_p and S1y_m=Sy_m_p; step S534), and transmits the first setting information to the illumination device 1_m corresponding to the device counter value m (step S535).

The transmission-reception circuit 225 determines whether the first setting information is transmitted to all operation target devices (illumination devices 1_m). Specifically, the control device 200 determines whether the device counter value m is equal to M (step S536).

In the case of m<M (No at step S536), the processing from step S533 to step S536 is repeatedly executed. Specifically, the transmission-reception circuit 225 adds one to the device counter value m (m=m+1; step S533) and transmits the first setting information to the illumination device 1_m corresponding to the device counter value m (step S535).

The transmission-reception circuits 111 of the M illumination devices 1_m each store the received first setting information (S1x_m and S1y_m) as the second setting information (S2x_m and S2y_m) in the storage circuit 113. The electrode drive circuit 112 of each illumination device 1_m supplies drive voltage corresponding to the second setting information stored in the storage circuit 113 to the drive electrodes 10 and 13 of each liquid crystal cell 2 of the optical element 100.

The above-described processing from step S533 to step S536 is executed until m=M (Yes at step S536). Accordingly, the same setting change is executed for the M illumination devices 1_m of the scene information SCENE_p, which are selected as the operation target devices in the multi-device operation mode.

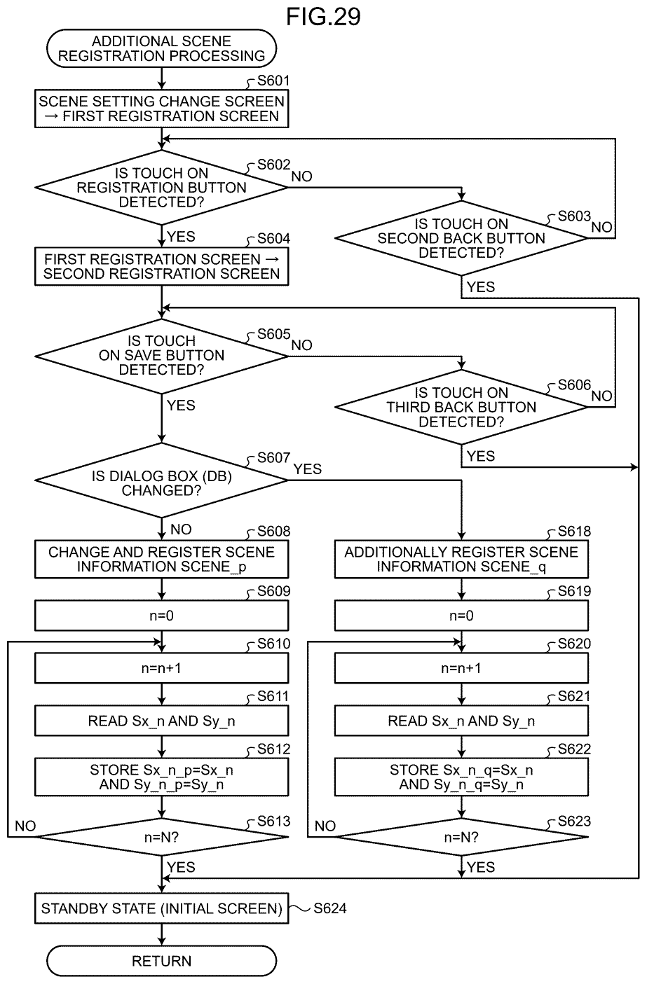

Referring back to FIG. 24, the control device 200 determines whether the setting change history flag is “1” (step S108). If the setting change history flag is “0” (No at step S108), a return is made to the standby state of the initial screen of the illumination control application illustrated in FIG. 15 (step S101). If the setting change history flag is “1” (Yes at step S108), a transition is made to the standby state of the first registration screen illustrated in FIG. 20 to execute additional scene registration processing (step S600). FIG. 29 is a flowchart illustrating an example of the additional scene registration processing by the control device 200 for the illumination device 1 according to the first embodiment. In description of FIG. 29, it is assumed that the scene setting change processing illustrated in FIG. 28 is executed for the scene information SCENE_p.

In the additional scene registration processing illustrated in FIG. 29 by the control device 200 for the illumination device 1 according to the first embodiment, the control device 200 transitions from any of FIGS. 18A, 18B, 18C, 18D, and 18E to the first registration screen 500 illustrated in FIG. 20 (step S601) and executes touch detection processing of the registration button RGSW (step S602), and touch detection processing of the second back button RTSW2 (step S603).

Specifically, if the registration button RGSW is touched (Yes at step S602), the control device 200 transitions from the first registration screen 500 illustrated in FIG. 20 to the second registration screen 600 illustrated in FIG. 21 (step S604).

The control device 200 transitions to step S603 if the registration button RGSW is not touched (No at step S602), and the control device 200 repeatedly executes the processing at steps S602 and S603 if the second back button RTSW2 is not touched (No at step S603). If the second back button RTSW2 is touched (Yes at step S603), the control device 200 transitions to the standby state of the initial screen of the illumination control application illustrated in FIG. 15 (step S624).

In the standby state of the second registration screen 600 (step S604), the conversion processing circuit 212 of the control device 200 executes touch detection processing of the save button SVSW (step S605) and touch detection processing of the third back button RTSW3 (step S606).

Specifically, the control device 200 transitions to step S606 if the save button SVSW is not touched (No at step S605), and the control device 200 repeatedly executes the processing at steps S605 and S606 if the third back button RTSW3 is not touched (No at step S606). If the third back button RTSW3 is touched (Yes at step S606), the control device 200 transitions to the standby state of the initial screen of the illumination control application illustrated in FIG. 15 (step S624).

If the save button SVSW is touched (Yes at step S605), the conversion processing circuit 212 of the control device 200 determines whether the registration name of the scene information in the dialog box DB is changed (step S607). If the registration name of the scene information in the dialog box DB is not changed (No at step S607), a registration change of the scene information SCENE_p is executed with the unchanged registration name of the scene information SCENE_p (step S608). If the registration name of the scene information in the dialog box DB is changed (Yes at step S607), scene information SCENE_q is additionally registered with the changed registration name of the scene information SCENE_q (step S618). In FIG. 29, the scene information SCENE_p is a registration change target, and the scene information SCENE_q is an additional registration target.

If the save button SVSW is touched while the dialog box DB is blank, for example, a caution object indicating that the dialog box DB is blank may be displayed. The operation aspect in a case where the save button SVSW is touched while the dialog box DB is blank is not limited to the above description, and for example, a cursor that prompts inputting of a registration name of the scene information in the dialog box DB may be displayed in a flashing manner.

If the registration name of the scene information in the dialog box DB is not changed (No at step S607), a registration change of the scene information SCENE_p is executed (step S608). The scene setting processing circuit 241 of the control device 200 resets the device counter value n (n=0; step S609), adds one to the device counter value n (n=n+1; step S610), and reads the current values of the horizontal diffusion degree Sx_n and the vertical diffusion degree Sy_n of the illumination device 1_n corresponding to the device counter value n from the storage region of the storage circuit 223 (step S611). Then, the read current values of the horizontal diffusion degree Sx_n and the vertical diffusion degree Sy_n of the illumination device 1_n are stored in the storage region of the storage circuit 223 as the horizontal diffusion degree Sx_1_p and the vertical diffusion degree Sy_1_p of the illumination device 1_n corresponding to the device counter value n in the scene information SCENE_p as a registration change target (Sx_1_p=Sx_1 and Sy_1_p=Sy_1; step S612).

The scene setting processing circuit 241 determines whether the horizontal diffusion degree Sx_n_p and the vertical diffusion degree Sy_n_p of the scene information SCENE_p are stored for all control target devices (illumination devices 1_n). Specifically, the scene setting processing circuit 241 determines whether the device counter value n is equal to N (step S613).

In the case of n<N (No at step S613), the scene setting processing circuit 241 repeatedly executes the processing from step S610 step S613. Accordingly, the horizontal diffusion degrees Sx_n_p and the vertical diffusion degrees Sy_n_p of all control target devices (illumination devices 1_n or illumination devices 1_1, 1_2, 1_3, 1_4, and 1_5 in this example) in the scene information SCENE_p are stored in the storage region of the storage circuit 223 as setting information of the scene information SCENE_p that has been changed and registered. Through this processing, the setting information of the control target devices (illumination devices 1_n) and the scene information SCENE_p are associated with each other.

Then, in the case of n is equal to N (Yes at step S613), the control device 200 transitions to the standby state of the initial screen of the illumination control application illustrated in FIG. 15 (step S624).

After transitioning to the standby state of the initial screen of the illumination control application illustrated in FIG. 15 (step S624), the control device 200 returns to the illumination control processing illustrated in FIG. 24 and resets the setting change history flag (from “1” to “0”; step S109). Then, if the illumination control application is ended in the standby state of the initial screen of the illumination control application illustrated in FIG. 15, control of the illumination devices 1_n by the control device 200 ends.

If the registration name of the scene information in the dialog box DB is changed (Yes at step S607), additional registration of the scene information SCENE_q is executed (step S618). The scene setting processing circuit 241 of the control device 200 resets the device counter value n (n=0; step S619), adds one to the device counter value n (n=n+1; step S620), and reads the current values of the horizontal diffusion degree Sx_n and the vertical diffusion degree Sy_n of the illumination device 1_n corresponding to the device counter value n from the storage region of the storage circuit 223 (step S621). Then, the read current values of the horizontal diffusion degree Sx_n and the vertical diffusion degree Sy_n of the illumination device 1_n are stored in the storage region of the storage circuit 223 as a horizontal diffusion degree Sx_1_q and a vertical diffusion degree Sy_1_q of the illumination device 1_n corresponding to the device counter value n in the scene information SCENE_q as an additional registration target (Sx_1_q=Sx_1 and Sy_1_q=Sy_1; step S622).

The scene setting processing circuit 241 determines whether the horizontal diffusion degree Sx_n_q and the vertical diffusion degree Sy_n_q of the scene information SCENE_q are stored for all control target devices (illumination devices 1_n). Specifically, the scene setting processing circuit 241 determines whether the device counter value n is equal to N (step S623).

In the case of n<N (No at step S623), the scene setting processing circuit 241 repeatedly executes the processing from step S620 to step S623. Accordingly, the horizontal diffusion degrees Sx_n_q and the vertical diffusion degrees Sy_n_q of all control target devices (illumination devices 1_n or illumination devices 1_1, 1_2, 1_3, 1_4, and 1_5 in this example) in the scene information SCENE_q are stored in the storage region of the storage circuit 223 as setting information of the scene information SCENE_q additionally registered. Through this processing, the setting information of the control target devices (illumination devices 1_n) and the scene information SCENE_q are associated with each other.

Then, in the case of n=N (Yes at step S623), the control device 200 transitions to the standby state of the initial screen of the illumination control application illustrated in FIG. 15 (step S624).

After transitioning to the standby state of the initial screen of the illumination control application illustrated in FIG. 15 (step S624), the control device 200 returns to the illumination control processing illustrated in FIG. 24 and resets the setting change history flag (from “1” to “0”; step S109). Then, if the illumination control application is ended in the standby state of the initial screen of the illumination control application illustrated in FIG. 15, control of the illumination devices 1_n by the control device 200 ends.

With the control device 200 for the illumination device 1 and the illumination system according to the first embodiment described above, the same setting information (in the present disclosure, light diffusion degree information) can be set at once to the illumination devices 1_m selected upon selection of the multi-device operation mode from among the illumination devices 1_n registered as control target devices in advance.

With the control device 200 for the illumination device 1 and the illumination system according to the first embodiment described above, setting information (in the present disclosure, light diffusion degree information) that is registered in the new scene registration processing illustrated in FIG. 26 or the additional scene registration processing illustrated in FIG. 29 and is associated with each illumination device 1_n can be set at once to the illumination devices 1_n as control targets. It is possible to call a scene registered in advance and further change the light distribution states of one or a plurality of illumination devices defined for the scene, it is easy to change the light distribution states of the scene-registered illumination devices, and in addition, it is easy to perform new scene registration.

In the aspect described above in the first embodiment, the setting change screen 400 is displayed for each illumination device 1_n (refer to FIGS. 16A, 16B, 16C, 16D, 16E, 18A, 18B, 18C, 18D, and 18E), but the present disclosure is not limited to the aspect in which the setting change screen 400 or the scene setting change screen is displayed for each illumination device 1_n. For example, in a case of a tablet or the like having the sufficiently large display region DA of the control device 200, the setting change of each of a plurality of illumination devices 1_n registered as control target devices may be performed on one screen.

### Second Embodiment

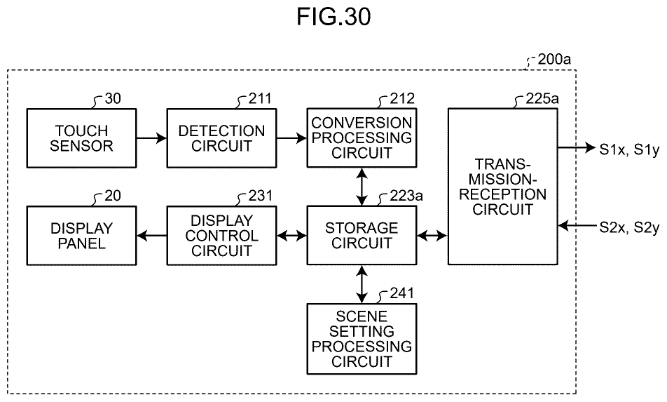

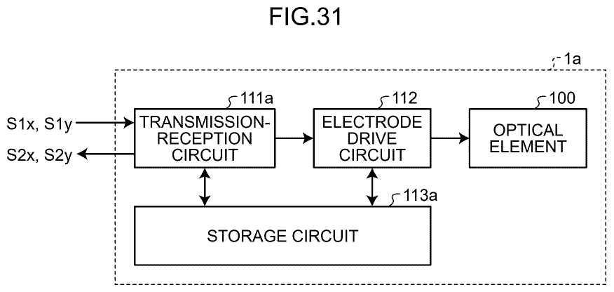

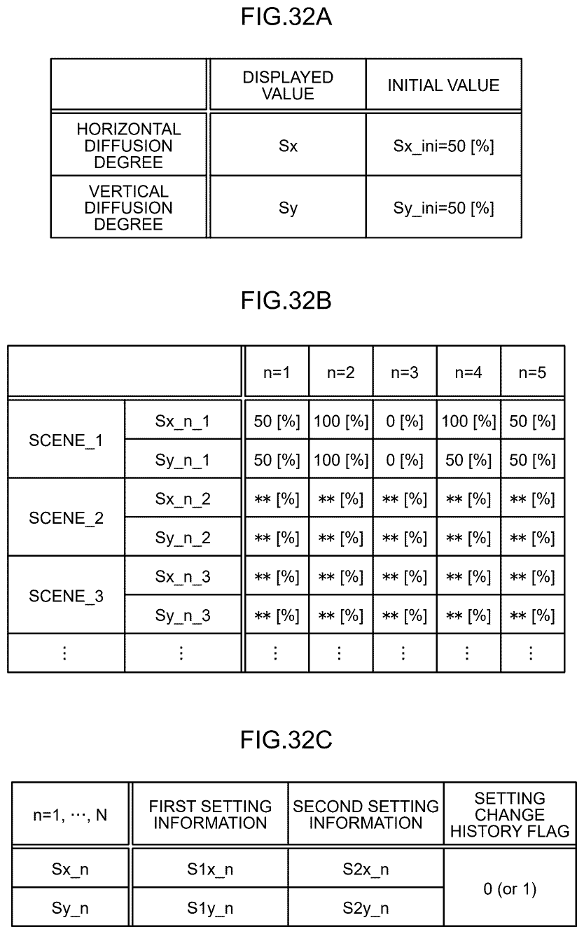

FIG. 30 is a diagram illustrating an example of the control block configuration of a control device 200a for an illumination device 1a according to a second embodiment. FIG. 31 is a diagram illustrating an example of the control block configuration of the illumination device 1a according to the second embodiment. FIG. 32A is a conceptual diagram illustrating an example of a storage region in the control device for an illumination device according to the second embodiment. FIG. 32B is a conceptual diagram illustrating an example of the storage region in the control device for an illumination device according to the second embodiment. FIG. 32C is a conceptual diagram illustrating an example of a storage region in the illumination device according to the second embodiment.

A transmission-reception circuit 225a of the control device 200a according to the second embodiment transmits the first setting information (Dx-directional light diffusion degree S1x and Dy-directional light diffusion degree S1y) to the illumination device 1a. In addition, the transmission-reception circuit 225a receives the second setting information (Dx-directional light diffusion degree S2x and Dy-directional light diffusion degree S2y) transmitted from the illumination device 1a.

A transmission-reception circuit 111a of the illumination device 1a according to the second embodiment receives the first setting information (Dx-directional light diffusion degree S1x and Dy-directional light diffusion degree Sy) transmitted from the control device 200a and stores the first setting information in a storage circuit 113a. In addition, the transmission-reception circuit 111a transmits, to the control device 200, the second setting information (Dx-directional light diffusion degree S2x and Dy-directional light diffusion degree S2y) stored in the storage circuit 113a.

The second embodiment is different from the first embodiment in that, as illustrated in FIG. 32C, a storage region of the storage circuit 113a of the illumination device 1a holds the first setting information transmitted from the control device 200a and further has a setting change history flag indicating a change of the first setting information for the second setting information, wherein the first setting information is the Dx-directional light diffusion degree S1x and the Dy-directional light diffusion degree S1y of the illumination device 1a, in other words, the horizontal diffusion degree S1x_n and the vertical diffusion degree S1y_n; and the second setting information is the Dx-directional light diffusion degree S2x and the Dy-directional light diffusion degree S2y of the illumination device 1a, in other words, the horizontal diffusion degree S2x_n and the vertical diffusion degree S2y_n. As illustrated in FIG. 32A, a storage circuit 223a of the control device 200a stores the displayed values of the horizontal diffusion degree Sx and the vertical diffusion degree Sy, and the horizontal diffusion degree Sx_ini (in FIG. 32A, 50%) and the vertical diffusion degree Sy_ini (in FIG. 32A, 50%) that are the initial values (default values) of the horizontal diffusion degree Sx and the vertical diffusion degree Sy.

In the second embodiment, the setting change history flag stored in the storage region of the storage circuit 113a of the illumination device 1a is reset (“0”) upon activation of the illumination device 1. The setting change history flag is set to “1” if the first setting information (S1x_n and S1y_n) transmitted from the control device 200a for the current second setting information (S2x_n and S2y_n) is changed in processes of illumination control processing by the control device 200a for the illumination device 1a and the illumination system according to the second embodiment.

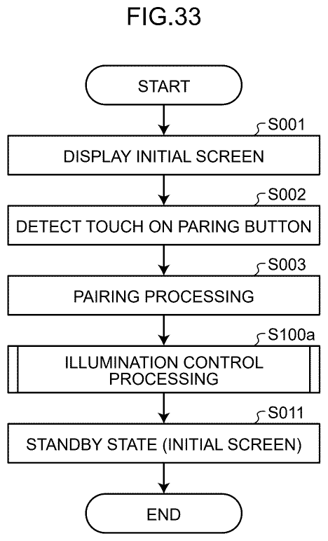

In the second embodiment, similarly to the first embodiment, as illustrated in FIG. 32B, each scene information SCENE_p (p=1, 2, 3, . . . ) in which the setting values of various setting parameters (in the present disclosure, light diffusion degrees) are set for each control target device (illumination device 1a_n, or illumination device 1a_1, 1a_2, 1a_3, 1a_4, or 1a_5 in this example) is stored in the storage circuit 223a of the control device 200a. Each scene information SCENE_p (p=1, 2, 3, . . . ) is set as appropriate in processing (refer to FIGS. 33 to 39) to be described later.

The following describes specific examples of processing by the control device 200a for the illumination device 1a and the illumination system according to the second embodiment described above.

FIG. 33 is a flowchart illustrating an example of initial setting processing by the control device 200a for the illumination device 1a according to the second embodiment. After the illumination control application is activated on the control device 200a, the initial screen of the illumination control application illustrated in FIG. 15 is displayed on the display region DA (step S001).

Before activation of the illumination control application, the illumination devices 1a_n registered in advance in a space where pairing with the control device 200a is possible are activated. In the second embodiment, each illumination device 1a_n reads the second setting information (S2x_n and S2y_n) at the previous turn-off from the storage circuit 113a and supplies drive voltage corresponding to the second setting information to the drive electrodes 10 and 13 of each liquid crystal cell 2 of the optical element 100.

If the pairing button PEXE is touched on the initial screen of the illumination control application illustrated in FIG. 15 (step S002), the transmission-reception circuit 225a of the control device 200a executes pairing processing with any illumination device 1a_n activated in a space where pairing with the control device 200a is possible (step S003), and executes the illumination control processing (step S100a). The illumination device 1a_n may be registered as a control target device to the control device 200a in advance, or the illumination device 1a_n paired in a space where pairing with the control device 200a is possible may be registered as a control target device.

After the execution of the illumination control processing at step S100a, a transition is made to the standby state of the initial screen of the illumination control application illustrated in FIG. 15 (step S011). If the illumination control application is ended in the standby state of the initial screen of the illumination control application, control of the illumination devices 1a_n by the control device 200a ends. The overall flow of the illumination control processing by the control device 200a for the illumination device 1a according to the second embodiment is the same as that of the illumination control processing illustrated in FIG. 24 by the control device 200 for the illumination device 1 according to the first embodiment, and thus detailed description thereof is omitted.

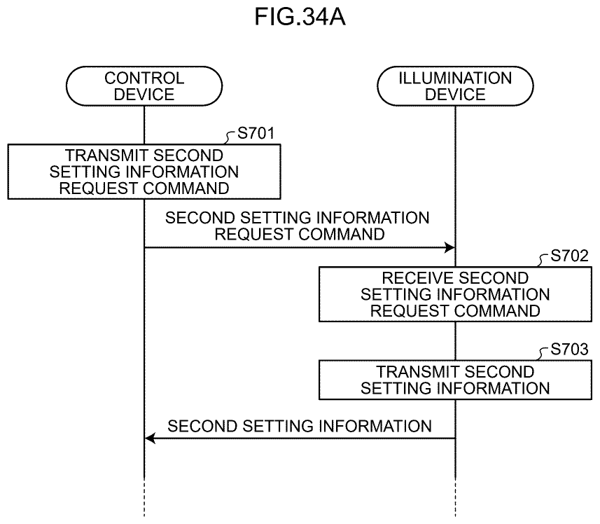

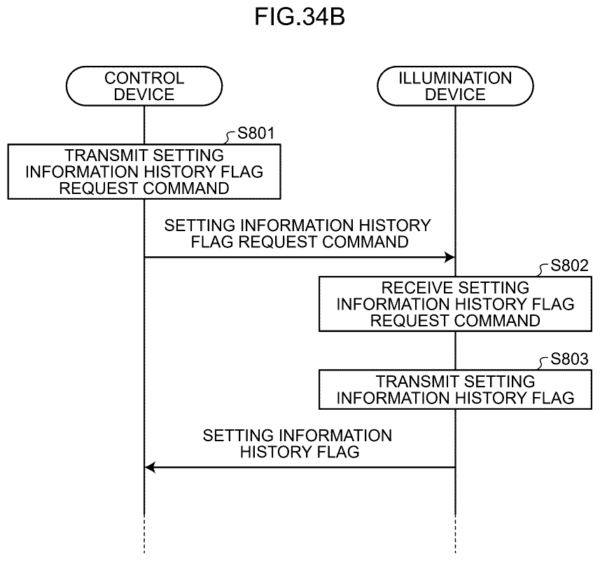

As described above, in the second embodiment, the storage circuit 223a of the control device 200a does not store the current values of the horizontal and vertical diffusion degrees of each illumination device 1a_n nor the setting change history flag. Thus, the second setting information (S2x_n and S2y_n) and the setting change history flag need to be read as appropriate from each illumination device 1a_n in processes of the illumination control processing. Hereinafter, processing of reading the second setting information (S2x_n and S2y_n) from each illumination device 1a_n is also referred to as “first synchronization processing”, and processing of reading the setting change history flag is also referred to as “second synchronization processing”. FIG. 34A is a sequence diagram illustrating an example of the first synchronization processing by the illumination system according to the second embodiment. FIG. 34B is a sequence diagram illustrating an example of the second synchronization processing by the illumination system according to the second embodiment.

In the first synchronization processing illustrated in FIG. 34A, the transmission-reception circuit 225a of the control device 200a transmits second setting information request command to an illumination device 1a_n from which the second setting information (step S701) is to be read.

The transmission-reception circuit 111a of the illumination device 1a_n reads the second setting information (S2x_n and S2y_n) stored in the storage circuit 113a (step S702) and transmits the second setting information to the control device 200a (step S703).

Then, the transmission-reception circuit 225a of the control device 200a receives the second setting information (S2x_n and S2y_n) transmitted from the illumination device 1a_n and executes processes of the illumination control processing by the control device 200a for the illumination device 1a according to the second embodiment by using the second setting information.

In the second synchronization processing illustrated in FIG. 34B, the transmission-reception circuit 225a of the control device 200a transmits setting change history flag request command to an illumination device 1a_n from which the setting change history flag (step S801) is to be read.

The transmission-reception circuit 111a of the illumination device 1a_n reads the setting change history flag stored in the storage circuit 113a (step S802) and transmits the setting change history flag to the control device 200a (step S803).

Then, the transmission-reception circuit 225a of the control device 200a receives the setting change history flag transmitted from the illumination device 1a_1 and executes processes of the illumination control processing by the control device 200a for the illumination device 1a according to the second embodiment by using the setting change history flag.

In the standby state of the initial screen of the illumination control application illustrated in FIG. 15 (step S101 in FIG. 24), the control device 200a determines whether any of the scene selection switches SCSEL is touched (step S102 in FIG. 24). If none of the scene selection switches SCSEL is touched (No at step S102), the control device 200a subsequently determines whether any of the device selection switches DSEL is touched (step S103 in FIG. 24). If none of the device selection switches DSEL is touched (No at step S103), a return is made to the standby state of the initial screen of the illumination control application illustrated in FIG. 15 (step S101 in FIG. 24).

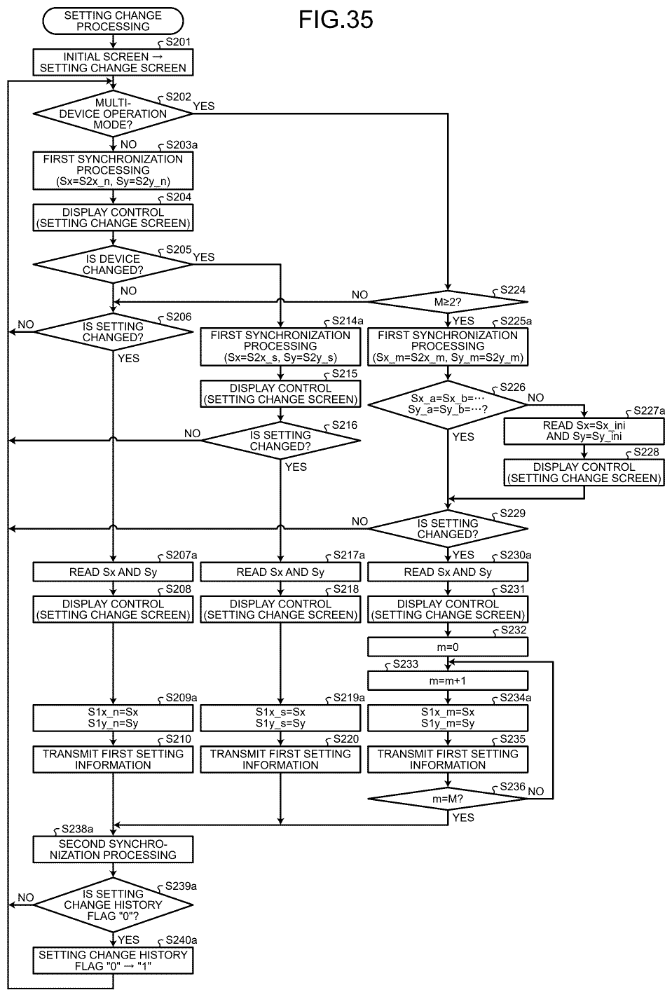

If any of the device selection switches DSEL is touched (Yes at step S103), setting change processing is executed (step S200 in FIG. 24). FIG. 35 is a flowchart illustrating an example of the setting change processing by the control device 200a for the illumination device 1a according to the second embodiment.

In the setting change processing illustrated in FIG. 35 by the control device 200a for the illumination device 1a according to the second embodiment, the control device 200a transitions from the initial screen of the illumination control application illustrated in FIG. 15 to the setting change screen 400 illustrated in any of FIGS. 16A, 16B, 16C, 16D, and 16E (step S201) and determines whether the multi-device operation mode is selected (step S202).

If the single-device operation mode is selected and an illumination device 1a_n is selected (No at step S202), the control device 200a and the illumination device 1a_n execute first synchronization processing illustrated in FIG. 34A (step S203a). The control device 200a sets second setting information (S2x_n and S2y_n) transmitted from the illumination device 1a_n (Sx=S2x_n and Sy=S2y_n) as displayed values (Sx and Sy), and the display control circuit 231 of the control device 200a executes display control of the display panel 20 to reflect the displayed values on the setting change screen 400 (step S204).

Subsequently, the control device 200a determines whether the operation target device is changed (step S205).

If the operation target device is not changed (No at step S205), the display control circuit 231 of the control device 200a determines whether a setting change of the setting information (in the present disclosure, light diffusion degree information) of the illumination device 1a_n is executed (step S206). If a setting change of the setting information of the illumination device 1a_n is not executed (No at step S206), the control device 200a returns to the processing at step S202.

The following describes a specific operation example of the setting change of the setting information (in the present disclosure, light diffusion degree information) according to the second embodiment. Specifically, the conversion processing circuit 212 executes, for example, touch detection processing for the first slider S1 and touch detection processing for the second slider S2 on the setting change screen 400. If the first slider S1 is touched, the conversion processing circuit 212 calculates the current horizontal diffusion degree Sx of the illumination device 1a_n based on the X-directional position of the first slider S1 on the detection region FA and stores the current horizontal diffusion degree Sx in a storage region of the storage circuit 223a. More specifically, upon such an operation on the first slider S1, the displayed value of the horizontal diffusion degree Sx of the illumination device 1a_n illustrated in FIG. 19 is updated and overwritten. If the second slider S2 is touched, the conversion processing circuit 212 calculates the current vertical diffusion degree Sy of the illumination device 1a_n based on the Y-directional position of the second slider S2 on the detection region FA and stores the current vertical diffusion degree Sy in the storage region of the storage circuit 223a. More specifically, upon such an operation on the second slider S2, the displayed value of the vertical diffusion degree Sy of the illumination device 1a_n illustrated in FIG. 19 is updated and overwritten.

If a setting change of the setting information of the illumination device 1a_n is executed on the setting change screen 400 (Yes at step S206), the display control circuit 231 of the control device 200a reads the displayed values of the horizontal diffusion degree Sx and the vertical diffusion degree Sy of the illumination device 1a_n overwritten by making the setting change on the setting change screen 400 (step S207a), and executes display control of the display panel 20 (step S208).

The transmission-reception circuit 225a of the control device 200a transmits the first setting information to the illumination device 1a_n. Specifically, the transmission-reception circuit 225 sets the displayed values of the horizontal diffusion degree Sx and the vertical diffusion degree Sy of the illumination device 1a_n as the first setting information (S1x_n=Sx and S1y_n=Sy; step S209a), and transmits the first setting information to the illumination device 1a_n (step S210).

The transmission-reception circuit 111a of the illumination device 1a_n stores the received first setting information (S1x_n and S1y_n) in the storage region of the storage circuit 113a.

Then, the control device 200a executes the second synchronization processing illustrated in FIG. 34B with the illumination device 1a_n (step S238a). The control device 200a determines whether the setting change history flag transmitted from the illumination device 1a_n is “0” (step S239a). If the setting change history flag is “0” (Yes at step S239a), the control device 200a changes the setting change history flag from “0” to “1” and transmits the setting change history flag to the illumination device 1a n (step S240a), and returns to the processing at step S202.

In the second embodiment, the setting change history flag of “0” (Yes at step S239a) indicates a state in which a setting change of the setting information of the illumination device 1a is not made in the setting change processing illustrated in FIG. 35 by the control device 200a for the illumination device 1a according to the second embodiment and the horizontal diffusion degree S1x_n and the vertical diffusion degree S1y_n of the first setting information transmitted from the control device 200a are both the same as the horizontal diffusion degree S2x_n and the vertical diffusion degree S2y_n of the second setting information, which are the current control values. The setting change history flag of “1” indicates a state in which, as a result of the setting change of the setting information of the illumination device 1a in the setting change processing illustrated in FIG. 35 by the control device 200a for the illumination device 1a according to the second embodiment, at least one of the horizontal diffusion degree S1x_n and the vertical diffusion degree S1y_n in the first setting information transmitted from the control device 200a is different from the horizontal diffusion degree S2x_n or the vertical diffusion degree S2y_n of the second setting information as a current control value. In other words, the setting change history flag of “0” indicates that a setting change of the setting information of the illumination device 1a_n selected as an operation target device is not made, and the setting change history flag of “1” indicates that a setting change of the setting information of the illumination device 1a_n selected as an operation target device is made.

The transmission-reception circuit 111a of the illumination device 1a_n stores the received first setting information (S1x_n and S1y_n) as the second setting information (S2x_n and S2y_n) in the storage circuit 113a. The electrode drive circuit 112 of the illumination device 1a_n supplies drive voltage corresponding to the second setting information stored in the storage circuit 113 to the drive electrodes 10 and 13 of each liquid crystal cell 2 of the optical element 100.

If the operation target device is changed (Yes at step S205), the control device 200a executes the first synchronization processing illustrated in FIG. 34A with the illumination device 1a_n (step S214a). The control device 200a sets the second setting information (S2x_s and S2y_s) transmitted from the illumination device 1a_s selected as an operation target device (Sx=S2x_s and Sy=S2y_s) as displayed values (Sx and Sy), and the display control circuit 231 of the control device 200a executes display control of the display panel 20 to reflect the displayed values on the setting change screen 400 (step S215).

Subsequently, the display control circuit 231 of the control device 200a determines whether a setting change of the setting information (in the present disclosure, light diffusion degree information) of the illumination device 1_s is executed (step S216). If a setting change of the setting information is not executed (No at step S216), the control device 200a returns to the processing at step S202.

If a setting change of the setting information of the illumination device 1a_s is executed on the setting change screen 400 (Yes at step S216), the display control circuit 231 of the control device 200a reads the displayed values of the horizontal diffusion degree Sx and the vertical diffusion degree Sy of the illumination device 1a_s overwritten by making the setting change on the setting change screen 400 (step S217a), and executes display control of the display panel 20 (step S218).

The transmission-reception circuit 225a of the control device 200a transmits the first setting information to the illumination device 1a_s. Specifically, the transmission-reception circuit 225a sets the displayed values of the horizontal diffusion degree Sx and the vertical diffusion degree Sy as the first setting information (S1x_s=Sx and S1y_s=Sy; step S219a) and transmits the first setting information to the illumination device 1a_s (step S220).

The transmission-reception circuit 111a of the illumination device 1a_s stores the received first setting information (S1x_s and S1y_s) in the storage region of the storage circuit 113a.

Then, the control device 200a executes the second synchronization processing illustrated in FIG. 34B with the illumination device 1a_n (step S238a). The control device 200a determines whether the setting change history flag transmitted from the illumination device 1a_n is “0” (step S239a). If the setting change history flag is “0” (Yes at step S239a), the control device 200a changes the setting change history flag from “0” to “1” and transmits the setting change history flag to the illumination device 1a_s (step S240a), and returns to the processing at step S202.

The transmission-reception circuit 111a of the illumination device 1a_s stores the received first setting information (S1x_s and S1y_s) as the second setting information (S2x_s and S2y_s) in the storage circuit 113a. The electrode drive circuit 112 of the illumination device 1a_s supplies drive voltage corresponding to the second setting information stored in the storage circuit 113a to the drive electrodes 10 and 13 of each liquid crystal cell 2 of the optical element 100.

If the multi-device operation mode is selected on the setting change screen 400 (Yes at step S202), the control device 200a determines whether the number M of illumination devices 1a selected as operation target devices in the multi-device operation mode is equal to or larger than two (step S224). If only one illumination device 1a is selected as an operation target device (M=1; No at step S224), the control device 200a determines whether a setting change of the setting information of the illumination device 1a_n selected as the operation target device is executed (step S206). If a setting change of the setting information of the illumination device 1a_n is not executed (No at step S206), the control device 200a returns to the processing at step S202.

If a setting change of the setting information of the illumination device 1a_n is executed on the setting change screen 400 (Yes at step S206), the display control circuit 231 of the control device 200a reads the displayed values of the horizontal diffusion degree Sx and the vertical diffusion degree Sy of the illumination device 1a_n overwritten by making the setting change on the setting change screen 400 (step S207a), and executes display control of the display panel 20 (step S208).

The transmission-reception circuit 225a of the control device 200a transmits the first setting information to the illumination device 1a_n. Specifically, the transmission-reception circuit 225a sets the displayed values of the horizontal diffusion degree Sx and the vertical diffusion degree Sy of the illumination device 1a_n as the first setting information (S1x_n=Sx and S1y_n=Sy; step S209a) and transmits the first setting information to the illumination device 1a_n (step S210).

Then, the control device 200a reads the setting change history flag stored in the storage region of the storage circuit 223 (step S238a) and determines whether the setting change history flag is “0” (step S239a). If the setting change history flag is “0” (Yes at step S239a), the control device 200a changes the setting change history flag stored in the storage circuit 223a from “0” to “1” (step S240a) and returns to the processing at step S202.

The transmission-reception circuit 111a of the illumination device 1a_n stores the received first setting information (S1x_n and S1y_n) as the second setting information (S2x_n and S2y_n) in the storage circuit 113a. The electrode drive circuit 112 of the illumination device 1a_n supplies drive voltage corresponding to the second setting information stored in the storage circuit 113a to the drive electrodes 10 and 13 of each liquid crystal cell 2 of the optical element 100.

If the number M of illumination devices 1a selected as operation target devices in the multi-device operation mode is equal to or larger than two (M≥2; Yes at step S224), the control device 200a executes the first synchronization processing illustrated in FIG. 34A with each of the M illumination devices 1a_m (step S225a). The control device 200a sets the second setting information (S2x_m and S2y_m) transmitted from the M illumination devices 1a_m as (Sx_m and Sy_m), (that is, Sx_m=S2x_m and Sy_m=S2y_m) and determines whether the light distribution shapes of the M illumination devices 1a_m (1a_a, 1a_b, . . . ) are identical to one another. Specifically, the control device 200a determines whether the horizontal diffusion degrees Sx_m (Sx_a, Sx_b, . . . ) of the M illumination devices 1a_m (1a_a, 1a_b, . . . ) are identical to one another and the vertical diffusion degrees Sy_m (Sy_a, Sy_b, . . . ) of the M illumination devices 1a_m (1a_a, 1a_b, . . . ) are identical to one another (step S226).

If the light distribution shapes of the M illumination devices 1a_m (1a_a, 1a_b, . . . ) selected as the operation target devices in the multi-device operation mode are identical to one another (Yes at step S226), a transition is made to step S229.

If the light distribution shapes of the M illumination devices 1a_m (1a_a, 1a_b, . . . ) selected as the operation target devices in the multi-device operation mode are different from one another (No at step S226), the display control circuit 231 of the control device 200a reads the horizontal diffusion degree Sx_ini (in FIG. 32A, 50%) that is the initial value (default value) of the horizontal diffusion degree Sx stored in the storage region of the storage circuit 223a, and sets the horizontal diffusion degree Sx_ini as the displayed values of the horizontal diffusion degrees Sx of the illumination devices 1a_m, and in addition, reads the vertical diffusion degree Sy_ini (in the example illustrated in FIG. 32A, 50%) that is the initial value of the vertical diffusion degree Sy, and sets the vertical diffusion degree Sy_ini as the displayed values of the vertical diffusion degrees Sy of the illumination devices 1a_m (Sx=Sx_ini and Sy=Sy_ini; step S227a), and then executes display control of the display panel 20 (step S228), and a transition is made to step S229.

The display control circuit 231 of the control device 200a determines whether a setting change of each of the illumination devices 1a_m selected as the operation target devices in the multi-device operation mode is executed (step S229). If a setting change of the setting information is not executed (No at step S229), the control device 200a returns to the processing at step S202.

If a setting change of the setting information of each of the illumination devices 1a_m is executed on the setting change screen 400 (Yes at step S229), the display control circuit 231 of the control device 200a reads the displayed values of the horizontal diffusion degrees Sx and the vertical diffusion degrees Sy of the illumination devices 1a_m overwritten by making the setting change on the setting change screen 400 (step S230a), and executes display control of the display panel 20 (step S231).

The transmission-reception circuit 225a of the control device 200a transmits the horizontal diffusion degree Sx_m and the vertical diffusion degree Sy_m overwritten by making the setting change on the setting change screen 400, as the first setting information to the illumination devices 1a_m selected as the operation target devices in the multi-device operation mode. Specifically, the transmission-reception circuit 225a resets the device counter value m (m=0; step S232), adds one to the device counter value m (m=m+1; step S233), sets the displayed values of the horizontal diffusion degrees Sx and the vertical diffusion degrees Sy of the illumination devices 1a_m as the first setting information (S1x_m=Sx and S1y_m=Sy, step S234a), and transmits the first setting information to the illumination device 1a_m corresponding to the device counter value m (step S235).

The transmission-reception circuit 225a determines whether the first setting information is transmitted to all operation target devices (illumination devices 1a_m). Specifically, the control device 200a determines whether the device counter value m is equal to M (step S236).

In the case of m<M (No at step S236), the processing from step S233 to step S236 is repeatedly executed. Specifically, the transmission-reception circuit 225a adds one to the device counter value m (m=m+1; step S233) and transmits the first setting information to the illumination device 1a_m corresponding to the device counter value m (step S235).

The transmission-reception circuits 111a of the M illumination devices 1a_m each store the received first setting information (S1x_m and S1y_m) in the storage region of the storage circuit 113a.

Then, the control device 200a executes the second synchronization processing illustrated in FIG. 34B with each of the M illumination devices 1a_m (step S238a). The control device 200a determines whether the setting change history flag transmitted from any illumination device 1a_m is “0” (step S239a). If the setting change history flag transmitted from any illumination device 1a_m is “0” (Yes at step S239a), the control device 200a changes the setting change history flag of each illumination device 1a m subjected to setting change from “0” to “1” and transmits the setting change history flag to the illumination device 1a_m (step S240a), and returns to the processing at step S202.

The transmission-reception circuits 111a of the M illumination devices 1a_m each store the received first setting information (S1x_m and S1y_m) as the second setting information (S2x_m and S2y_m) in the storage circuit 113a. The electrode drive circuit 112 of each illumination device 1a_m supplies drive voltage corresponding to the second setting information stored in the storage circuit 113a to the drive electrodes 10 and 13 of each liquid crystal cell 2 of the optical element 100.

The above-described processing from step S233 to step S236 is executed until m=M (Yes at step S236). Accordingly, the same setting change is executed for the M illumination devices 1_m selected as the operation target devices in the multi-device operation mode.

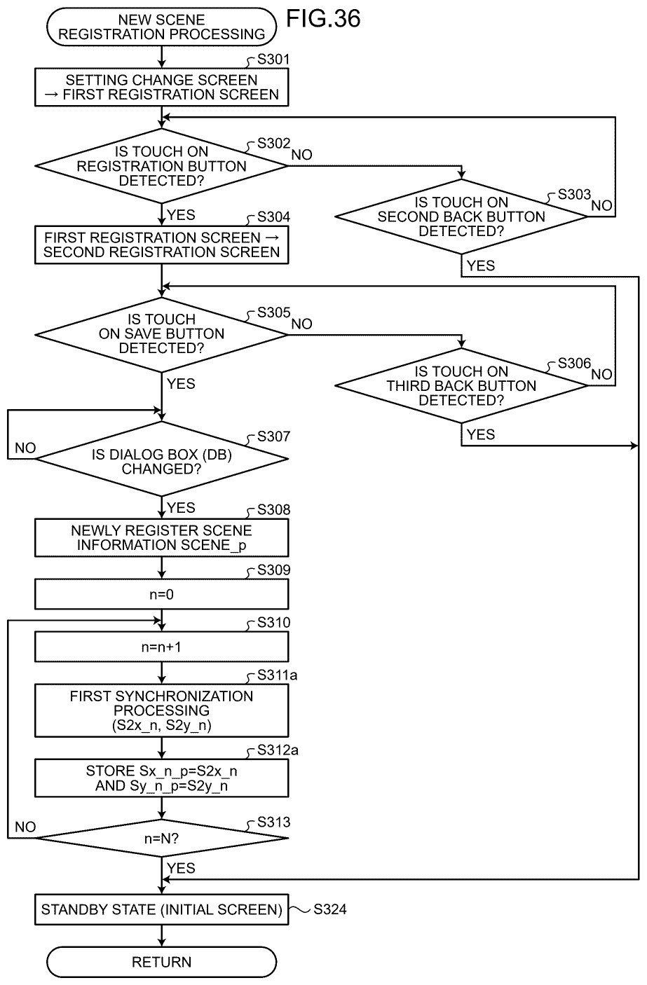

Referring back to FIG. 24, the control device 200a executes the second synchronization processing illustrated in FIG. 34B with each illumination device 1a_n as a control target device (step S105) and determines whether the setting change history flag of at least one of all illumination devices 1a_n is “1” (step S105). If the setting change history flags of all illumination devices 1a_n are “0” (No at step S105), a return is made to the standby state of the initial screen of the illumination control application illustrated in FIG. 15 (step S101). If the setting change history flag of at least one of all illumination devices 1a_n is “1” (Yes at step S105), a transition is made to the standby state of the first registration screen illustrated in FIG. 20 to execute new scene registration processing (step S300). FIG. 36 is a flowchart illustrating an example of the new scene registration processing by the control device 200a for the illumination device 1a according to the second embodiment.

Processing from step S301 to step S307 in the new scene registration processing illustrated in FIG. 36 by the control device 200a for the illumination device 1a according to the second embodiment is the same as that in the new scene registration processing illustrated in FIG. 26 by the control device 200 for the illumination device 1 according to the first embodiment, and thus detailed description thereof is omitted.

In new registration processing of the scene information for the illumination device 1a according to the second embodiment (step S308), the control device 200a resets the device counter value n (n=0; step S309), adds one to the device counter value n (n=n+1; step S310), and executes the first synchronization processing illustrated in FIG. 34A with each illumination device 1a n (step S311a). The control device 200a stores the second setting information (S2x_n and S2y_n) transmitted from the illumination device 1a_n in the storage region of the storage circuit 223a as the horizontal diffusion degree Sx_1_p and the vertical diffusion degree Sy_1_p of the illumination device 1a_n corresponding to the device counter value n in the scene information SCENE_p as a registration target (Sx_1_p=Sx_1 and Sy_1_p=Sy_1; step S312a).

The scene setting processing circuit 241 determines whether the horizontal diffusion degree Sx_n_p and the vertical diffusion degree Sy_n_p of the scene information SCENE_p are stored for all control target devices (illumination devices 1a_n). Specifically, the scene setting processing circuit 241 determines whether the device counter value n is equal to N (step S313).

In the case of n<N (No at step S313), the scene setting processing circuit 241 repeatedly executes the processing from step S310 to step S313. Accordingly, the horizontal diffusion degrees Sx_n_p and the vertical diffusion degrees Sy_n_p of all control target devices (illumination devices 1a_n or illumination devices 1a_1, 1a_2, 1a_3, 1a_4, and 1a_5 in this example) in the scene information SCENE_p are stored in the storage region of the storage circuit 223a as setting information of the scene information SCENE_p newly registered. Through this processing, the setting information of the control target devices (illumination devices 1_n) and the scene information SCENE_p are associated with each other.

Then, in the case of n=N (Yes at step S313), the control device 200a transitions to the standby state of the initial screen of the illumination control application illustrated in FIG. 15 (step S324).

After transitioning to the standby state of the initial screen of the illumination control application illustrated in FIG. 15 (step S324), the control device 200a returns to the illumination control processing illustrated in FIG. 24 and resets the setting change history flag of each illumination device 1a_n as a control target device (from “1” to “0”; step S109). Specifically, a command to reset the setting change history flag is transmitted to each illumination device 1a_n. Then, if the illumination control application is ended in the standby state of the initial screen of the illumination control application illustrated in FIG. 15, control of the illumination devices 1a_n by the control device 200a ends.

In FIG. 24, if any of the scene selection switches SCSEL is touched (Yes at step S102), the control device 200a executes scene change processing (step S400). The scene change processing by the control device 200a for the illumination device 1a according to the second embodiment is the same as the scene change processing illustrated in FIG. 27 by the control device 200 for the illumination device 1 according to the first embodiment, and thus detailed description thereof is omitted.

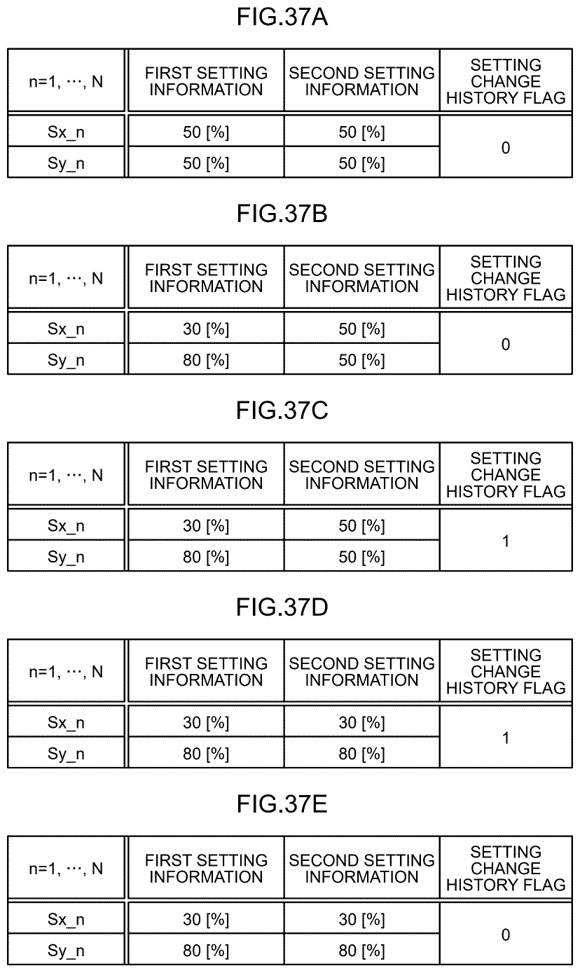

The following describes state transition in the storage region of the storage circuit 113a of the illumination device 1a according to the second embodiment. FIGS. 37A, 37B, 37C, 37D, and 37E are diagrams illustrating an example of state transition in the storage region of the storage circuit 113a of the illumination device 1a according to the second embodiment.

FIG. 37A illustrates a state in which, at activation of the illumination device 1a_n, for example, the horizontal diffusion degree S2x_n=50% and the vertical diffusion degree S2y_n=50% of the second setting information as the current control values are stored in the storage circuit 113a of the illumination device 1a_n and the setting change history flag is “0”.

As illustrated in FIG. 37B, for example, when transmitted from the control device 200a in the setting change processing according to the second embodiment illustrated in FIG. 35, the horizontal diffusion degree S1x_n=30% and the vertical diffusion degree S1y_n=80% of the first setting information as changed control values are stored in the storage region of the storage circuit 113a. At this point in time, the setting change history flag is maintained in the “0” state.

Subsequently, if the second synchronization processing illustrated in FIG. 34B is executed in the setting change processing according to the second embodiment illustrated in FIG. 35, the setting change history flag of “0” is transmitted to the control device 200a.

The second synchronization processing is executed, for example, after the setting change of each of the illumination devices 1a_n is made in the setting change processing according to the second embodiment illustrated in FIG. 35. In this case, the control device 200a changes the setting change history flag from “0” to “1” and transmits the setting change history flag to each illumination device 1a_n (for example, step S240a in FIG. 35). Accordingly, as illustrated in FIG. 37C, the setting change history flag stored in the storage region of the storage circuit 113a of each illumination device 1a_n is updated from “0” to “1”.

Thereafter, as illustrated in FIG. 37D, the transmission-reception circuit 111a of each illumination device 1a_n stores the received first setting information (S1x_n and S1y_n) as the second setting information (S2x_n and S2y_n) in the storage circuit 113, for example, in the setting change processing according to the second embodiment illustrated in FIG. 35. The electrode drive circuit 112 of each illumination device 1a_n supplies drive voltage corresponding to the second setting information stored in the storage circuit 113a to the drive electrodes 10 and 13 of each liquid crystal cell 2 of the optical element 100.

Then, for example, as illustrated in FIG. 37E, the setting change history flag of each illumination device 1a_n is reset (from “1” to “0”) at step S109 in the illumination control processing illustrated in FIG. 24 after the new scene registration processing illustrated in FIG. 36.

Referring back to FIG. 24, the control device 200 determines whether any of the device selection switches DSEL is touched (step S106). If none of the device selection switches DSEL is touched (No at step S106), a return is made to the standby state of the initial screen of the illumination control application illustrated in FIG. 15 (step S101).

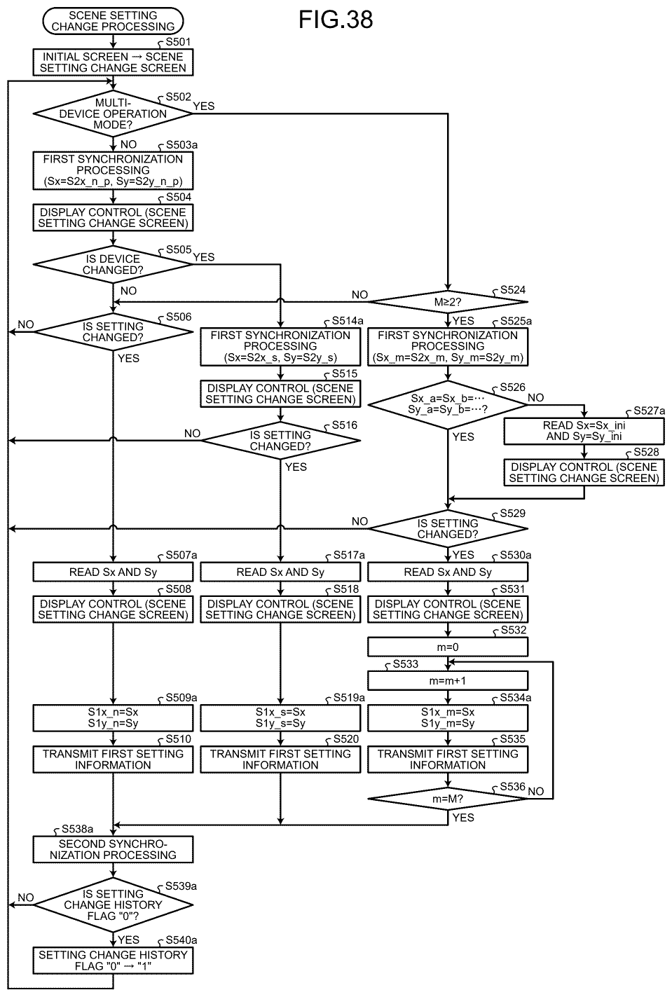

If any of the device selection switches DSEL is touched (Yes at step S106), the scene setting change processing of selected scene information (in this example, the scene information SCENE_p) is executed (step S500). FIG. 38 is a flowchart illustrating an example of the scene setting change processing by the control device 200a for the illumination device 1a according to the second embodiment.

In the scene setting change processing illustrated in FIG. 38 by the control device 200a for the illumination device 1a according to the second embodiment, the control device 200a transitions from the initial screen of the illumination control application illustrated in FIG. 15 to the scene setting change screen 400A illustrated in any of FIGS. 18A, 18B, 18C, 18D, and 18E (step S501) and determines whether the multi-device operation mode is selected (step S502).

If the single-device operation mode is selected and an illumination device 1a_n is selected (No at step S502), the control device 200a executes the first synchronization processing illustrated in FIG. 34A with the illumination device 1a_n (step S503a). The control device 200a sets the second setting information (S2x_n and S2y_n) transmitted from the illumination device 1a_n (Sx=S2x_n and Sy=S2y_n) as displayed values (Sx and Sy), and the display control circuit 231 of the control device 200a executes display control of the display panel 20 to reflect the displayed values on the setting change screen 400 (step S504).

Subsequently, the control device 200a determines whether the operation target device of the scene information SCENE_p is changed (step S505).

If the operation target device is not changed (No at step S505), the display control circuit 231 of the control device 200a determines whether a setting change of the setting information (in the present disclosure, light diffusion degree information) of the illumination device 1a_n of the scene information SCENE_p is executed (step S506). If a setting change of the setting information of the illumination device 1a_n is not executed (No at step S506), the control device 200a returns to the processing at step S502.

If a setting change of the setting information of the illumination device 1a_n of the scene information SCENE_p is executed on the scene setting change screen 400A (Yes at step S506), the display control circuit 231 of the control device 200a reads the displayed values of the horizontal diffusion degree Sx and the vertical diffusion degree Sy of the illumination device 1a_n of the scene information SCENE_p (step S507a) overwritten by making the setting change on the scene setting change screen 400A, and executes display control of the display panel 20 (step S508).

The transmission-reception circuit 225a of the control device 200a transmits the first setting information to the illumination device 1a_n of the scene information SCENE_p. Specifically, the transmission-reception circuit 225a sets the displayed values of the horizontal diffusion degree Sx and the vertical diffusion degree Sy of the illumination device 1a_n of the scene information SCENE_p as the first setting information (S1x_n=Sx and S1y_n=Sy; step S509a) and transmits the first setting information to the illumination device 1a_n (step S510).

The transmission-reception circuit 111a of the illumination device 1a_n stores the received first setting information (S1x_n and S1y_n) in the storage region of the storage circuit 113a.

Then, the control device 200a executes the second synchronization processing illustrated in FIG. 34B with the illumination device 1a_n (step S538a). The control device 200a determines whether the setting change history flag transmitted from the illumination device 1a_n is “0” (step S539a). If the setting change history flag is “0” (Yes at step S539a), the control device 200a changes the setting change history flag from “0” to “1” and transmits the setting change history flag to the illumination device 1a_n (step S540a), and returns to the processing at step S502.

The transmission-reception circuit 111a of the illumination device 1a_n stores the received first setting information (S1x_n and S1y_n) as the second setting information (S2x_n and S2y_n) in the storage circuit 113a. The electrode drive circuit 112 of the illumination device 1a_n supplies drive voltage corresponding to the second setting information stored in the storage circuit 113a to the drive electrodes 10 and 13 of each liquid crystal cell 2 of the optical element 100.

If the operation target device is changed (Yes at step S505), the control device 200a executes the first synchronization processing illustrated in FIG. 34A with the illumination device 1a_n (step S514a). The control device 200a sets the second setting information (S2x_s and S2y_s) transmitted from the illumination device 1a_s selected as the operation target device (Sx=S2x_s, Sy=S2y_s) as displayed values (Sx and Sy), and the display control circuit 231 of the control device 200a executes display control of the display panel 20 to reflect the displayed values on the setting change screen 400 (step S515).

Subsequently, the display control circuit 231 of the control device 200a determines whether a setting change of the setting information (in the present disclosure, light diffusion degree information) of the illumination device 1a_s of the scene information SCENE_p is executed (step S516). If a setting change of the setting information is not executed (No at step S516), the control device 200a returns to the processing at step S502.

If a setting change of the setting information of the illumination device 1a_s of the scene information SCENE_p is executed on the scene setting change screen 400A (Yes at step S516), the display control circuit 231 of the control device 200a reads the displayed values of the horizontal diffusion degree Sx and the vertical diffusion degree Sy of the illumination device 1a_s of the scene information SCENE_p overwritten by making the setting change on the scene setting change screen 400A (step S517a), and executes display control of the display panel 20 (step S518).

The transmission-reception circuit 225a of the control device 200a transmits the first setting information to the illumination device 1a_s. Specifically, the transmission-reception circuit 225a sets the displayed values of the horizontal diffusion degree Sx and the vertical diffusion degree Sy of the illumination device 1a_s of the scene information SCENE_p as the first setting information (S1x_s=Sx and S1y_s=Sy; step S519a) and transmits the first setting information to the illumination device 1a_s (step S520).

The transmission-reception circuit 111a of the illumination device 1a_s stores the received first setting information (S1x_s and S1y_s) in the storage region of the storage circuit 113a.

Then, the control device 200a executes the second synchronization processing illustrated in FIG. 34B with the illumination device 1a_n (step S538a). The control device 200a determines whether the setting change history flag transmitted from the illumination device 1a_n is “0” (step S539a). If the setting change history flag is “0” (Yes at step S539a), the control device 200a changes the setting change history flag from “0” to “1” and transmits the setting change history flag to the illumination device 1a_s (step S540a), and returns to the processing at step S502.

The transmission-reception circuit 111a of the illumination device 1a_s stores the received first setting information (S1x_s and S1y_s) as the second setting information (S2x_s and S2y_s) in the storage circuit 113a. The electrode drive circuit 112 of the illumination device 1a_s supplies drive voltage corresponding to the second setting information stored in the storage circuit 113a to the drive electrodes 10 and 13 of each liquid crystal cell 2 of the optical element 100.

If the multi-device operation mode is selected on the scene setting change screen 400A (Yes at step S502), the control device 200a determines whether the number M of illumination devices 1a of the scene information SCENE_p, which are selected as operation target devices in the multi-device operation mode, is equal to or larger than two (step S524). If only one illumination device 1a of the scene information SCENE_p is selected as an operation target device (M=1; No at step S524), the control device 200a determines whether a setting change of the setting information of the illumination device 1a_n of the scene information SCENE_p that is selected as the operation target device is executed (step S506). If a setting change of the setting information of the illumination device 1a_n is not executed (No at step S506), the control device 200a returns to the processing at step S502.

If a setting change of the setting information of the illumination device 1a_n of the scene information SCENE_p is executed on the scene setting change screen 400A (Yes at step S506), the display control circuit 231 of the control device 200a reads the displayed values of the horizontal diffusion degree Sx and the vertical diffusion degree Sy of the illumination device 1a_n of the scene information SCENE_p (step S507a) overwritten by making the setting change on the scene setting change screen 400A, and executes display control of the display panel 20 (step S508).

The transmission-reception circuit 225a of the control device 200a transmits the first setting information to the illumination device 1a_n. Specifically, the transmission-reception circuit 225a sets the displayed values of the horizontal diffusion degree Sx and the vertical diffusion degree Sy of the illumination device 1a_n of the scene information SCENE_p as the first setting information (S1x_n=Sx and S1y_n=Sy; step S509a) and transmits the first setting information to the illumination device 1a_n (step S510).

Then, the control device 200a executes the second synchronization processing illustrated in FIG. 34B with the illumination device 1a_n (step S538a). The control device 200a determines whether the setting change history flag transmitted from the illumination device 1a_n is “0” (step S539a). If the setting change history flag is “0” (Yes at step S539a), the control device 200a changes the setting change history flag from “0” to “1” and transmits the setting change history flag to the illumination device 1a_n (step S540a), and returns to the processing at step S502.

The transmission-reception circuit 111a of the illumination device 1a_n stores the received first setting information (S1x_n and S1y_n) as the second setting information (S2x_n and S2y_n) in the storage circuit 113a. The electrode drive circuit 112 of the illumination device 1_n supplies drive voltage corresponding to the second setting information stored in the storage circuit 113a to the drive electrodes 10 and 13 of each liquid crystal cell 2 of the optical element 100.

If the number M of illumination devices 1a of the scene information SCENE_p, which are selected as operation target devices in the multi-device operation mode, is equal to or larger than two (M≥2; Yes at step S524), the control device 200a executes the first synchronization processing illustrated in FIG. 34A with each of the M illumination devices 1a_m (step S525a). The control device 200a sets the second setting information (S2x_m and S2y_m) transmitted from the M illumination devices 1a_m as (Sx_m and Sy_m), (that is, Sx_m=S2x_m and Sy_m=S2y_m) and determines whether the light distribution shapes of the M illumination devices 1a_m (1a_a, 1a_b, . . . ) are identical to one another. Specifically, the control device 200a determines whether the horizontal diffusion degrees Sx_m (Sx_a, Sx_b, . . . ) of the M illumination devices 1a_m (1a_a, 1a_b, . . . ) are identical to one another and the vertical diffusion degrees Sy_m (Sy_a, Sy_b, . . . ) of the M illumination devices 1a_m (1a_a, 1a_b, . . . ) are identical to one another (step S526).

If the light distribution shapes of the M illumination devices 1a_m (1a_a, 1a_b, . . . ) of the scene information SCENE_p, which are selected as the operation target devices in the multi-device operation mode, are identical to one another (Yes at step S526), a transition is made to step S529.

If the light distribution shapes of the M illumination devices 1a_m (1a_a, 1a_b, . . . ) of the scene information SCENE_p, which are selected as the operation target devices in the multi-device operation mode, are different from one another (No at step S526), the display control circuit 231 of the control device 200a reads the horizontal diffusion degree Sx_ini (in FIG. 32A, 50%) that is the initial value (default value) of the horizontal diffusion degree Sx stored in the storage region of the storage circuit 223a, and sets the horizontal diffusion degree Sx_ini as the displayed values of the horizontal diffusion degrees Sx of the illumination devices 1a_m, and in addition, reads the vertical diffusion degree Sy_ini (in the example illustrated in FIG. 32A, 50%) that is the initial value of the vertical diffusion degree Sy, and sets the vertical diffusion degree Sy_ini as the displayed values of the vertical diffusion degrees Sy of the illumination devices 1a_m (Sx=Sx_ini and Sy=Sy_ini; step S527a), and then executes display control of the display panel 20 (step S528), and a transition is made to step S529.

The display control circuit 231 of the control device 200a determines whether a setting change of each of the illumination devices 1a_m of the scene information SCENE_p, which are selected as the operation target devices in the multi-device operation mode, is executed (step S529). If a setting change of the setting information is not executed (No at step S529), the control device 200a returns to the processing at step S502.

If a setting change of the setting information of each of the illumination devices 1_m of the scene information SCENE_p is executed on the scene setting change screen 400A (Yes at step S529), the display control circuit 231 of the control device 200a reads the displayed values of the horizontal diffusion degrees Sx and the vertical diffusion degrees Sy of the illumination devices 1a_m of the scene information SCENE_p overwritten by making the setting change on the scene setting change screen 400A (step S530a), and executes display control of the display panel 20 (step S531).

The transmission-reception circuit 225a of the control device 200a transmits the horizontal diffusion degree Sx and the vertical diffusion degree Sy overwritten by making the setting change on the scene setting change screen 400A, as the first setting information to the illumination devices 1a_m of the scene information SCENE_p that are selected as the operation target devices in the multi-device operation mode. Specifically, the transmission-reception circuit 225a resets the device counter value m (m=0; step S532), adds one to the device counter value m (m=m+1; step S533), sets the displayed values of the horizontal diffusion degrees Sx and the vertical diffusion degrees Sy of the illumination devices 1a_m of the scene information SCENE_p as the first setting information (S1x_m=Sx and S1y_m=Sy; step S534a), and transmits the first setting information to the illumination device 1a_m corresponding to the device counter value m (step S535).

The transmission-reception circuit 225a determines whether the first setting information is transmitted to all operation target devices (illumination devices 1a_m). Specifically, the control device 200a determines whether the device counter value m is equal to M (step S536).

In the case of m<M (No at step S536), the processing from step S533 to step S536 is repeatedly executed. Specifically, the transmission-reception circuit 225a adds one to the device counter value m (m=m+1; step S533) and transmits the first setting information to the illumination device 1a_m corresponding to the device counter value m (step S535).

The transmission-reception circuits 111a of the M illumination devices 1a_m each store the received first setting information (S1x_m and S1y_m) in the storage region of the storage circuit 113a.

Then, the control device 200a executes the second synchronization processing illustrated in FIG. 34B with each of the M illumination devices 1a_m (step S538a). The control device 200a determines whether the setting change history flag transmitted from any illumination device 1a_m is “0” (step S539a). If the setting change history flag transmitted from any illumination device 1a_m is “0” (Yes at step S539a), the control device 200a changes the setting change history flag of each illumination device 1a_m subjected to setting change from “0” to “1” and transmits the setting change history flag to the illumination device 1a_m (step S540a), and returns to the processing at step S502.

The transmission-reception circuits 111a of the M illumination devices 1a_m each store the received first setting information (S1x_m and S1y_m) as the second setting information (S2x_m and S2y_m) in the storage circuit 113a. The electrode drive circuit 112 of each illumination device 1a_m supplies drive voltage corresponding to the second setting information stored in the storage circuit 113a to the drive electrodes 10 and 13 of each liquid crystal cell 2 of the optical element 100.

The above-described processing from step S533 to step S536 is executed until m=M (Yes at step S536). Accordingly, the same setting change is executed for the M illumination devices 1a_m of the scene information SCENE_p, which are selected as the operation target devices in the multi-device operation mode.

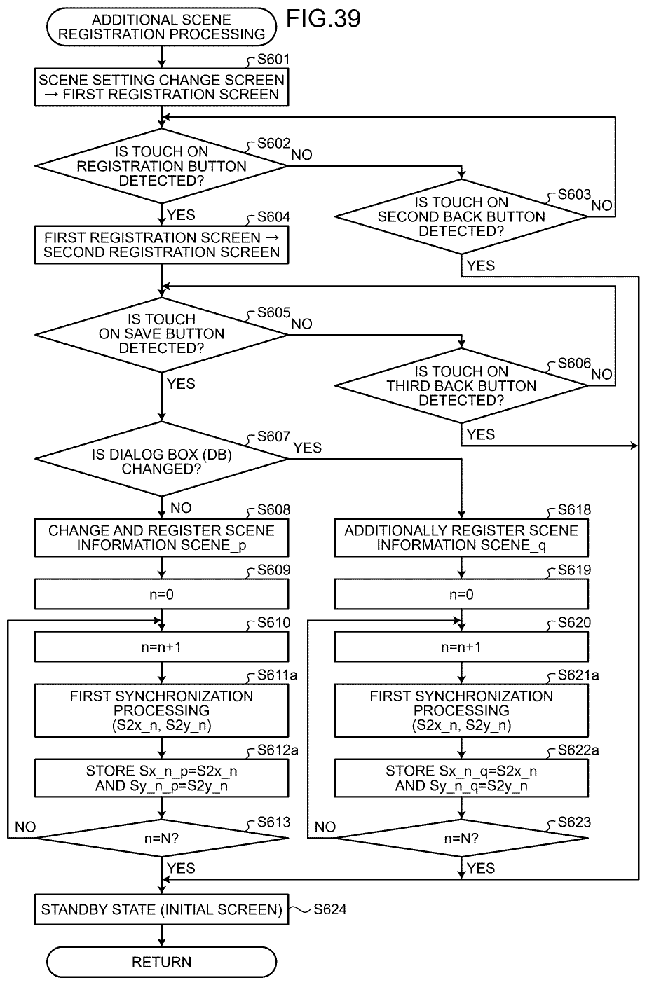

Referring back to FIG. 24, the control device 200a executes the second synchronization processing illustrated in FIG. 34B with each illumination device 1a_n as a control target device (step S105) and determines whether the setting change history flag of at least one of all illumination devices 1a_n is “1” (step S108). If the setting change history flags of all illumination devices 1a_n are “0” (No at step S108), a return is made to the standby state of the initial screen of the illumination control application illustrated in FIG. 15 (step S101). If the setting change history flag of at least one of all illumination devices 1a_n is “1” (Yes at step S108), a transition is made to the standby state of the first registration screen illustrated in FIG. 20 to execute additional scene registration processing (step S600). FIG. 39 is a flowchart illustrating an example of the additional scene registration processing by the control device 200a for the illumination device 1a according to the second embodiment. In description of FIG. 39, it is assumed that the scene setting change processing illustrated in FIG. 38 is executed for the scene information SCENE_p.

Processing from step S601 to step S607 in the additional scene registration processing illustrated in FIG. 39 by the control device 200a for the illumination device 1a according to the second embodiment is the same as that in the new scene registration processing illustrated in FIG. 26 by the control device 200 for the illumination device 1 according to the first embodiment, and thus detailed description thereof is omitted.

In the additional scene registration processing by the illumination device 1a according to the second embodiment, if the registration name of the scene information in the dialog box DB is not changed (No at step S607), a registration change of the scene information SCENE_p is executed (step S608). The scene setting processing circuit 241 of the control device 200a resets the device counter value n (n=0; step S609), adds one to the device counter value n (n=n+1; step S610), and executes the first synchronization processing illustrated in FIG. 34A with each illumination device 1a_n (step S611a). The control device 200a stores the second setting information (S2x_n and S2y_n) transmitted from the illumination device 1a_n in the storage region of the storage circuit 223a as the horizontal diffusion degree Sx_1_p and the vertical diffusion degree Sy_1_p of the illumination device 1a n corresponding to the device counter value n in the scene information SCENE_p as a registration change target (Sx_1_p=Sx_1 and Sy_1_p=Sy_1; step S612a).

The scene setting processing circuit 241 determines whether the horizontal diffusion degree Sx_n_p and the vertical diffusion degree Sy_n_p of the scene information SCENE_p are stored for all control target devices (illumination devices 1a_n). Specifically, the scene setting processing circuit 241 determines whether the device counter value n is equal to N (step S613).

In the case of n<N (No at step S613), the scene setting processing circuit 241 repeatedly executes the processing from step S610 to step S613. Accordingly, the horizontal diffusion degrees Sx_n_p and the vertical diffusion degrees Sy_n_p of all control target devices (illumination devices 1a_n or illumination devices 1a_1, 1a_2, 1a_3, 1a_4, and 1a_5 in this example) in the scene information SCENE_p are stored in the storage region of the storage circuit 223a as setting information of the scene information SCENE_p the registration change of which has been made. Through this processing, the setting information of the control target devices (illumination devices 1_n) and the scene information SCENE_p are associated with each other.

Then, in the case of n=N (Yes at step S613), the control device 200a transitions to the standby state of the initial screen of the illumination control application illustrated in FIG. 15 (step S624).

After transitioning to the standby state of the initial screen of the illumination control application illustrated in FIG. 15 (step S624), the control device 200a returns to the illumination control processing illustrated in FIG. 24 and resets the setting change history flag of each illumination device 1a_n as a control target device (from “1” to “0”; step S109). Specifically, a command to reset the setting change history flag is transmitted to each illumination device 1a_n. Then, if the illumination control application is ended in the standby state of the initial screen of the illumination control application illustrated in FIG. 15, control of the illumination devices 1a_n by the control device 200a ends.

In the additional scene registration processing by the illumination device 1a according to the second embodiment, if the registration name of the scene information in the dialog box DB is changed (Yes at step S607), an additional registration of the scene information SCENE_q is executed (step S618). The scene setting processing circuit 241 of the control device 200 resets the device counter value n (n=0; step S619), adds one to the device counter value n (n=n+1; step S620), and executes the first synchronization processing illustrated in FIG. 34A with each illumination device 1a_n (step S621a). The control device 200a stores the second setting information (S2x_n and S2y_n) transmitted from the illumination device 1a_n in the storage region of the storage circuit 223a as the horizontal diffusion degree Sx_1_q and the vertical diffusion degree Sy_1_q of the illumination device 1a n corresponding to the device counter value n in the scene information SCENE_q as an additional registration target (Sx_1_q=Sx_1 and Sy_1_q=Sy_1; step S622a).

The scene setting processing circuit 241 determines whether the horizontal diffusion degree Sx_n_q and the vertical diffusion degree Sy_n_q of the scene information SCENE_q are stored for all control target devices (the illumination device 1a_n). Specifically, the scene setting processing circuit 241 determines whether the device counter value n is equal to N (step S623).

In the case of n<N (No at step S623), the scene setting processing circuit 241 repeatedly executes the processing from step S620 to step S623. Accordingly, the horizontal diffusion degrees Sx_n_q and the vertical diffusion degrees Sy_n_q of all control target devices (illumination devices 1a_n or illumination devices 1a_1, 1a_2, 1a_3, 1a_4, and 1a_5 in this example) in the scene information SCENE_q are stored in the storage region of the storage circuit 223a as setting information of the scene information SCENE_q additionally registered. Through this processing, the setting information of the control target devices (illumination devices 1_n) and the scene information SCENE_q are associated with each other.

Then, in the case of n=N (Yes at step S623), the control device 200a transitions to the standby state of the initial screen of the illumination control application illustrated in FIG. 15 (step S624).

After transitioning to the standby state of the initial screen of the illumination control application illustrated in FIG. 15 (step S624), the control device 200a returns to the illumination control processing illustrated in FIG. 24 and resets the setting change history flag of each illumination device 1a_n as a control target device (from “1” to “0”; step S109). Specifically, a command to reset the setting change history flag is transmitted to each illumination device 1a_n. Then, if the illumination control application is ended in the standby state of the initial screen of the illumination control application illustrated in FIG. 15, control of the illumination devices 1a_n by the control device 200 ends.

With the control device 200a for the illumination device 1a and the illumination system according to the second embodiment described above, similarly to the first embodiment, the same setting information (in the present disclosure, light diffusion degree information) can be set at once to the illumination devices 1a_m selected upon selection of the multi-device operation mode from among the illumination devices 1a_n registered as control target devices in advance.

With the control device 200a for the illumination device 1a and the illumination system according to the second embodiment described above, similarly to the first embodiment, setting information (in the present disclosure, light diffusion degree information) that is registered in the new scene registration processing illustrated in FIG. 36 or the additional scene registration processing illustrated in FIG. 39 and is associated with each illumination device 1a_n can be set at once to the illumination devices 1a_n as control targets.

In addition, with the control device 200a for the illumination device 1a and the illumination system according to the second embodiment described above, the second setting information (S2x_n and S2y_n) as current control values is transmitted from each illumination device 1a_n to the control device 200a and reflected as displayed values on the setting change screen 400 or the scene setting change screen 400A of the control device 200a in the first synchronization processing illustrated in FIG. 34A. Accordingly, for example, even when the same illumination control application is installed on a plurality of control devices 200a and the control devices 200a are owned by, for example, a plurality of users, it is possible to perform, in the same manner, the illumination control processing on which the second setting information of each illumination device 1a_n as current control values is reflected by executing the first synchronization processing in the setting change processing illustrated in FIG. 35 or the scene setting Change processing illustrated in FIG. 38 by using each control device 200a.

In the aspect described above in the first embodiment, the setting change screen 400 is displayed for each illumination device 1_n (refer to FIGS. 16A, 16B, 16C, 16D, 16E, 18A, 18B, 18C, 18D, and 18E), but the present disclosure is not limited to the aspect in which the setting change screen 400 or the scene setting change screen is displayed for each illumination device 1_n. For example, in a case in which the display region DA of the control device 200 is a sufficiently large tablet or the like, the setting change of a plurality of illumination devices 1_n registered as control target devices may be performed on one screen.

### Third Embodiment

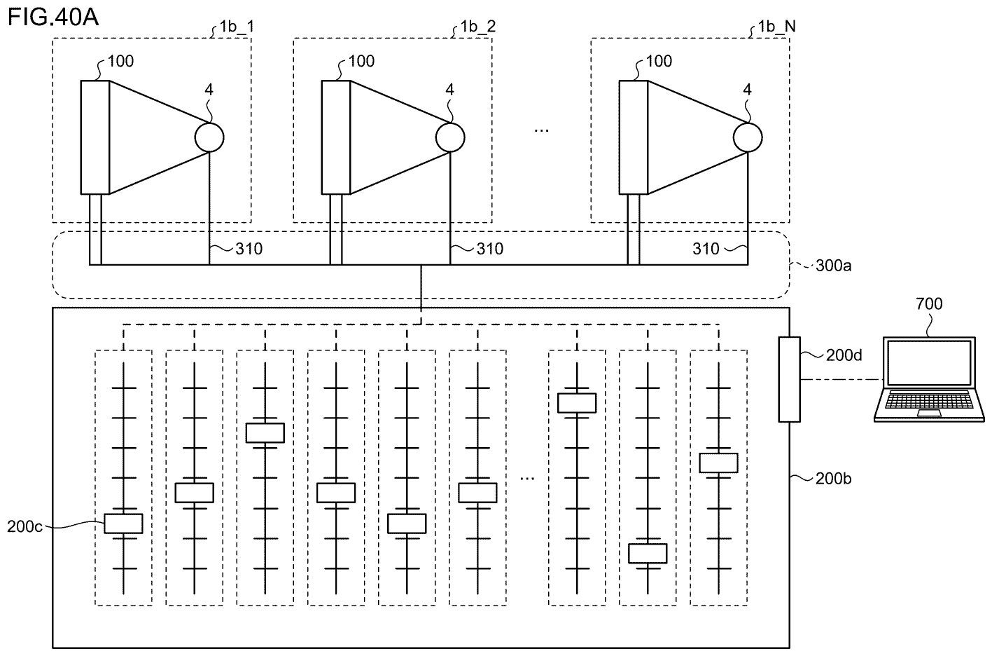

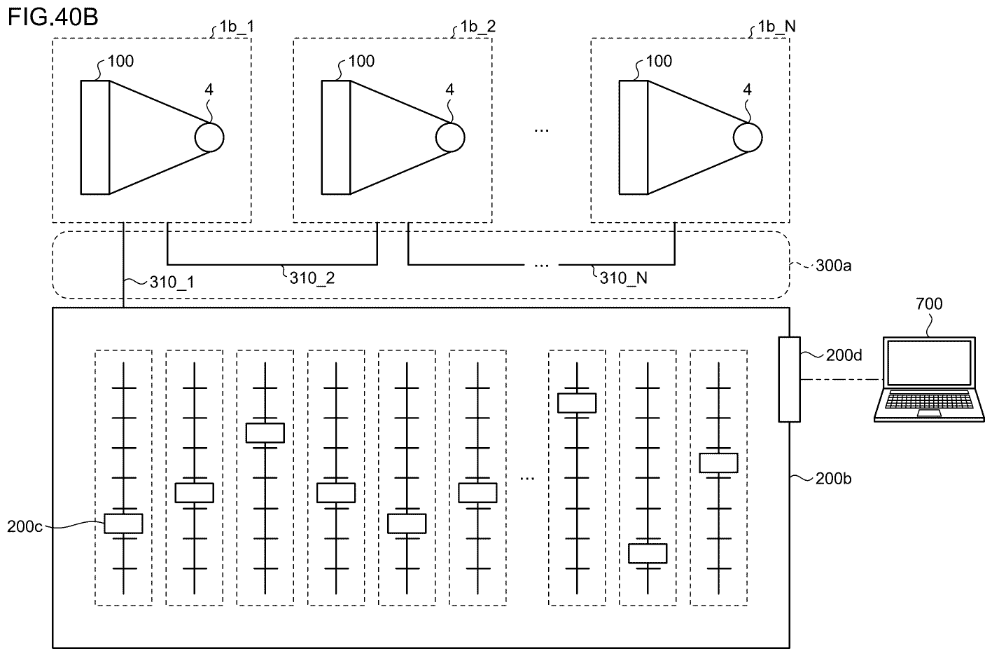

FIG. 40A is a schematic view illustrating an example of the configuration of an illumination system according to a third embodiment. In FIG. 40A, a plurality of illumination devices 1_1, 1_2, . . . , 1_N are coupled to an illumination control device (control device) 200b through a communication means 300a including a plurality of wiring lines 310. More specifically, the illumination control device 200b is, for example, a DMX controller. The DMX controller can adjust the brightness and color of emission light from illumination devices 1b_1, 1b_2, . . . , and 1b_N and can also operate the optical element 100 of each of the illumination devices 1b_1, 1b_2, . . . , and 1b_N, thereby changing the light distribution shape of emission light from each of the illumination devices 1b_1, 1b_2, . . . , and 1b_N. FIG. 40B is a schematic view illustrating a specific coupling example in a case where the illumination control device 200b is a DMX controller in the configuration of the illumination system according to the third embodiment. In a case where the illumination control device 200b is a DMX controller, the illumination control device 200b and the illumination devices 1b_1, 1b_2, . . . , and 1b_N are daisy-chained as illustrated in FIG. 40B. More specifically, the illumination control device 200b and the illumination device 1b_1 are coupled to each other through a cable 310_1, and the illumination device 1b_1 and the illumination device 1b_2 are coupled to each other through a cable 310_2. Subsequently, the preceding illumination device and the succeeding illumination device are sequentially coupled to each other through a cable.

The illumination system includes the illumination devices 1b_1, 1b_2, . . . , and 1b_N and the single illumination control device 200b, and these devices are coupled in a wired manner. More specifically, each of the illumination devices 1b_1, 1b_2, . . . , and 1b_N includes the light source 4 and the optical element 100 as in the above-described first and second embodiments, and the illumination control device 200b includes a plurality of physical sliders 200c. The light source 4 and the optical element 100 of each of the illumination devices 1_1, 1_2, . . . , and 1_N are coupled to the illumination control device 200b through the wiring lines 310 (or the cables 310_1, 310_2, . . . , 310_N), and therefore, each light source 4 or each optical element 100 can be driven by moving the corresponding physical slider (hereinafter referred to as slider) 200c upward and downward. More specifically, the light sources 4 correspond to the sliders 200c on a one-to-one basis, and the brightness of emission light from the light sources 4 can be changed by moving the sliders 200c upward and downward. A configuration in which the color of emission light from the light source 4 is changed by moving the slider 200c upward and downward may be employed, or both brightness and color may be changed. Alternatively, it is possible to employ a configuration in which each light source 4 corresponds to two sliders 200c such that the brightness of emission light from the light source 4 is changed by moving one of the sliders 200c upward and downward and the color of emission light from the light source 4 is changed by moving the other slider 200c upward and downward.

Two wiring lines 310 are extended from the optical element 100 of each of the illumination devices 1b_1, 1b_2, . . . , and 1b_N and coupled to the illumination control device 200b. Thus, each optical element 100 corresponds to two sliders 200c such that the horizontal diffusion degree of the optical element 100 can be changed by moving one of the sliders 200c upward and downward and the vertical diffusion degree of the optical element 100 can be changed by moving the other slider 200c upward and downward. The vertical and horizontal diffusion degrees of a plurality of optical elements 100 can be simultaneously changed by simultaneously moving a plurality of sliders 200c upward and downward. It is possible to employ a configuration in which an additional slider 200c corresponding to more than one optical element 100 selectively selected from among the optical elements 100 is provided and the diffusion degrees of the selected optical elements 100 are changed by moving the slider 200c upward and downward.

Such an aspect in which the diffusion degrees of one optical element 100 are changed by operating the corresponding sliders 200c of the illumination control device 200b may be referred to as the single-device operation mode (first mode), corresponding to the above-described first and second embodiments. Such an aspect in which the diffusion degrees of a plurality of optical elements 100 are simultaneously changed by operating the corresponding one or plurality of sliders 200c of the illumination control device 200b may be referred to as the multi-device operation mode (second mode), corresponding to the above-described first and second embodiments.

The illumination control device 200b can be coupled to an external control device 700 such as a PC through a port 200d, and it is possible to change setting of the illumination control device 200b by the external control device 700. More specifically, it is possible by the external control device 700 to change the combination of the correspondence relation between the sliders 200c and the illumination device 1b_1, 1b_2, . . . , or 1b_N and the change the diffusion degree and the degrees of brightness of emission light from each of the illumination devices 1b_1, 1b_2, . . . , 1b_N through upward and downward movement of the corresponding slider 200c. Alternatively, it is possible to employ a configuration in which the external control device 700 and the illumination control device 200b are maintained in the coupled state to collectively function as the control device 200 or 200a.

In the configurations illustrated in FIGS. 40A and 40B, as well, it is possible to employ an aspect in which each of the illumination devices 1b_1, 1b_2, . . . , and 1b_N are coupled to the illumination control device 200b including the sliders 200c by a wireless communication means as in the first and second embodiments.

The preferable embodiments of the present disclosure are described above, but the present disclosure is not limited to the embodiments. Contents disclosed in the embodiments are merely exemplary and may be modified in various kinds of manners without departing from the scope of the present disclosure. For example, in the present embodiment, the optical element of an illumination device is controlled to change the light distribution state of the illumination device, but the configurations disclosed in the present embodiment may be applied to change the brightness, color, or the like of the light source of the illumination device instead of the light distribution state. Appropriate modifications made without departing from the scope of the present disclosure naturally belong to the technical scope of the present disclosure.

What is claimed is:

1. A control device for an illumination device configured to control a plurality of illumination devices each capable of setting a light distribution shape of light emitted from a light source in two directions of a first direction and a second direction intersecting the first direction, the control device comprising:
a touch sensor including a detection region in which a plurality of detection elements are provided;
a display panel provided with a display region overlapping the detection region of the touch sensor in plan view; and
a storage circuit configured to store setting information at least including setting values of the light distribution shape, wherein
the setting information of the illumination devices is set as scene information in the storage circuit, and
the setting information set as the scene information for each of the illumination devices is transmitted to an illumination device associated with the setting information.

2. The control device for an illumination device according to claim 1, wherein the setting information is transmitted to one, some, or all of the illumination devices when the setting value is changed.

3. The control device for an illumination device according to claim 2, wherein the same setting information is transmitted to some or all of the illumination devices when the setting value is changed.

4. The control device for an illumination device according to claim 2, wherein
the control device has
a first mode in which one illumination device is selected from among the illumination devices, and
a second mode in which more than one illumination device is selected from among the illumination devices,
the setting information is transmitted to the one selected illumination device when the setting value is changed in the first mode, and
the same setting information is transmitted to the selected illumination devices when the setting value is changed in the second mode.

5. An illumination system comprising:
a plurality of illumination devices each including a light source and an optical element, the optical element being provided on an optical axis of the light source and capable of setting a light distribution state of light emitted from the light source in two directions of a first direction and a second direction intersecting the first direction; and
a control device configured to control the illumination devices to change the light distribution states, wherein
the control device includes
a touch sensor including a detection region in which a plurality of detection elements are provided,
a display panel provided with a display region overlapping the detection region of the touch sensor in plan view, and
a first storage circuit configured to store setting information at least including setting values of the light distribution states,
the setting information of the illumination devices is set as scene information in the first storage circuit,
the control device is configured to transmit the setting information set as the scene information for each of the illumination devices to an illumination device associated with the setting information, and
the illumination device includes a second storage circuit configured to store the setting information transmitted from the control device.

6. The illumination system according to claim 5, wherein the control device transmits the setting information to one, some, or all of the illumination devices when the setting value is changed.

7. The illumination system according to claim 6, wherein the control device transmits the same setting information to some or all of the illumination devices when the setting value is changed.

8. The illumination system according to claim 6, wherein
the control device has
a first mode in which one illumination device is selected from among the illumination devices, and
a second mode in which more than one illumination device is selected from among the illumination devices,
the setting information is transmitted to the one selected illumination device when the setting value is changed in the first mode, and
the same setting information is transmitted to the selected illumination devices when the setting value is changed in the second mode.

9. The illumination system according to claim 5, wherein
the illumination device is configured to transmit the setting information stored in the second storage circuit to the control device, and
the control device is configured to perform display control of the display panel based on the setting information transmitted from the illumination device.
